(19) United States
(12) Patent Application Publication
(10) Pub. No.: US 2016/0125068 A1
(43) Pub. Date: May 5, 2016

(54) SYSTEM AND METHOD FOR INTEGRATED MISSION CRITICAL ECOSYSTEM MANAGEMENT

(71) Applicant: Fulcrum Collaborations, LLC, Richmond, VA (US)

(72) Inventor: Michael J. Dongieux, Richmond, VA (US)

(21) Appl. No.: 14/891,154

(22) PCT Filed: May 13, 2014
(86) PCT No.: PCT/US14/37847

§ 371 Date: Nov. 13, 2015

Related U.S. Application Data
(60) Provisional application No. 61/822,581, filed on May 13, 2013.

(51) Int. Cl. G06F 17/30

(52) U.S. Cl. CPC G06F 17/30604; G06F 17/30598

(57) ABSTRACT

The present approach provides methods and processes for comprehensive management of the Mission Critical Ecosystem. Mission critical information management includes information from an entity's facilities, especially the critical facilities. The methods and processes disclosed herein allow for assessing and managing dependencies between assets, which may provide valuable insight into, for example, risk relationships for planned and unplanned events, and mitigation planning and management for incidents.

### CROSS REFERENCE TO RELATED APPLICATIONS

This application claims the benefit of U.S. Provisional Application No. 61/822,581, filed May 13, 2013, which is hereby incorporated by reference in its entirety.

### FIELD OF THE APPROACH

The present application relates to mission critical information management, including information from an entity's facilities, especially the critical facilities, and more particularly to a system and method for electronically collecting, integrating, managing, automating, decision making, and/or disseminating structured business information of strategic, managerial and tactical value to the organization.

### BACKGROUND

Mission critical may be considered as the provisioning and management of the functions supporting continuous network availability, 24 hours a day, 7 days a week, and 365 days a year (24/7/365). Technology being pervasive, most organizations have increased their reliance on the network across the enterprise's value chain, from logistics to operations to sales and support. As a result, the need for fault-tolerant data centers continues to increase. Directly supporting the data center are three primary engineering infrastructure groups: Fire and Life Safely, Power and Cooling and Space and Security. These engineering infrastructure groups collectively support the 24/7/365 operation of the data center's IT infrastructure (e.g. servers, networking devices, etc.), which theoretically provides uninterrupted application, data and telecommunications services to the organization's internal business units and external customer channels around the world. In turn, uninterrupted application, data, and telecommunications services support the continuous execution and delivery of the core operating and support activities which make up the organization's value chain. As up-time availability remains a key firm performance metric, on-going maintenance and governance of critical infrastructure should remain a top priority for the firm. The incongruity of useful lifespans between facility engineering infrastructure and IT infrastructure assets further complicates this priority.

For example, facilities and the engineering infrastructure assets they contain are built to last about 15 years or more, whereas IT infrastructure assets are typically transitioned about every 3 years, and in some instances less than 3 years. Given that the network (and the business units and customer channels it supports) both drives and relies on the facility for its performance needs, an obvious disparity exists. Adding to the complexity of the situation, multiple, redundancy critical facilities and/or data centers within an organization are relied upon to provide primary, secondary, and even tertiary backup to common mission critical functions they collectively support. The increasing requirements for redundancy across critical facilities to support 24/7/365 business continuity, and the resulting informational and operational dependencies between the critical facilities and assets therein, can render many traditional software solutions inadequate to the task. Furthermore, both the Uptime Institute's Tier Standards and the Telecommunications Industry Association's TIA-942-2 are based primarily on redundancy levels of physical infrastructure only, focusing on independent paths and system failover capabilities within a single data center.

However, new availability demands imposed by virtualization, cloud computing and “always on” mobile technology are rapidly increasing asset interdependency to levels beyond the levels at which the physical infrastructure within a single data center is able to support. These new levels of interdependence demand that the concepts of redundancy and fault tolerance evolve to encompass a variety of assets across the entire organizational value chain, beyond only the physical engineering and IT infrastructure.

### BRIEF SUMMARY

Disclosed herein are systems and methods employing the intelligent, thoughtful integration of numerous discrete information centers—housed at different facilities and managed by different departments—that enable effective, holistic decision making across a global facilities portfolio.

The present approach allows for bridging the gap between the facility, the data center and the organization's applications, business units, and customer channels. One of the most difficult challenges facing the mission critical industry is an inability to objectively assess risk and critical facility robustness. In general, organizations lack the metrics needed to quantify reliability and availability—the ability to identify and align the function or business mission of each building with its performance expectation.

The present approach enables an organization to meet these challenges, and more, by centralizing, standardizing, integrating, and automating a broad set of mission critical information (i) from an organization's entire critical facility portfolio, (ii) from both the internal and external environment, and (iii) from among all mission critical stakeholders (including separate, yet ultimately related departments). This, in turn, mitigates the risk of impact events and maximizes the useful life of mission critical assets, both within and around a facility, across an interconnected and/or global portfolio of facilities, and across an organization's value chain as a whole.

In one embodiment of the present approach, the operational features of the system support transactional day-to-day activities, such as change control process administration, incident reporting, maintenance, and routine inspections. Meanwhile, the business intelligence and decision support elements of various aspects of the present approach consolidate operational data with industry benchmarks to provide a strategic analysis of the critical facility portfolio, which may align facility outputs with data center needs and the mission of the organization as a whole.

Some embodiments of the present approach provide, among other features and benefits, core maintenance and operating functions to ensure efficient and effective delivery of engineering infrastructure, including Fire and Life Safety, Power and Cooling and Space and Security. Some embodiments may also provide rigorous governance, business intelligence, and reporting through functions such as: Availability and Risk Management, Efficiency Planning and Audit Readiness. Such embodiments of the present approach thereby support healthy data center performance and maximum availability of a network to the organization's internal business unit assets and external customer channel assets downstream, across an entire, global portfolio.

Unlike contemporary facility management systems, the present approach allows for the masterful integration of discrete information centers and data elements into a single, global system. Furthermore, embodiments of the present approach provide a consolidated, integrated, real-time data set of this nature, which enables numerous advantageous capabilities. Historically, and to the present day, organizations typically rely upon multiple, non-integrated point solutions to perform various functions, or sets of functions. These various point solutions create informational silos, preventing the organization from benefitting from the logical combinations of the information they contain. Conversely, the present approach avoids the limitations of informational silos. In some embodiments, all data, stakeholders, methods, and processes may be seamlessly integrated to produce, among other useful features, a perpetual pipeline of complete, accurate, standardized and integrated data, aggregated from across (and beyond) the facility ecosystem and funneled into a single system on a real-time basis.

Some embodiments of the present approach enable the use of tightly integrated functions via a cloud platform, accessible by an authorized user, theoretically anywhere, anytime, via any device able connected to the Internet. In some embodiments, the present approach also provides offline capabilities to ensure access to mission critical information in circumstances where an Internet connection is not available. The system of the present approach may also provide instant access to a full-spectrum view of all mission critical information. Some embodiments feature an intuitive, easy-to-use interface that minimizes users' ramp-up time and simplifies day-to-day work activities. The present approach enables may thus remove the obstacle of dealing with multiple, inconsistent versions of the same information. Everything may be stored and accessed in a single location, available on-demand, anywhere, anytime, in accordance with embodiments of the present approach as disclosed herein.

Some embodiments of the present approach provide methods and systems for assessing and managing dependencies between assets. As shown in FIG. 1, embodiments of such methods and systems, which may include computer implemented methods and/or computer systems, may include defining, in a database, (1) more than one asset S101, having an operation; (2) upstream assets having at least one upstream asset dependency S102, an upstream asset dependency comprising an upstream asset having an operation that has a potential impact on the operation an asset; and (3) downstream assets having at least one downstream asset dependency S103, a downstream asset dependency comprising a downstream asset that has an operation that may be impacted by the operation of an asset. The method may include receiving an indication of an event S104 that has a potential to change the operation of an asset, such as a risk assessment (e.g., testing and identifying risks based on asset dependencies), a planned event (e.g., maintenance, testing, risk analysis, etc.) or an unplanned event (e.g., asset failure, power loss, etc.). The method may include identifying a first category of assets for the event S105, if any. Generally, a first category asset may be a downstream asset having a downstream asset dependency on the asset subject to the event. Some embodiments may include determining redundant assets for all or some of the first category assets S106, if any. Generally, a redundant asset may be an asset that provides the same operation as the first asset, and/or an asset upstream of a first category asset that provides the same operation to the first category asset as the asset subject to the event, such as a vertically redundant asset. A redundant asset may also be an asset providing the same operation as the first category asset, such as a parallel or horizontally redundant asset. Some embodiments may include identifying a second category of assets S107. Generally, a second category asset may be a first category asset, e.g., a downstream asset from the first asset having, less redundant assets than a predetermined threshold for the asset. Some embodiments may include identifying a third category of assets for the event, a third category asset generally being a first category asset having more redundant assets that a first predetermined threshold for the asset, and less redundant assets than a second predetermined threshold for the asset. A processor may be used to execute instructions stored in at least one memory device to perform all or a portion of such methods.

Assets may include assets from asset classes such as engineering infrastructure assets, information technology hardware assets, information technology software assets, business unit assets, and customer channel assets, and may include homogeneous and/or heterogeneous assets.

As described in more detail below, embodiments of the present approach may take the form of systems, such as computer-implemented systems, for assessing and managing dependencies between assets, among other useful tasks. Such embodiments may include data identifying (1) assets having an operation; (2) upstream assets having at least one upstream asset dependency; and (3) downstream assets having at least one downstream asset dependency. Such data may be included in computer storage means, such as a database. Embodiments of the system may also include on or more numerous modules as described in more detail below. For example, embodiments may include an asset monitoring module; an event indication receiving module; a first category asset identification module; a redundant assets module; and/or a second category asset identification module, among other useful modules described herein. Dependencies may be re-evaluated, such as a predefined interval, after an event, on an ad hoc basis, and after an asset monitoring module signal.

### DESCRIPTION OF THE DRAWINGS

FIG. 1 is a flow chart showing a method for assessing and managing dependencies between assets.

FIG. 2 is a model of the relationship between work, a change request/change control process, and an entity's value chain, according to an embodiment of the present approach.

FIG. 3 is a flow chart demonstrating a method for creating asset data in an embodiment of the present approach.

FIG. 4 is a flow chart of an embodiment of a change request documentation process.

FIG. 5 is a flow chart of an embodiment of a bill of work creation, assignment and update process.

FIG. 6 is a flow chart showing an embodiment of a method for mapping asset dependencies.

FIG. 7 illustrates a method for defining risk relationships and dependencies between assets used in the exemplary embodiment.

FIG. 8 is a demonstrative screen capture of an asset dependency visualization according to an embodiment of the present approach.

FIG. 9 is a demonstrative screen capture of an asset dependency visualization according to an embodiment of the present approach.

FIG. 10 demonstrates a screen capture of a visualization of risk relationships and dependencies among the engineering and IT infrastructure assets according to an embodiment of the present approach.

FIG. 11 shows an embodiment of risk relationships and dependencies among the business unit and customer channel assets residing in multiple facilities.

FIGS. 12 and 13 are demonstrative screen shots containing contextual risk relationship and dependency information from an exemplary embodiment of the present approach.

FIG. 14 shows an embodiment of a risk horizon forecast.

FIG. 15 is a screen shot from an embodiment showing asset models and work templates.

FIG. 16 illustrates use of a bill of work to generate as fine-grain work template.

FIG. 17 illustrates an asset model data screen from an embodiment of the present approach.

FIG. 18 demonstrates an audit report in an embodiment of the present approach.

FIGS. 19-21 illustrate exemplary methods for work order and change requests processes to access shared a work template library and shared asset database.

FIG. 22 illustrates an exemplary screen capture showing preventative maintenance scheduling via a work order process.

FIG. 23 illustrates an exemplary screen capture of work tasks relating to a change request.

FIG. 24 shows a demonstrative screen capture of perform maintenance work through the change request process.

FIG. 25 illustrates an embodiment of a change request implementation plan.

FIG. 26 illustrates an exemplary process for automatic standards benchmarking and evolution based on an integrated incident process.

FIGS. 27-28 show exemplary screen captures of records relating to an incident report.

FIG. 29 illustrates an exemplary document incident impact on an asset.

FIG. 30 is an exemplary site record in an embodiment of the present approach.

FIG. 31 illustrates an exemplary service level agreement.

FIGS. 32-33 are exemplary analytics reports generated in an embodiment.

FIG. 34 illustrates exemplary incident analytics reports generated in an embodiment.

FIG. 35 shows an exemplary method for creating a preventative maintenance template.

FIG. 36 shows an embodiment of an asset monitoring method.

FIG. 37 shows an embodiment of a method for custom asset monitoring.

FIG. 38 illustrates an example for mobile asset monitoring and reporting.

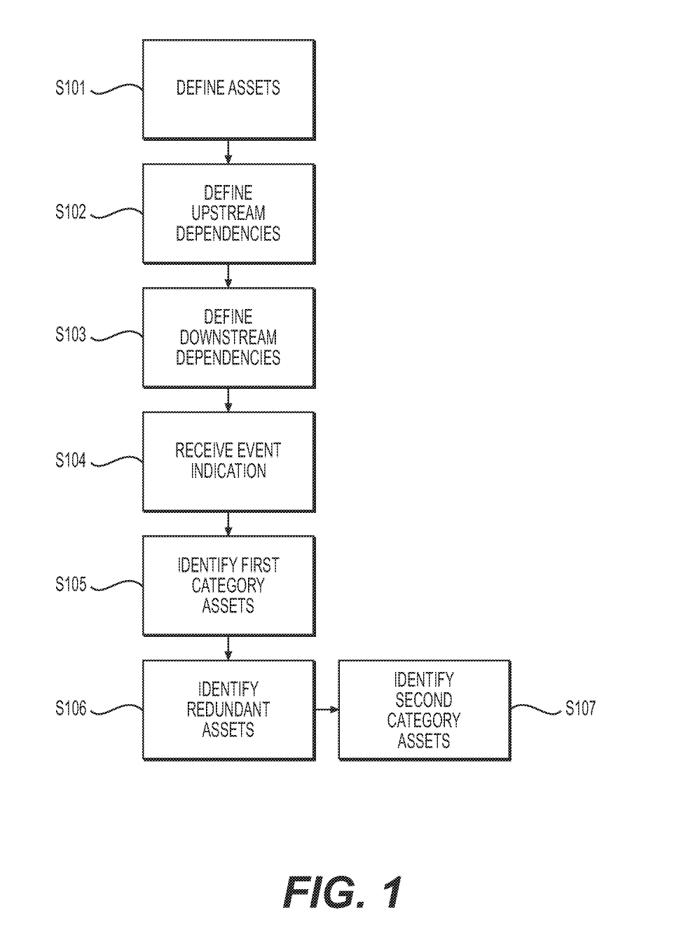

### DESCRIPTION

A detailed description of exemplary systems and methods for integrated mission critical ecosystem management is presented below. The explanation will be by way of exemplary embodiments to which the scope of the present application is not limited.

The present approach addresses issues common to data center management, notably, but not limited to, the minimization of critical infrastructure downtime, which can lead to interruption of service for both customers and internal parties. The high cost of service interruption may necessitate the creation of a mapping of assets and facility dependencies to gain a thorough understanding of the possible points of failure and take appropriate steps to mitigate the risks to those dependencies. These risks may be, but are not limited to, external events, internal asset failures, and planned and unplanned maintenance whose necessity may be identified through monitoring of assets, standardized maintenance requirements which take place at specified intervals, or the documentation of incidents.

By integrating the management of a single facility's engineering and IT infrastructure, with the management of inter-facility risks to mission-critical business functions, the systems and methods described herein may yield many advantages over systems and methods specializing in any one these aspects alone. The systems and methods described herein may provide timely, accurate, and valuable information to the owner/operator by gathering and integrating information about, but not limited to, any combination of:
(1) A particular infrastructure asset's life cycle from inception to termination;
(2) Dependencies among related physical and non-physical assets within the same facility;
(3) Dependencies among facilities and assets, both physical and non-physical, around the world; acid
(4) External, relevant data sources which may represent increased risk to asset dependencies or inter-facility dependencies.

For instance, gathering information about each planned event (e.g. change requests, work orders 24, as described below), each unplanned event (Incident 14, Asset Monitor 7, etc.), the relationship of these events to the specific assets involved, and the external factors which may have been involved, allow for an integrated view of ever-changing risks and potential impact to the organization's value. In this way, a particular planned event can be reviewed with greater awareness of both intra and inter-facility risk and potential impact. Similarly, new risk factors introduced through an unplanned event can be quickly assessed, correlated with any relevant internal or external factors, and appropriate mitigation actions efficiently taken. The systems and methods described herein may be used to automatically assess both internal and external planned and unplanned events, to determine risk and potential impact within and across facilities, with high speed and accuracy, thereby reducing the frequency and duration of unintentional, high-risk/high-impact circumstances. Furthermore, efficient, standardized operation and maintenance of all infrastructure assets across a portfolio can be better ensured using certain aspects of exemplary embodiments. For example, because the systems and methods described herein can automatically identify audit periods for which no maintenance activities have been planned or executed for a particular asset of a particular classification, the owner/operators can be automatically contacted and prompted to complete the outstanding maintenance activities. Thus, owner/operators are less likely to pay fines for failed audits, and infrastructure asset life may be maximized through standardized maintenance practices across the portfolio.

One demonstrative embodiment of the present approach is the Mission Critical Information Management (MCIM) platform, developed by Fulcrum Collaborations, LLC. The MCIM platform provides core maintenance and operating functions to ensure efficient and effective delivery of an organization's entire value chain, from the critical engineering and IT infrastructure within a single facility, all the way to the globally dispersed business units and customer channels which consume the application, data, telecommunication and other IT services they collectively support. MCIM provides rigorous governance, business intelligence and reporting typically through three strategic functions: Availability and Risk Management, Efficiency Planning, and Audit Readiness. Incorporating various aspects of the present approach, MCIM supports healthy Data Center performance and maximum availability of the Engineering and IT infrastructure networks and application services to internal business units and external customer channels downstream.

The present approach provides numerous advantageous features related to managing an organization's mission critical ecosystem. These features are described below in more detail, and depicted in the drawings.

The present approach allows for the identification of an asset's upstream and downstream dependencies, and the advantageous use of such dependencies and dependency data in various aspects of integrated mission critical ecosystem management. Generally, asset dependencies may reflect both upstream and downstream dependencies among various types of assets, which may be used to define a mission critical part of an organization's value chain.

Embodiments of the present approach may provide the user with a simple, easy to use method and process for defining asset dependencies. Dependencies, in turn, enable a user to locate impacted assets (e.g., impacted during incidents), quickly identify downstream asset dependencies and risks, and confidently act to reduce recovery time during an incident and in emergency response scenarios. Asset dependencies may also be capable of deriving the tier topology and redundancy configuration of a site, based on the network of assets and the dependency records which connect them. This information can then be automatically evaluated via the system's incident prevention module to drive proactive warnings and enforce risk management protocols both within and across sites, to prevent cascading failures both within and across facilities.

For example, if a primary site is scheduled to a perform high-risk maintenance effort under a change request which will temporarily reduce the site's redundancy level (and therefore increase probability of an impact incident), the present approach can warn or prevent a user at a backup/dependent site from scheduling work that could result in a simultaneous reduced redundancy level at the backup site. Such a warning ensures that the backup site is fully capable of instantaneously taking over the primary site's mission critical functions in the event that an impact event (incident) does occur at the primary site during the high-risk maintenance change request. The use of asset dependencies also provides a method and process for defining business continuity plans, which can be automatically enacted based on user defined parameters.

In the demonstrated embodiment, Asset Dependencies 5 reflect both upstream and downstream dependencies among assets 3, which in the aggregate, may help to define a mission critical part of an organization's value chain. The engineering infrastructure assets 3a at a site support each other, both in series and parallel redundant configurations (e.g. generators support uninterruptible power supplies, which support static transfer switches, which support PDU's; UPS 2 serves as a parallel redundant backup/standby to UPS 1), and as a whole, the engineering infrastructure supports the IT infrastructure assets 3b at the site (e.g. servers, server racks, etc.), which also support each other in both series and parallel redundant configurations, and in turn support application assets 3c which are distributed internally to organizational business units 3d (e.g. Sales, HR), and externally to customer channels 3e (e.g. AMTs, e-commerce, personal online accounts, consumer telecommunications services). Applications 3c, Business Units 3d and Customer Channels 3e may be dependent on assets at more than one site 20. In one aspect, the present approach provides the user 31 with a simple, easy to use method and process for defining asset dependencies in advance, which in turn enables a user to locate impacted assets 15, quickly identify downstream dependencies and risks and act with confidence to reduce recovery time during an incident 14 and in emergency response. In addition, one aspect of the system of the present approach may be capable of automatically deriving the tier topology and redundancy configuration of a site 20 based on the network of assets and dependencies created by the user 31.

Under the present approach, asset dependencies may be used to provide warnings and enforce risk management protocols, among other advantageous uses. For instance, in the exemplary embodiment, dependencies may be automatically evaluated via the system's incident prevention module to drive proactive warnings and enforce risk management protocols both within a site and across sites 20 to prevent cascading failures both with and across facilities 20 (e.g. when a primary site is scheduled to perform high-risk maintenance which will temporarily reduce its redundancy level (and therefore increase probability of impact), the system can warn, or prevent a user 31 at a backup/dependent site 20 from scheduling work 22 that could result in a reduced redundancy level at a backup site 20, ensuring that the backup site 20 will be capable of taking over the primary site's mission critical functions in the event that an impact event 14 does occur at the primary site 20 during the high-risk maintenance (9, 11, 22), for example. Asset Dependencies also provide a method and process for defining business continuity plans, which can be automatically enacted based on user 31 defined parameters. Asset dependencies can also be fully mobile enabled 37 in accordance with one embodiment of the present approach.

One of ordinary skill would appreciate that there are numerous methods for defining interdependencies between assets. The exemplary embodiment offers users a “manage dependencies” wizard that guides the user through the process of defining, modifying, and otherwise managing interdependencies. The wizard opens a graphical interface, such as a window, with three columns—upstream, asset, and downstream. Each column includes an identical list of assets at a given site. The listed assets may be limited based on the asset type (e.g., IT infrastructure assets only), by the use of radial buttons on the page. A user selects an asset in the middle column for defining dependencies, such as by checking a radial button next to the asset name or alias. The user then selects down upstream dependencies (i.e., assets that may have an effect on, or may be affected by the selected asset) in the left column, and downstream dependencies (i.e., assets that may have an effect on, or may be affected by the selected asset) in the right column. For example, an air handling unit (an engineering infrastructure asset) might be supported by a water chiller and redundant power panels. The air handling unit might be used to support two high-density servers. A user would identify the chiller and power panels as upstream dependencies, and the servers as downstream dependencies of the air handler unit. Under the present approach, the dependencies may be used to warn users or operators that, for example, maintenance on the water chiller may impact the air handling unit, and as a result, may also impact the servers.

One of ordinary skill understands that assets comprising an organization's value chain typically fall into five categories:
(1) Engineering Infrastructure Assets: Engineering infrastructure assets may be located at and/or associated with a physical site support each other. Physical engineering assets may include, as examples, generators, uninterruptible power supplies (UPS), chillers, power distribution units (PDUs), that provide power, cooling, fire alarm and suppression, plumbing, security, and the like to support critical IT infrastructure and/or facility residents and business units. Engineering infrastructure assets may be in series and/or parallel redundant configurations. For example, generators support UPSs, which in turn support static transfer switches, which support PDUs. As another example, a secondary UPS (UPS 2) may serve as a parallel redundant backup/standby to primary UPS (UPS 1). Engineering infrastructure assets reside in areas within and around sites. As a whole, the engineering infrastructure assets typically support the second and third category of assets—IT infrastructure assets and internal business units.
(2) IT Infrastructure Assets: IT infrastructure assets at a site may include, for example, physical IT assets such as racks, servers, storage, processing and networking gear, which may rely upon facility engineering infrastructure for critical power and cooling in order to support uninterrupted provisioning of applications, data, telecom, and other IT infrastructure services. IT infrastructure assets may also support each other, both in series and parallel redundant configurations. IT infrastructure assets may, in turn, support application assets.
(3) Internal Business Units: Internal business units are typically non-physical assets that consume application services, and rely on the availability of data and/or telecom and utility services provided by engineering assets and IT infrastructure assets at a facility. Examples include human resources (HR), sales, customer service, etc. Application Assets: Application assets are typically software applications. These assets are usually distributed to and support two categories of assets—internal business units and customer channels.
(4) Application Assets: Application assets are typically software applications. These assets are usually distributed to and support two categories of assets—internal business units and customer channels.
(5) External Customer Channels: Customer channel assets are typically non-physical assets that represent an operational channel for delivering externally-facing application, data and/or telecom services (provided by engineering and IT infrastructure) to consumers and/or other businesses. Examples of customer channels include automatic teller machines (ATMs), e-commerce websites, personal online accounts, and consumer telecommunications services.

It should be appreciated that application assets, business units, and customer channels may be dependent on assets at more than one site.

The exemplary embodiment of the present approach provides numerous advantageous features for each asset type. For example, with respect to engineering infrastructure assets, MCIM allows a user to view asset nameplate information; work order, change request, and incident history; asset monitoring performance history; interdependencies with other assets; cost, depreciation, warranty and lifecycle information; and other data relating to each asset. One of ordinary skill in the art will appreciate that any combination of these features may be incorporated into embodiments of the present approach.

MCIM also provides supporting methods and processes for engineering and IT infrastructure assets, whereby: (1) preventive maintenance, projects, and other standard operating procedures can be carried out on engineering infrastructure assets via change requests and/or work orders, in accordance with an integrated standards module; (2) associated risks to interdependent physical and non-physical assets (both within and across sites) are documented and managed via (a) an integrated asset dependency mapping component, and (b) an integrated change request/change control process; (3) engineering infrastructure asset performance metrics can be monitored via an integrated asset monitoring component (allowing web/mobile user entry, or real-time data feed integration from external monitoring sources, among other features); (4) incidents involving engineering infrastructure assets can be documented and automatically analyzed via an integrated incident documentation method and process to (a) support engineering infrastructure asset lifecycle forecasting/planning, (b) mitigate engineering infrastructure asset failure risk before failure occurs through a holistic perspective of the engineering infrastructure asset's life history, and (c) enable continuous process and procedure improvement towards the goal of maximizing uptime availability and resiliency of individual engineering infrastructure assets and the organization's value chain as a whole; (5) engineering infrastructure asset records can be logically grouped within area records (reflective of their actual physical location), which in turn reside within site records, enabling an organization to instantly identify the location of spare/replacement parts/units when engineering infrastructure asset failures (incidents) occur, thereby reducing the recovery time and maximizing uptime. One of ordinary skill in the art will appreciate that any combination of these features may be incorporated into embodiments of the present approach.

As another example, with respect to IT infrastructure assets, MCIM permits a user to view asset nameplate information, work order, change request and incident history, asset monitoring performance history, interdependencies with other assets, cost, depreciation, warranty and lifecycle information, and other data relating to each asset. MCIM also provides supporting methods and processes whereby: (1) preventive maintenance, projects, and other standard operating procedures can be carried out on IT Infrastructure assets via change requests and/or work orders, in accordance with the integrated standards module; (2) associated risks to interdependent physical and non-physical assets (both within and across sites) are documented and managed via (a) an integrated asset dependency mapping component, and (b) an integrated change request/change control process; (3) IT infrastructure asset performance metrics can be monitored via an integrated asset monitoring component (allowing web/mobile user entry, or real-time data feed integration from external monitoring sources); (4) incidents involving IT infrastructure assets can be documented and automatically analyzed via an integrated incident documentation method and process to (a) support IT infrastructure asset lifecycle forecasting/planning, (b) mitigate IT infrastructure asset failure risk before failure occurs through a holistic perspective of the IT Infrastructure asset's life history, and (c) enable continuous process and procedure improvement towards the goal of maximizing uptime availability and resiliency of individual IT Infrastructure assets and the organization's value chain as a whole; (5) IT infrastructure asset records can be logically grouped within area records (reflective of their actual physical location), which in turn reside within site records, enabling an organization to instantly identify the location of spare/replacement parts/units when IT Infrastructure asset failures (incidents) occur, thereby reducing the recovery time and maximizing uptime. One of ordinary skill in the art will appreciate that any combination of these features may be incorporated into embodiments of the present approach.

As another example, with respect to application assets, MCIM allows a user to view application asset information, change request risk exposure and incident history, interdependencies with other assets, and other data relating to each asset. MCIM also provides supporting methods and processes whereby: (1) associated risks to interdependent non-physical assets (both within and across sites) are documented and managed via (a) an integrated asset dependency mapping component, and (b) an integrated change request/change control process; (2) incidents involving application assets can be documented and automatically analyzed via an integrated incident documentation method and process to (a) support application asset lifecycle forecasting/planning, (b) mitigate application asset failure risk before failure occurs through a holistic view of supporting engineering and IT infrastructure asset systems within and across supporting sites, and (c) enable continuous process and procedure improvement towards the goal of maximizing uptime availability and resiliency of application assets and the organization's value chain as a whole. One of ordinary skill in the art will appreciate that any combination of these features may be incorporated into embodiments of the present approach.

As another example, with respect to internal business units, MCIM allows a user to view asset information, change request risk exposure and incident history, interdependencies with other assets, and other data relating to each asset. MCIM also provides supporting methods and processes whereby: (1) associated risks to interdependent non-physical assets (both within and across sites) are documented and managed via (a) an integrated asset dependency mapping component, and (b) an integrated change request/change control process; (2) incidents involving internal business unit assets can be documented and automatically analyzed via an integrated incident documentation method and process to (a) support internal business unit asset planning (b) mitigate internal business unit asset failure risk before failure occurs through a holistic view of supporting engineering and IT infrastructure asset systems and application assets within and across supporting sites, and (c) enable continuous process and procedure improvement towards the goal of maximizing uptime availability and resiliency of internal business unit assets and the organization's value chain as a whole. One of ordinary skill in the art will appreciate that any combination of these features may be incorporated into embodiments of the present approach.

As discussed above, the present approach allows for identifying an organization's assets. The system and method may incorporate various data for each asset. In some embodiments, a user may enter data in data fields relating to each asset. Alternatively, the system may auto-populate all or a portion of the data fields for one or more assets. One of ordinary skill would understand from the teachings herein that it is advantageous to enter certain types of data for each asset. The exemplary embodiment of the present approach includes modules for entering data related to assets. Assets 3 are a central component of the exemplary embodiment, and include the Engineering Infrastructure 3a, IT Infrastructure (physical assets) 3b, Applications 3c, Internal Business Units 3d and External Customer Channels 3e (non-physical assets), which together help to form the value chain of an organization. The present approach provides a simple yet comprehensive method and process for managing mission critical assets. From a single system screen, a user 31 can view asset nameplate information, maintenance 11 and incident 15 history, asset monitoring performance history 7, interdependencies with related assets 5, cost, depreciation, warranty and lifecycle information and more.

As described elsewhere, assets may reside in areas 2 within and around sites 20. The present approach provides a system and method whereby preventive maintenance 22c and projects 22a may be carried out on assets in accordance with an integrated standards authoring process 21, and associated risks to interdependent physical and non-physical assets (both within and across sites) may be documented and managed via (1) an integrated asset dependency mapping component 5, and (2) an integrated change request/change control process 9. Asset performance metrics may be monitored via an integrated Asset Monitoring component 7 (allowing manual/mobile 37 user 31 entry, or real-time data feed integration from external monitoring sources) and incidents may be documented and automatically analyzed via an integrated Incident Documentation method and process 14 to (a) support asset lifecycle forecasting/planning, (b) mitigate asset failure risk before failure occurs through a holistic perspective of the asset's life history, and (c) enable continuous process and procedure improvement towards the goal of maximizing uptime availability and resiliency of individual assets and the organization's value chain as a whole.

In one embodiment of the present approach, physical asset records can be logically grouped within area 2 records (reflective of their actual physical location), which in turn reside within site 20 records, enabling an organization to instantly identify the location of spare/replacement parts/units when asset failures 15 occur, thereby reducing the recovery time and maximizing uptime. Assets can also be fully mobile enabled 37 in accordance with one embodiment of the present approach.

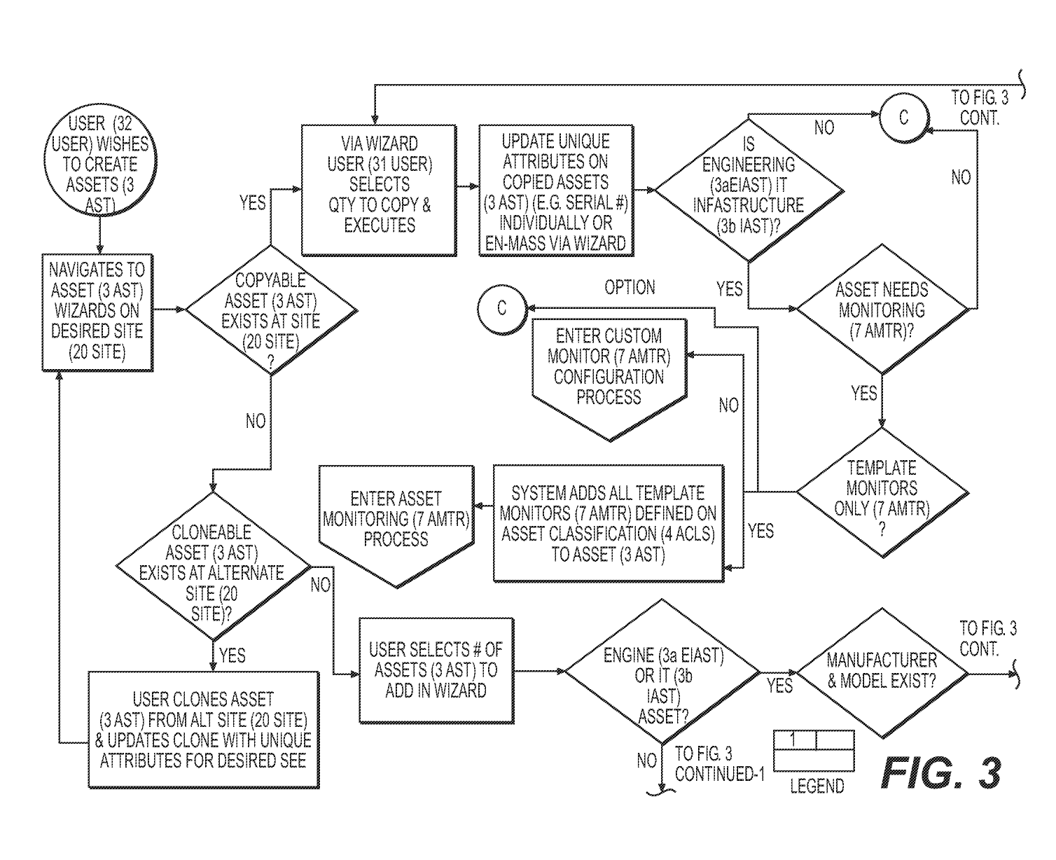

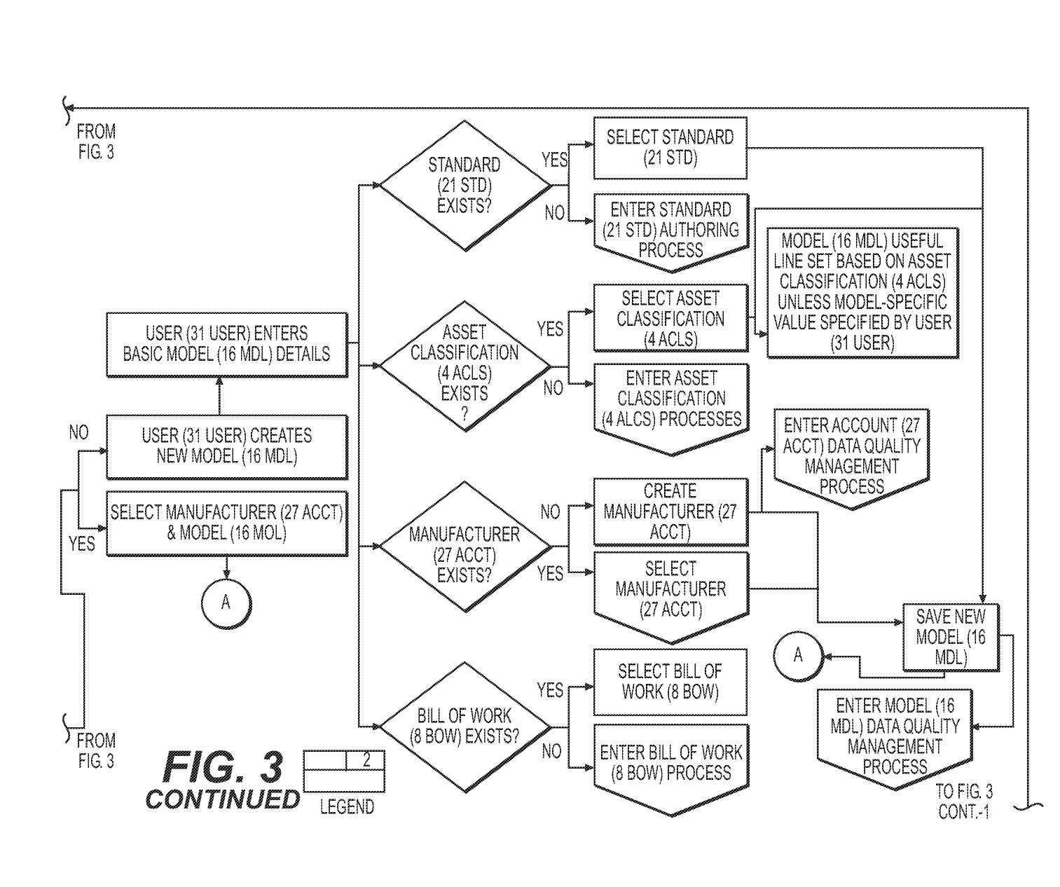

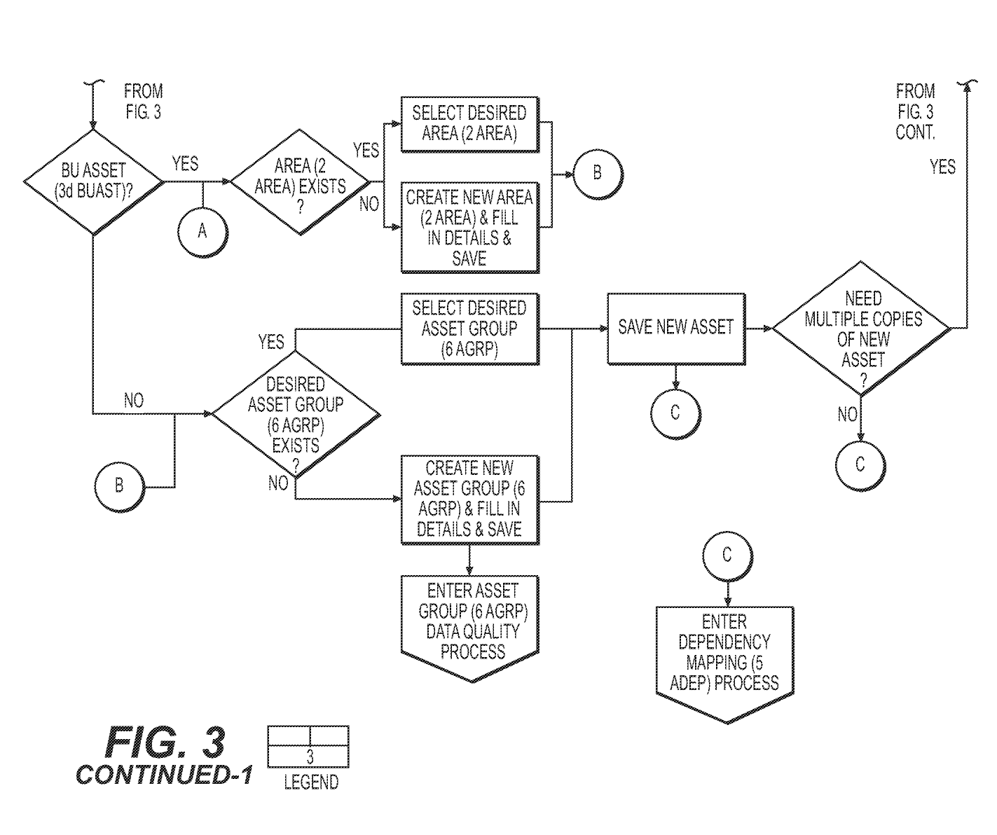

One of ordinary skill will appreciate that there are numerous methods for creating an asset object in a system. For instance, a method such as shown in the exemplary embodiment in FIG. 3 may be used. As with other data fields described herein, one of ordinary skill may choose to use different labels for each data field, and might determine that not all of the illustrative data fields used in the exemplary embodiment are necessary.

One of ordinary skill would appreciate that numerous methods are available for entering data relating to one or more assets. In the exemplary embodiment, a user may select an “add/remove” wizard for engineering infrastructure assets, IT infrastructure assets, application assets, business unit assets, and customer channel assets. The system then displays a number of data fields for the asset type. For example, for an engineering infrastructure asset, the exemplary embodiment provides fields for name, record type (e.g., engineering infrastructure, IT infrastructure, etc.), alias, asset group (described elsewhere), area (described elsewhere), manufacturer (which may include pre-loaded manufacturers), model, manufacturing date, install date, warranty, warranty expiration date, asset ID (usually automatically created), asset status, asset priority (relative to other assets at the site), active (e.g., operating), critical (e.g., whether the asset is deemed critical to the IT infrastructure of the site), include in rounds (e.g., if the asset should be listed on schedules for performing routine equipment checks), sequence for rounds, model number, serial number, tag number (usually automatically created), and recorded cost (useful for incorporating accounting functions such as depreciation), among others. A record for a business unit asset may include fields for alias, asset group (e.g., common business purpose, line of business, or management), area, unit number, allocated square feet, asset priority, and asset status, among others. One of ordinary skill would understand that other data fields may be used in connection with one or more of these exemplary fields.

One of ordinary skill in the art would appreciate that a main cause of error in the management of most systems is the entrance of human error, the effects of which are exacerbated by the specific area in which the error takes place. One of the most foundational aspects of assets, and by extension the myriad points of intersection assets have within an organization's portfolio-wide mission critical ecosystem, is the taxonomy of asset classifications. The relative advantage of ensuring accuracy in this particular area is therefore of prime importance. One of ordinary skill in the art would appreciate that the use of techniques to avoid human error is highly valuable; one such tool is the use of abstraction to limit the need of users to utilize specific domain knowledge and thereby limit the possibility of mistakes or limited knowledge, among other possible causes of error, and allows for the use of abstraction to conveniently manage, classify, and administer assets and related data with consistency across the entire organization. Abstraction simplifies the process of entering data to remove the possibility of typographical errors, inconsistent naming and data entry practices, and other problems that the human element introduces. For example, assets typically fall into an asset classification and have a manufacturer. Abstraction enables the system to generate models for a manufacturer of an asset type, standards for an asset classification, and work templates for models and standards. These concepts are addressed herein, with reference to the exemplary embodiment as but one example of the present approach.

The present approach permits the use of asset classifications to conveniently manage assets via abstraction. In the exemplary embodiment, Asset Classifications 4 comprise a standards-based library/system by which all physical assets 3a, 3b are segmented, administered and managed with consistency across a global portfolio. Each manufacturer model 16 can be classified under a single Asset Classification. Each classification, in turn, may have associated performance attributes, such that each asset identified in an organization has global consistency in asset performance attributes (e.g. Volts, Amps, Gallons, Tons, etc.) monitored 7 for each installed instance of the model 16. In turn, this permits capacity planning and energy efficiency measurement and management within and across Asset Classifications. Each classification may also be subdivided into main classifications, grouped in some manner according to similar characteristics, assigned position in a hierarchy of classifications, or assigned a useful life for the classification among other manipulations. Asset classifications are also fully mobile enabled 37. One of ordinary skill in the art would appreciate the utility of altering the asset classification of an asset, or number of assets, through a mobile device, viewing the associated monitoring data with that asset classification, and viewing the frequency of that classification globally or site specifically, among other activities. The abstracted nature of asset classifications further increases the utility of using, manipulating, or creating, among other available actions, asset classifications from a mobile device due to the factors associated with a mobile device, such as a smaller screen, limited processing power, wireless connections, limited keyboard, or the environment in which the mobile device is being used which may contribute to distraction, among other factors, by minimizing the likelihood of human error.

In the exemplary embodiment a record for an asset classification may include fields for the main classification, asset family, “child” asset classifications which may be those classifications with a hierarchical or dependent relationship to the classification, the average useful life of the classification, among others. The fields may be automatically input by the system or may be input by the user.

One of ordinary skill in the art would recognize that models represent one of the foundational points of data intersection for physical assets due to the inherent information present in a model, notably its position as a junction among a large number of physical assets, thereby lending itself to act as a junction between assets and a number of related processes, methods, and activities.

In the present approach models may be a key intersection point between the Asset Classification 4, Standards Authoring 21 and Bill of Work 8 Modules in MCIM. Models are used to track manufacturer-specific attributes/nuances for all installed manufacturer 27 models of physical assets 3a, 3b owned and/or operated within an organizations portfolio of sites 20. Models allow for designation of any combination of manufacturer-recommended asset useful life, as well as manufacturer-recommended prescription 8 of standard operating procedures 22b and preventive maintenance 22c for a given asset model (if different from organizationally defined parameters 21), among other related model related activities and attributes. Models assist in organizing and aggregating the physical assets 3a, 3b of an organization under specific manufacturers 27 for use in, among myriad other functions, purchasing negotiations, automated distribution of relevant flash reports, analysis of manufacturer quality, and simplification of the user 31 experience while further enhancing global data consistency 36.

In the exemplary embodiment of the present approach models can also be tightly integrated with MCIM analytics, enabling a wide array of insightful business intelligence (e.g. purchasing intelligence, lifecycle benchmarking, etc.). Models can also be fully mobile enabled 37.

Model Capacities are used to designate manufacturer 27 specified maximum capacity ratings for specific performance attributes of various asset models 16, in a standardized format which can be automatically merged with asset-specific monitoring 7 for global reporting and benchmarking (e.g. capacity planning, space planning, etc.). Model Capacities differ from Asset Monitors 7 in that Model Capacities represent the absolute maximum rating of a particular performance attribute, whereas Asset Monitors 7 allow for the definition of organizationally preferred performance thresholds, which often incorporate a margin of safety less than the absolute maximum rating of the particular asset model 16, as specified by the manufacturer 27 (e.g. a 500 KW manufacturer rated UPS may be organizationally mandated not to exceed 480 KW 7 based on environmental dependencies 5 and/or circumstances, or general organizational Standards 21). Model Capacities can also be fully mobile enabled 37.

One of ordinary skill in the art would appreciate the utility of grouping assets using a flexible process which may allow for group creation according situational necessity. Considering the wide reach, importance, and number assets in a facility or global portfolio the ability to segment assets into groups for creating a sequence to monitor the attributes of an assets in a physical or non-physical location, part replacement, predictive, proactive, reactive or preventative maintenance, investigation into anomalous behavior, among many other possible considerations, desired results or motivations.

Grouping of assets may be used to conveniently schedule and monitor tasks related to a group of assets (e.g., common maintenance, upgrades, etc.) and represents is versatile tool for use in various purposes (e.g. grouping engineering and IT infrastructure assets 3a, 3b for easy preventive maintenance 22c work order 24 assignment, grouping engineering and IT infrastructure assets 3a, 3b for maximum efficiency when performing routine rounds 7 via mobile device 37, grouping internal business units 3d under a corporate line of business, etc.). Groupings of assets may also represent a flexible tool for assigning one or many users to the completion of the task for which the group was created. One of ordinary skill would appreciate that in addition to the advantages described above there are numerous advantages derived from the ability to create groups, alter a group in a meaningful way, move assets between groups, or move users assignments to groups, among other uses and manipulations possible through a mobile device.

One of ordinary skill would appreciate that numerous methods are available for entering data relating to one or more asset groups. In the present approach asset groups may be created in a variety of ways, from multiple points in the system, depending on their intended use or their relationship to another object. For example, asset groups may be created in the same “add/remove” wizard for engineering infrastructure assets, IT infrastructure assets, applications assets, business units assets, and customer channels assets. Once a user has chosen to create a new group the wizard may request the user assign fill fields related to asset group name, a description, a number which may apply for sequence, one or more engineers, and its status as active or inactive, all of which may be populated by the system. The present approach also allows for the dynamic assignment of assets to the group using a variety of contextual information about the asset which may include the area in which the asset resides, the asset's alias, the asset's history, and the like using a wizard among other means. Asset groups may also be utilized to assign specific work, among other features related to asset manipulation, diagnostics, history, dependencies, and forecasting, to those physical or non-physical assets at the discretion of users.

One of ordinary skill in the art would appreciate the necessity of monitoring changes to assets in an organization's portfolio of data centers according the relevant metrics that may describe the past, present or future state of an asset. The accrual of this information may provide benefit in the ability to proactively or reactively asses the current state of an asset dependency chain, recognize and mitigate risk of failure, maximize uptime, asses manufacture quality, asses the integrity of a redundancy chain, inform the timing and type of work performed on assets, plan facility layout, inform the evolution of standards, inter- and intra-organizational benchmarking, automatic issuance of work to remedy the appearance of anomalous readings, among myriad other automations and benefits. These benefits are dependent on the ability to incorporate this asset specific data into a larger system which can correlate and analyze these numerous streams of data to provide the fore mentioned analysis and insights. The value of a system which could integrate this data and provide these benefits would rapidly increase as the system accrued more data over time, permitting the recognition of new patterns and insights, cyclically increasing the relative value of each of the fore mentioned benefits.

One of ordinary skill in the art would appreciate the variety of methods asset monitoring data is input and the variety of data types associated with the myriad types of assets in an organization's portfolio. Therefore, the relative utility and value of system may be correlated to the ability of this system to accommodate these various methods of input ranging from point input using a mobile device, automated tracking of assets metrics via an automated system, among other methods, and these varied data stream types.

Under the present approach, a system may monitor (or receive from external sources such as monitors and sensors) various operating parameters or other data for assets, compare measured values against targets or thresholds, and initiate protocol based on measurements. For example, in the exemplary embodiment, Asset Monitors 7 allow an organization to define, track and trend specific performance metrics for Engineering and IT infrastructure assets 3a, 3b (e.g. A/C Return Air Temperature, Server Inlet Temperature, UPS Output KW/KVA, Fuel Tank Level, etc.). Asset Monitors may also provide configurable workflow automation to alert designated users or other staff 31 or 28 of abnormal asset performance conditions as they are happening, help spot and flag imminent failures 15, and initiate preventive actions (e.g. automatically open a problem ticket 24, 14 and assign an investigative work order 24 in real-time, or automatically generate an incident 14 based on asset priority/criticality, and notify all relevant parties 31, 28 in real-time). Asset Monitors may also integrate with MCIM analytics, including out-of-the-box reports, and configurable reports, to support various organizational initiatives (e.g. Data Center Cooling efficiency projects, PUE Improvement projects, etc.). Asset Monitors can also be fully mobile enabled 37 and may be automatically updated via a pre-built integration API 38, supporting real-time connections to any external asset monitoring system capable of transmitting data via industry standard integration protocols or which provides data which may be manually or automatically transformed into a form amenable to the present approach, in accordance with embodiments of the present approach.

Embodiments of the present approach allow for coordination, integration, or other activities involving change request/change control methods and processes. When combined with the other embodiments of the present approach, the risks and potential downstream impacts of planned events (such as maintenance and projects, among others) on the engineering/facility infrastructure—which underpin the IT infrastructure, and in turn the business units and customer channels of the organization, and the supply chain as a whole—can be automatically identified by the system, and mitigated before undesirable risk scenarios are realized.

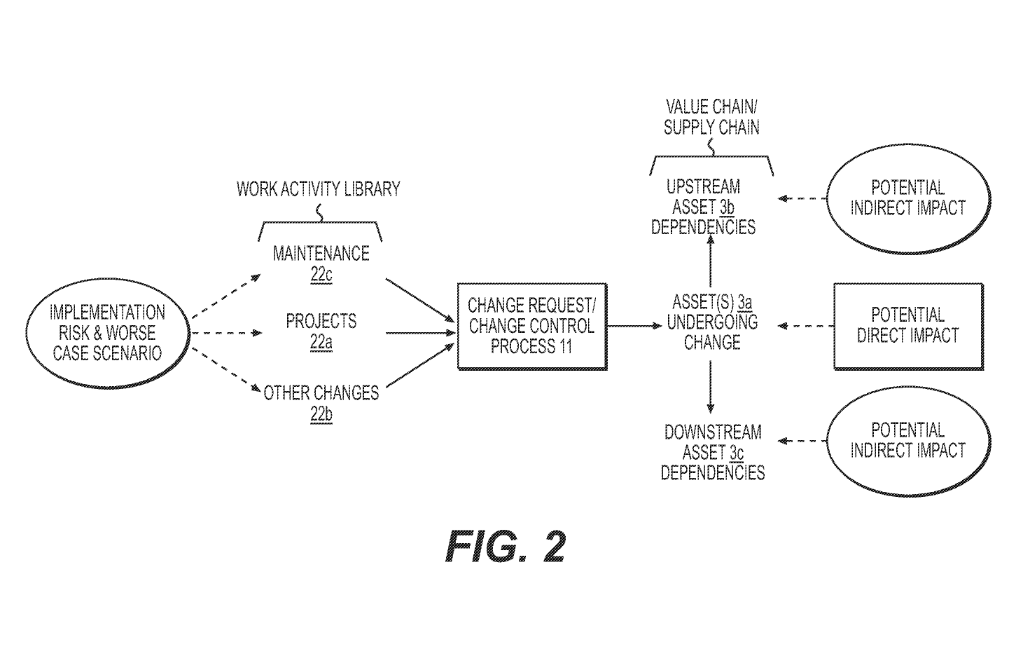

Generally, as shown in FIG. 2, Change Requests/Change Controls 9 provide a robust risk management and planning method and approval process for conducting maintenance 22c, project 22a and other change related activities 22b on assets which are important to continuous uptime of the organization's value chain or supply chain, encompassing both supporting (upstream) and dependent (downstream) assets and processes that may be both internal and external to the organization, as is commonly understood in the discipline of supply chain management.

Change Requests/Change Controls provide, for example, collective evaluation of (1) the risk profile of selected Work templates 22, (2) the Priority/Criticality of the assets upon which each Work template 22 is to be performed, (3) potential indirect impact to downstream and upstream assets based on asset dependencies, (4) the effect or time-based risk factors (e.g. on-peak/off-peak server traffic levels, critical operations windows, maintenance lockdown calendars, etc.), among other useful advantages.

Under the present approach, several factors can be evaluated to determine risk probability and potential organizational impact 14 of a change request, and the system can implement risk mitigation, verification and back-out plans, for example. Change requests can also integrate with the incident documentation component 14, allowing the user to create a historical linkage between incidents 14 and the change requests (or work orders 24) that were implemented as part of corrective actions, for example. Change requests can also be linked together to form a series of work efforts, which may comprise an entire project. The present approach provides a system and processes for anticipating the risk and impact of each work effort and the overall project to the organization's value chain/supply chain. Change requests may also be fully mobile enabled 37 and provide a configurable approval process capable of adapting to a particular organization's structure, without disrupting system performance.

In the exemplary embodiment, Change Requests integrate with the MCIM Standards Authoring 21 module to pair Work templates (preventive maintenance, standard operating procedures, custom work scripts) 22c, 22b, 22a with specific Engineering and IT Infrastructure assets 3a, 3b upon which the Work templates 22 are to be performed.

The process for risk management and planning described above may be combined with the ability to assign users to perform the tasks associated with the objects and work identified in order the facilitate the performance of duties by users in a proactive, transparent, and efficient manner.

By incorporating change request tasks with asset dependency and redundancy information, tasks performed can be compared against data about the performance of work on dependent assets across multiple sites, the current status of assets, external factors which may impact the necessity of redundancy, among other factors, to ensure that the risk of downtime is minimized. For example, when a change request task is created for an asset the present approach permits analysis of the current state of the entire asset dependency stream, weighting by the type of work, including fore mentioned factors, among others, to provide a comprehensive analysis of the relative risk of the particular task to the redundancy and/or uptime of an organization. The system may inform the user that work is being performed at another site also servicing the same business unit, which has reduced the redundancy of that site, requiring the delay of the specified change request task until the redundant path is fully restored, or may inform the user that there is no offline work currently being performed on any redundant paths but that an external event has a probability of disrupting utility power, correlating the necessity and impact of the work to provide insight into implications of performance of this work, among other foreseeable situations.

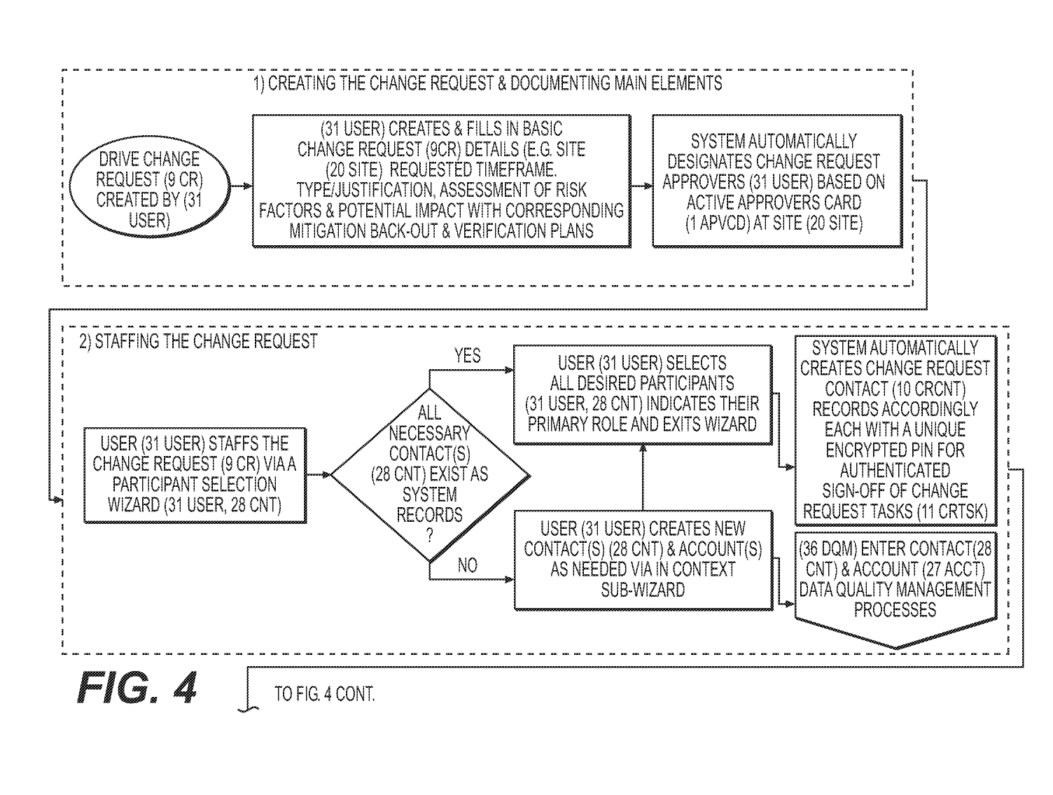

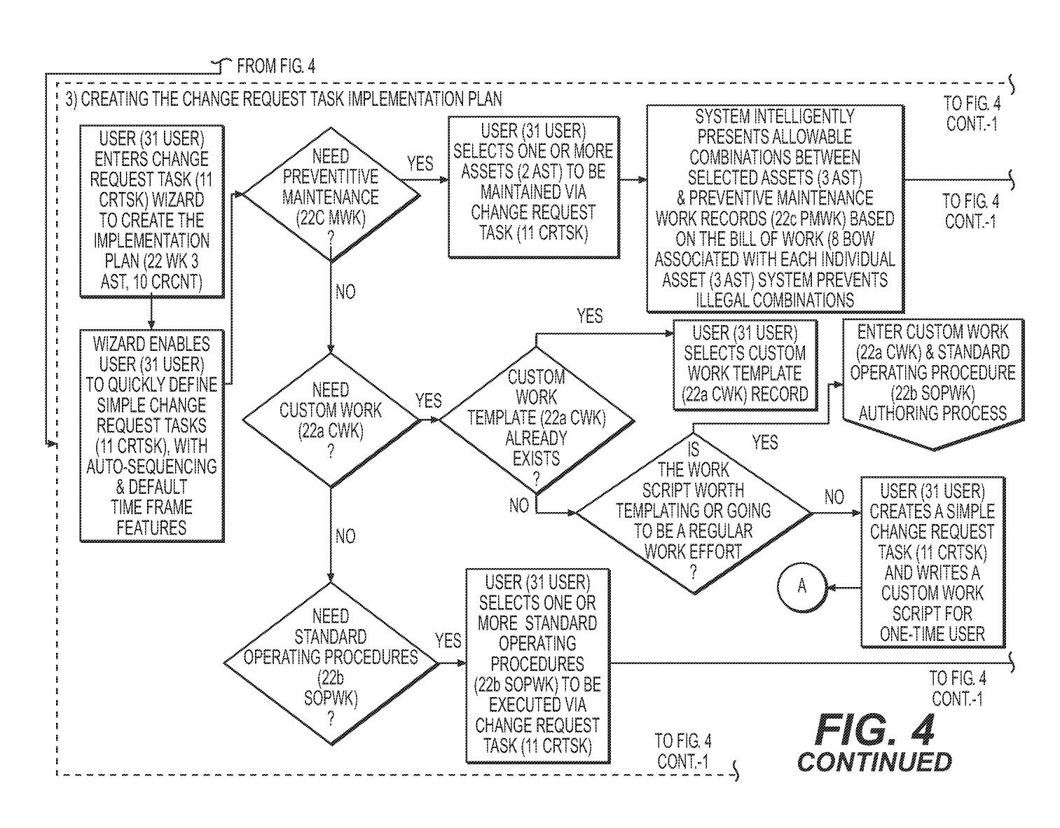

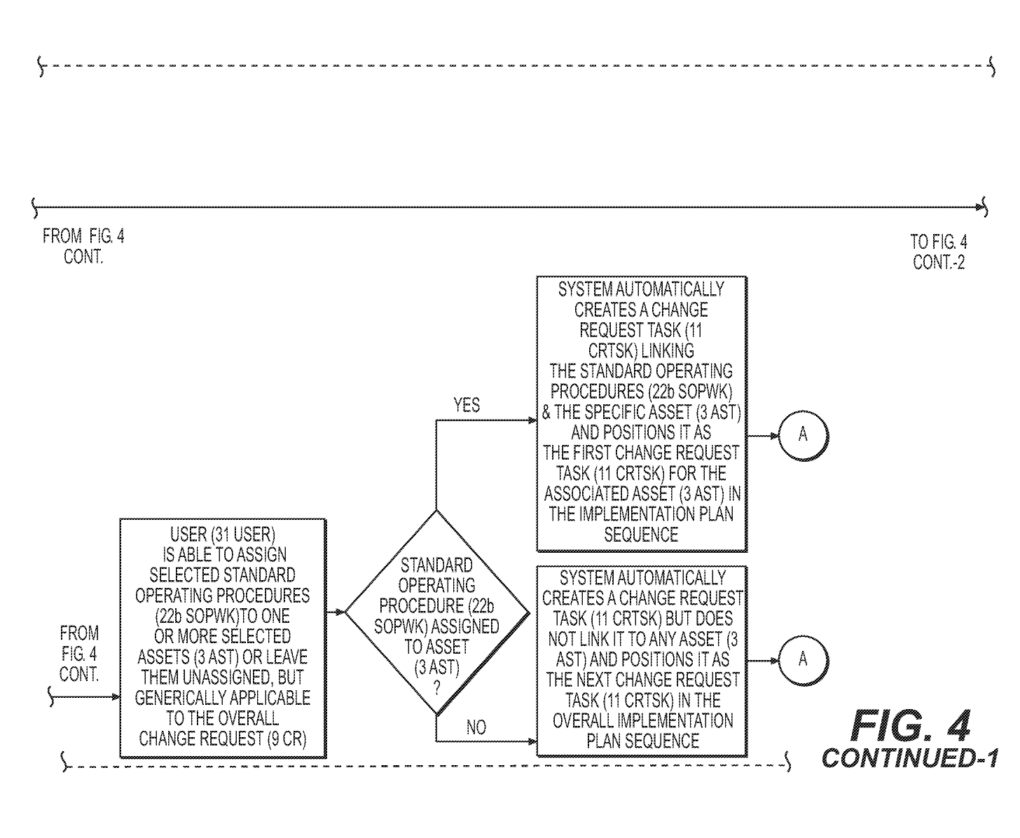

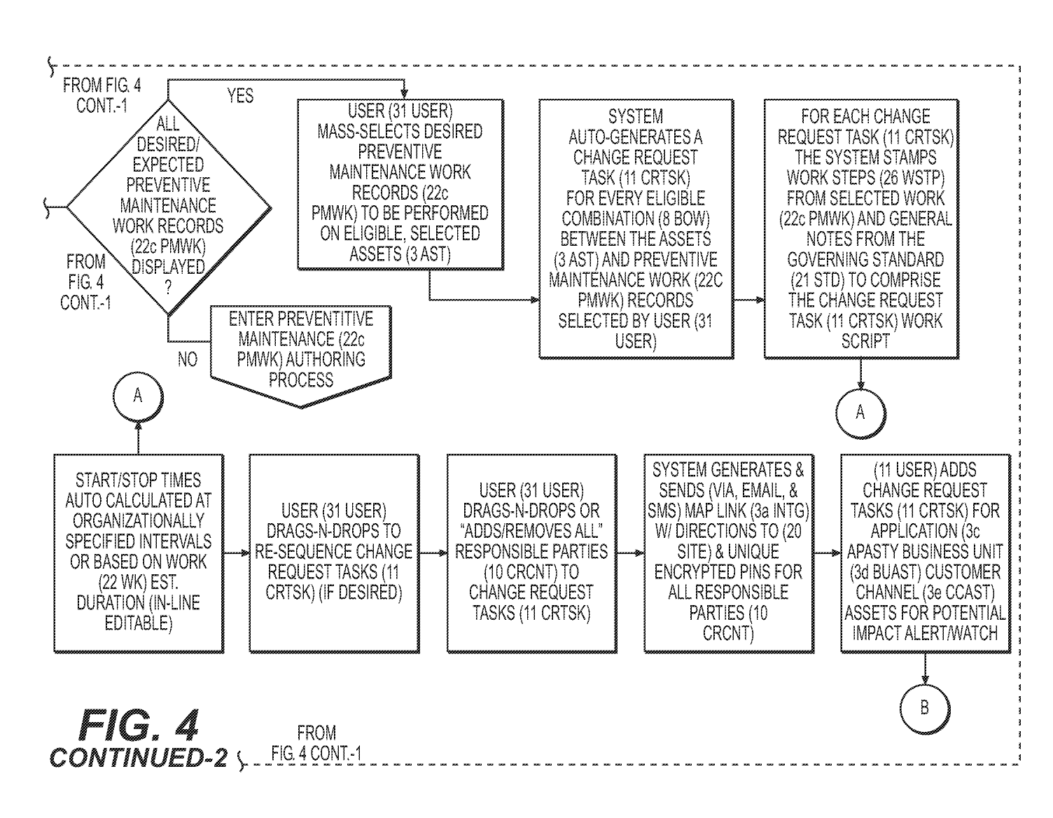

In the exemplary embodiment of the present approach, change request tasks 11 may represent a component of the change request 9 method and process, in that a single change request task may be created for each unique combination of a work template/script 22, an asset 3, and responsible parties 10, 28, 31. In one embodiment, change request tasks can be documented and sequenced via an easy to use wizard, where they collectively form an implementation plan for an entire change request 9. FIG. 4 shows a demonstrative process for documenting change request tasks.

Change request tasks can also serve as a historical receipt of (1) the work 22 performed on a specific physical asset 3a, 3b (including planned downtime, work script deviations, and any observed anomalies), (2) the responsible party(s) 10, 28, 31 associated with specific work 22 on a specific asset 3, and (3) timeframe and duration of risk exposure to a specific physical or non-physical asset as a result of the change request 9, for example. In the exemplary embodiment of the current approach change request tasks may be tightly integrated with the standards authoring 21 and audit readiness 8, 21, and can be fully mobile enabled 37 in accordance with one embodiment of the present approach which may allow the assignment, analysis, completion, or review, among other actions. Change request tasks may also include incident prevention technology, which enables automated warnings of inter-site and intra-site redundancy risks 5, when scheduling offline/high-risk work 11, 22 within internal infrastructure asset networks as well as among interdependent asset networks at other sites 20. Change request tasks can also be fully mobile enabled 37.

The present approach permits assignment of the change request task, delegation of decisions about work utilizing the insights provided, and approval of change request tasks in an automated fashion which may limit the relative workload of users, reduce the likelihood of human error, create greater transparency in the process for approval, and may direct approval to the appropriate user.

Embodiments may also include change request contacts. Change request contacts 10 generally provide a quick and simple method and process for assigning MCIM contacts 28 and users 31 to a change request 9. They may also allow for definition of roles for each contact 28 and user 31 assigned (e.g. Vendor Technician, Internal Technician, Notification Only), for example. The change request contact object may administer automated change request 9 communications to both internal and external participants (e.g. in-advance email distribution of work scripts 9, 11, 22 directions to the work site 20, encrypted PINS for responsible party 28, 31 task 11 sign-off, etc.). The change request contacts object may also provide a historical record of who, what, when and where all change request work (including specific work tasks 11) were performed, approved, or assigned among other actions. Change request contacts may also be fully mobile enabled 37 in accordance with one embodiment of the present approach.

There may be unexpected incidents which may impact the supply chain or value chain of an entity, and represent a rich data stream that can provide powerful insight into modes of failure, points of failure, best practices, redundancy requirements, indirect asset dependencies, vendor performance, employee performance, benchmarking, among other benefits. Integrating data produced by incidents into a system which can proactively assess the impact of the incident, provide analytics on cause, provide insight into work-arounds, automatically generate work to mitigate impact, proactively assess the probability of risk by correlating a number of factors both inside and outside an entity can provide material benefit to improving the overall uptime of an organization, as well as informing a wide variety of internal processes and activities.

In the present approach incidents may provide a robust method and process for documenting, approving, tracking and analyzing unplanned asset 3, site20 failures or anomalies 14, 15. Incidents can integrate with any combination of the dependency mapping 5, asset 3, asset monitoring 7 and work order 24, among other areas of the present approach, to enable a truly automated process for emergency response, impact assessment, work around implementation and improvement(s)/revision(s) to standards 21 (if appropriate). Incidents can provide collective evaluation of, but are not limited to, (1) qualitative and quantitative (downtime) impact to specific assets 3, (2) potential cascading impact(s) to dependent assets 3, 5, (3) qualitative and quantitative (downtime) impact to the entire network of interconnected assets 5 (asset systems), and (4) more. Information documented may be automatically passed through a proprietary process to produce real-time uptime and resiliency statistics, benchmarked against mission critical industry standards 19 (e.g. The Uptime Institute's Tier Standards), and segmented by any desired set of attributes, for example.

In the exemplary embodiment incidents can be tightly integrated with MCIM analytics, enabling powerful visibility into performance of the systems of physical and nonphysical assets critical to 24/7/365 uptime of the organization's value chain. Incidents can also provide a method and process for analyzing lessons learned, categorizing and isolating specific root causes of failure, which may then be mitigated from future occurrence via integration with the Standards Authoring module 21, wherein QA/QC (or other designated standards authoring users 31) revise existing maintenance and design standards 21 and/or incident prevention and emergency response procedures 22b to incorporate new measures to prevent the same failure from reoccurring at other sites 20 in the portfolio. Because, in one embodiment of the present approach, the standards 21 module may be tightly integrated with the work orders 24 and change requests 9, updates to standards 21 are instantly and globally deployable, such that outdated work scripts 22 may be immediately and seamlessly deprecated and replaced with the latest version, to be implemented by operational staff 31 without disruption. In summary, the incident documentation component enables an organization to make the shift from being reactive to proactive. Incidents can also be fully mobile enabled 37, and can provide a configurable approval process capable of adapting to a particular organization's structure, without disrupting system performance.

Incident assets may be a key component of the incident documentation 14 method and process of one embodiment of the present approach, in that an incident asset can be created for each unique combination of 1 physical or nonphysical Asset 3, and 1 failure/anomaly/risk. Incident assets can be documented via an easy to use wizard, where they collectively form a complete, detailed depiction of any combination of the timeframe, cause(s), qualitative and quantitative (downtime) result(s), and related facets of an incident 14. For example, incident assets can be tightly integrated with the asset and asset dependency 5 mappings of MCIM, which enables an organization to take prompt, decisive, actions to minimize recovery time and mitigate the risk(s) of additional cascading failure. Incident Assets can also be tightly integrated with MCIM analytics, enabling an organization to take proactive risk management/mitigation measures in real-time, across a global portfolio (e.g. suspend maintenance/project 11, 22, 24 activities at a backup site 5, 20 when a primary site experiences a partial failure). Incident Assets can also be fully mobile enabled 37.

Sites often represent one of the most foundational aspects of data center and facilities management, value chain and supply chain continuity, and organizational uptime. Therefore, sites are typically—but not always—a central component of the present approach, and include all properties, facilities, or physical pieces of real estate for which an organization wishes to track any data element relevant to maintaining an organizations value chain, supply chain, or uptime (e.g. assets 3, areas 2, change requests 9, work orders 24, incidents 14, Exceptions 13, Evaluations 12, etc.). Sites also permit the correlation of both physical and non-physical assets and processes to the physical environment in which they reside by locating those assets and processes within the context of the factors that may impact sites and regions, for example, the regional customer channel that a site supports, the utility grid which it relies upon, or the latency of data among business units.

In the present approach a portion of the utility of sites resides in the specific characteristics of the sites itself, such as, but not limited to, any combination of its physical address, redundancy configuration, number of assets present, inter- and intra-site asset dependencies, service level agreement, owner, managing account, square footage, areas, or uptime statistics, among others. In addition to the data associated directly with a site, nearly all of the data elements in the present approach are by nature tightly integrated with the site component. For example: physical (and certain nonphysical) assets exist in areas 2 within or around sites and non-physical assets 3c, 3d, 3e may be supported by networks of both physical and non-physical infrastructure assets 3a, 3b contained within and around sites. Incidents 14, change requests 9, work orders 24, and work requests 25are processed and approved (often pertaining to specific assets 3) within and around sites; SLAs 19 (against which site performance may be automatically benchmarked), positions 18, asset groups 6, asset dependencies 5, work templates 22 (e.g. standard operating procedures 22b, custom work scripts 22a), evaluations 12 and exceptions 13 to standards 21 are created and maintained for sites.

In an exemplary embodiment of the present approach the site can also be tightly integrated with MCIM analytics, including the ability to visualize 35 your sites within integrated geographical context 38, including elements such as weather, proximity of emergency spares and other external environment data (e.g. Electrical Utility Grids, etc.). Sites (and other relevant system records) benefit from pre-built system capability to integrate 38 with external Geospatial, weather and other data sources (e.g. Google Maps, etc). Another aspect of the exemplary embodiment permits the integration of incidents as they occur, either automatically registered and input through active system recognition of anomalous activity, asset monitor readings, etc., with historical incidents and their impacts on the uptime of an organization to produce real-time analytics reflecting incidents as they occur, correlating these uptime statistics with the relevant service level agreement requirements, among other factors, to provide transparency and insight into the current state of an organizations portfolio of sites, a subset of sites, or an individual site. Sites may be mobile enabled 37.

Embodiments of the present approach may include data relating to physical areas at a site or a facility, as well as the assets that reside in each area. A site may feature multiple areas. One of ordinary skill understands that areas may be comprised of critical areas or non-critical areas.

(1) Critical Areas may be one of the different types of areas which exist within or around a site (e.g. MDF Rooms, IDF Closets, Mechanical Rooms, Generator Yards, etc.) and often contain critical engineering and/or IT infrastructure assets. Critical Areas allow for storage of relevant documents and drawings (e.g. Mechanical/Electrical/Plumbing Diagrams, Single-line Diagrams, Floor Layouts, etc.), and also provide a method and display for tracking related work order/problem ticket history, as well as the engineering and IT infrastructure assets which reside within. Critical Areas can be analyzed in reporting to (1) provide visibility into energy efficiency, (2) support capacity and space planning for both physical and non-physical assets, among other useful reports.
(2) Non-Critical Areas can be one of the different types of areas which exist within or around a site (e.g. Cubicle Areas, Conference Rooms, Lobbies, etc.), and are often occupied by Internal Business Units, or serve other functions that are not necessarily critical to organizational uptime. Non-Critical Areas allow for storage of relevant documents and drawings (e.g. Space Plans, etc.), and also provide a method and display for tracking related work order/problem ticket history, as well as the internal business units who reside within them. Non-Critical Areas can be analyzed in reporting to (1) provide capacity and space usage metrics, (2) plan moves, among other useful reports.

For example, within embodiment MCIM areas may exist within or around a site (e.g. Data Room, Generator Yard, Cubicle Area), and can be comprised of various types of assets (e.g. Engineering Infrastructure 3a, IT infrastructure 3b, Internal Business Units 3d). MCIM associates documents and drawings 34 (e.g. Mechanical/Electrical/Plumbing Diagrams, Single-line Diagrams, etc.) with an area, such that relevant and/or useful documents for a given area are readily available. MCIM can display a list of assets for an area, as well as a related work order 24 and problem ticket 24, 14 history. Areas can be analyzed in reporting to (1) provide visibility into energy efficiency, (2) support capacity and space planning for both physical and non-physical assets 3, and (3) much more. Areas are also fully mobile enabled 37.

One of ordinary skill would appreciate that numerous methods are available for entering data relating to one or more areas. In the exemplary embodiment, a user may select an “add/remove critical areas” or “add/remove non-critical areas” wizard. The system then displays a number of data fields, among other information, and may also show other areas already defined for a given site. Data for other areas may be copied and used as a template for subsequently added areas. Some data fields may be automatically populated, some data fields have drop-down or other menu-selectable items, and other data fields require entry by other means (e.g., manual, data loader, etc.), Sample data fields in MCIM include area name, alias, type (e.g., cubicle space, conference room), building (if, e.g., a site has multiple buildings), floor, orientation, occupancy status, seat count, occupied seats, square footage, among others.

Management of a data center often requires a flexible method and process for site-specific definition of approver roles and approval hierarchies for any approval process at any site. Approval processes may be change requests of critical assets, incidents related to both physical and non-physical assets, work performed on assets, among others. This method and process could be easily deactivated, replaced, and/or the data associated with the card altered, to modify approver roles 31 and associated approval request routing for specific processes at specific sites 20, while preserving a historical record of former approval structures, for audit purposes. One demonstrative embodiment of the present approach would be an Approver Card, which would function as a method for implementing the fore mentioned method and process. This approver card may include fields that specify the site at which the approver card exists, the specification of the approval process(es) the card references, card status, and one or more approver, which may be arranged in a hierarchy.

Service Level Agreements (SLAs) are often a key component used in defining key performance indicators (KPIs) and benchmarking corresponding performance such as, among others, uptime availability and resiliency of individual sites 20 (or groups of sites, segmented by any desired attribute(s) e.g. region, management team 27, etc.). However, one of ordinary skill in the art would recognize that though there are standardizing organizations for some aspects of benchmarking, a robust system must be able to accommodate the variety of benchmarks which may be encountered.

In the exemplary embodiment of the present approach, SLAs can be tightly integrated with an incident 14 and performance against each Service Level Agreement (for a specified timeframe) can be derived through automated aggregation and translation of data collected via incidents 14, for any select group of sites or all sites 20 under a given SLA. The SLA module can also be tightly integrated with MCIM analytics, enabling an organization to provide both granular and executive-level reporting on performance against organizationally defined objectives. SLAs, among other purposes, serve to classify mission critical facility 20 configuration, capacity 17 and availability expectations. SLAs may be mobile enabled 37.

The oversight and maintenance of a global, regional, or single site portfolio may encounter issues in the standardization of methods, processes, or work performed on the wide array of assets present, of myriad varieties, by multiple users, especially given the technical complexity of each of those individual pieces, the requisite domain knowledge, the constantly shifting factors which influence them, etc. Beyond the challenges presented by this issue there are also numerous benefits to a system which not only over comes said issues, but extracts the available insights and value present, such as the ability to discover best practices, identify trends in assets life-cycle implications, among other useful insights and improvements.

In the present approach standards provide a robust method and process for categorizing and defining pervasive organizational processes, procedures and protocols pertaining to such items as, among others, asset life-cycle considerations, and standardized work template 22 QA/QC processes (e.g. standard operating procedures 22b, preventive maintenance 22c, custom work scripts 22a, etc.). Standards can follow a main/sub-section document structure, in accordance with one embodiment of the present approach, providing an umbrella under which all applicable work templates 22, all applicable work steps 26, all applicable manufacturer 27 models 16 and site-specific 20 exceptions 13 to the standard are reflected, ensuring global consistency 36 for an organization.

In an exemplary embodiment of the present approach standards also allow for simple, globally accessible, creation, approval and versioning of work templates 22 (and individual work steps 26), for automated, consistent prescription 8 and implementation 11, 24 on organizational assets via the Bill of Work 8 component. Standards can also be fully mobile enabled 37. However, they are not necessarily a hierarchal, top-down form of process control, but may also be, among other functions, a collaborative environment where the practices which are most effective can be identified and promoted through trial and error, easy communication utilizing the social aspects of the exemplary embodiment, or through a proprietary system of standards development and evolution.

In recognition of the nuances of a portfolio, the wide reach of standards, and likelihood that no standard is truly universally applicable, a robust system for the management of a portfolio should include provisions for exception to a standard. Given that a core function of standards is ensuring global consistency, the process for granting and monitoring an exception necessitate a method and process which is powerful, strict and well-defined, but flexible enough to accommodate the processes, which may differ markedly from organization to organization or site to site, defined by any organization.

Exceptions 13 provide a robust method and process for documenting and obtaining organizational approval when exceptions to organizational maintenance and/or design standards 21 are necessary (whether temporary or permanent in nature). Exceptions are used to thoroughly document risks, justification, and the economic and reliability impacts of granting exceptions—enabling the organization to make informed decisions regarding approval, duration of the exception and remedial action plans to bring the exception in line with organizational standards.

The exception method and process of one embodiment of the present approach may be integrated with the Standards Authoring 21 process of MCIM, providing an organization with a holistic, global view of adherence to maintenance and design standards, taking approved exceptions into account. Exceptions can be tightly integrated with MCIM analytics, which enables this powerful business intelligence at any desired level, segmented by any desired attribute(s) (e.g. Site 20, region, SLA 19, managing account 27, etc.) in accordance with aspects of the present approach. Exceptions can also be fully mobile enabled 37 and can provide a configurable approval process capable of adapting to a particular organization's structure, without disrupting system performance.

In the present approach work is a key component shared between the standards authoring 21, change request/change control 9, work order 24, and bill of work 8 components. The work component supports simple creation and approval of standard operating procedures 22b (multiple types, e.g. EMOP [emergency methods of procedure], CMOP [construction methods of procedure], DMOP [demolition methods of procedure], SMOP [standard methods of procedure], etc.), preventive maintenance templates 22c, and custom work scripts 22a, often pertinent and prescribed 8 to particular classifications 4 and models 16 of physical assets 3a, 3b. Once approved (if required), relevant work records are made available when assembling Change Request Tasks 11 under Change Requests 9, or via Work Orders 24, based on the assigned Bill of Work 8 of each Asset involved. Work records can also underpin pre-emptive compliance tracking via tight integration with the audit readiness component 8, 21.

In one embodiment of the present approach, work records can be comprised of individual work steps 26, and allow for pre-definition of required frequency (for preventive maintenance 22c), risk level, worst-case scenario (potential impact), and estimated completion timeframe (including asset downtime, if applicable). Work can also be fully mobile enabled 37 and can provide a configurable approval process capable of adapting to a particular organization's structure, without disrupting system performance.

Work assignments 23 permit linkage between the bill of work 8 and work 22 components, in that they provide a method and process for efficient, standardized use and reuse of work templates 22 across multiple bills of work 8, for assignment to specific manufacturer 27 models 16 via the Models 16 component. As the model's 16 bill of work 8 represents an organization's standardized prescription for type and frequency of preventive maintenance for a physical asset 3a, 3b, the work assignment component provides an important support function and substantially increases flexibility and standardization 21, while also substantially lessening administrative overhead. Work assignments can also be tightly integrated with analytics, allowing for simple, periodic re-evaluation of an organization's global maintenance standards 21 and protocols. Work assignments can also be fully mobile enabled 37.

In the present approach, work orders may provide a method and process for documenting, assigning 31 and completing on-demand 22a and preventive maintenance 22c work, often pertaining to specific assets and areas 2 within or around a site 20. Unlike a Change Request 9, Work Orders do not pose a substantial enough risk to the organization's value chain to warrant the extensive risk management and mitigation processes inherent in the Change Request 9 method and process. This is most often due to the following two factors: (1) low risk profile of the (single) selected Work template 22, (2) low Priority/Criticality of the asset upon which the Work is to be performed 3. On-demand type Work Orders can involve ad-hoc work scripts 22a and are most often generated as a result of observation of an abnormal condition by site staff 28, 31, by, but not limited to, monitoring 7 (whether automated via integration 38 with an external monitoring source, or via user entry), or a Work Request 25submitted by a user or contact 28, 31 (work orders are tightly integrated with Work Requests 25). Work Orders can also be fully mobile enabled 37 and can provide a configurable approval process capable of adapting to a particular organization's structure, without disrupting system performance.

Work Requests 25 are a method and process used to capture/document work requests (often made by site 20 tenants 28, 31), generate a corresponding Work Order(s) 24 and automate communications regarding status of the requests with the requester 28, 31, and involved site staff 28, 31. Work Requests may be submitted by site tenants 28, 31, site staff 28, 31 or others users associated with the organization 28, 31. In one embodiment of the present approach, the Work Request component can be integrated with the Work Order 24 component, to provide integrated reporting and fulfillment analytics from work request initiation all the way through completion of the associated work order(s) 24 generated to fulfill the Work Request. Work Requests may be captured automatically via external websites 38, internal web-forms 38, automated email handlers 38, phone, etc., among other available methods depending on the preference and/or capability of the organization. Work Requests can also be fully mobile enabled 37.

Work Steps 26 can be tightly integrated with the Standards Authoring 21 and Work Templating 22. Work Steps are pre-documented under a specific Standard 21 via an easy-to-use work template 22 creation wizard, and may or may not be related to a Standard Operating Procedure 22b, Preventive Maintenance Template 22c, or Custom Work Template 22a. Work Steps can also be tightly integrated with the Change Request/Change Control 9 process in that all work steps under a selected work template 22 are “stamped” onto Change Request Tasks 11 with which they are associated for historical purposes during the Change Request Creation Process 9 (the same process of “stamping” occurs when creating Preventive Maintenance type Work Orders 24). Whenever a work step is modified, from that moment forward the latest version will be “stamped” onto new Change Request Tasks 11 and Work Orders 24, without disrupting the historical record of past Change Request Tasks 11 or Work Orders 24. This allows QA/QC teams 28, 31 to operate independently, without disrupting operations, or allowing us of a sub-standard work template 22. Work Steps can also be fully mobile enabled 37.

One of ordinary skill in the art would appreciate that a method which allowed for flexible creation of groupings of work to be assigned to subsets of specific assets, models, asset groups, among other sets of assets, depending on the requirements of those sets ensuring consistent adherence to standards, which may dictate that work be performed on assets at specific intervals, steps be performed in specified order, among other requirements. Bills of work therefore further empower the evolution of standards by incorporating the insights gained through the practice of work associated with assets according to those standards (described elsewhere). When abstraction is incorporated into the system, as discussed above, the assignment of a work template (described elsewhere) to an asset model may trickle down to all assets in the particular model 16 for holistic, yet fine-grained prescription, measurement, management, and audit of an organization's preventive maintenance standards 21.

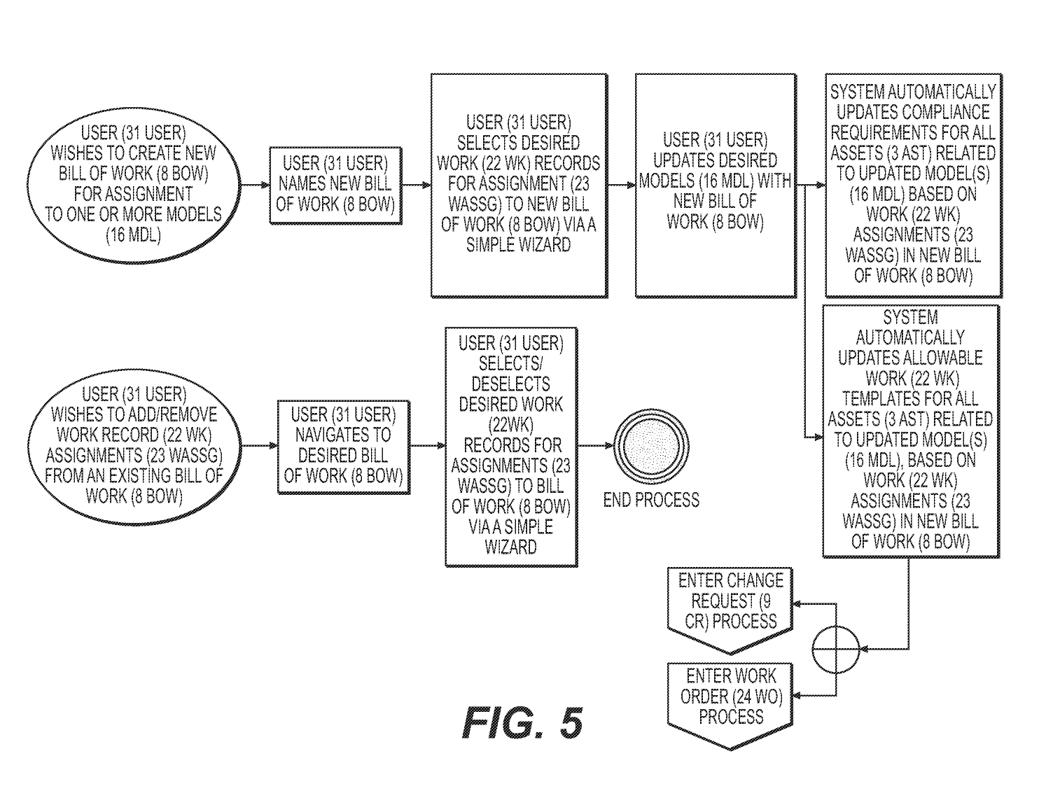

The present approach also permits the inclusion of bill of works into the system. A Bill of Work 8 is similar in concept to a “Bill of Materials” (which lists all replacement parts which may be needed at some point in a specific asset's lifespan). A Bill of Work, however, lists work such as preventive maintenance work requirements 22c, 22b (including standard operating procedures) for an asset, installation, upgrade, among other actions performed on assets. Typically, these requirements must be completed for specified assets at specified frequencies. For example, Caterpillar diesel generators (an asset) may require annual generator load bank preventative maintenance (Work/Frequency). In the exemplary embodiment of the present approach Bills of Work allow a simple, organizationally consistent method and process for creating groupings of work templates and assignment to various asset models 16. One of ordinary skill will understand that numerous methods exist for creating Bills of Work in a system in accordance with the present method. The data included in a Bill of Work For example, in the exemplary embodiment, as shown in FIG. 5. In the embodiment, User 31 creates a new Bill of Work 8 for assignment to one or more models 16. User 31 may select a desired Work Records 22 for Assignment 23 to new Bill of Work 8, such as via a wizard. User 31 may update desired models 16 with new Bill of Work 8. The system may automatically update compliance requirements for all assets 3 related to updated model(s) 16, based on work assignments 23 in new Bill of Work 8. Alternatively, the system may automatically update allowable work 22 templates for all assets related to updated model(s) 16, based on work 22 assignments 23 in new Bill of Work 8. The system may then, for example, enter a Change Request 9 Process or enter a Work Order 24 process. User 31 may add/remove work record 22 assignments 23 from an existing Bill of Work via a simple wizard. Bills of Work can also be fully mobile enabled 37.

Methods for evaluating the performance of various parties performing various work or tasks, may be integrated into the present approach, permit the integrations of those factors into the risk mitigation methods and processes, asset dependency evaluation, budgeting, key performance indicators, manufacturer selection, vendor evaluation, among others, to improve the resiliency of the organizations value chain and supply chain, improve transparency for audit requirements, cost savings from multiple areas, etc.

Embodiments of the present approach may include an evaluation feature that permits a user to monitor and study the performance of a party involved in work on an organization's assets. For instance, in the exemplary embodiment, evaluations 12 provide a simple yet robust method and process for evaluating the performance of any party performing work or other services for, or on behalf of the MCIM user organization (e.g. a vendor's performance on a Change Request 9, a facility management partner's performance in an emergency response situation 14, etc.) in accordance with one embodiment of the present approach. Evaluations may feature automated workflow and logic, which converts simple user-input rankings into categorical performance scores, and ultimately an overall performance grade. Evaluations can be tightly integrated with MCIM analytics, enabling an organization to quickly and easily identify the best firms 27 for a given task/project 9, 24 based on a wide array of attributes (e.g. service area, degree and quality of experience based on recorded past performance, Tech. Skill/Knowledge/Qualifications, etc.). Evaluations can be customized and configured to meet the specific attribute and weighting preferences of each MCIM user organization. Evaluations can also be fully mobile enabled to allow for evaluation in real-time as work and tasks are completed, thereby increasing the quality of evaluations and their accuracy 37.

Accounts 27 include manufacturers, vendors, landlords, external partners and internal accounts. Accounts are a standard Salesforce.com database object, but have novel use cases when combined with other methods and processes in one embodiment of the present approach. Notably by enabling an organization to track the variety of ways different types of accounts interact with an organization and providing history and accountability for those interactions, such as evaluations of the uptime of sites under the management of a specific account, correlation of the outcomes of a wide section of assets serviced by specific vendors to recognize those vendors whose technicians produce above average asset life-cycle improvements, among other capabilities, all of which may significantly improve their organizational effectiveness. Accounts can also be fully mobile enabled 37.

Under the present approach, the system may include data for recording contacts. Contacts may be data associated with individuals who participate in the change request process, as described elsewhere herein. In the exemplary embodiment, Contacts 28 may include employees of Accounts 27. Contacts are a standard Salesforce.com database object, but have novel use cases when combined with other MCIM methods and processes as described herein, for example. Contacts may be mobile enabled 37.

Events 29 may include calendar events, and requested meetings. A user of the system of the present approach can define and track events for all components in MCIM. In one embodiment of the present approach, Events display in related lists on associated records as well as on the Home tab. Events are a standard Salesforce.com database object, but have novel use cases when combined with other MCIM methods and processes as described and illustrated herein, for example. Events may be mobile enabled 37 and may be pre-integrated 38 with external calendaring systems, e.g., Microsoft Outlook, Lotus Notes, etc.

Tasks 30 allow a user of the present approach to define and track Tasks for all components in MCIM. Tasks display in related lists on associated records as well as on the Home tab. Tasks are a standard Salesforce.com database object, but have novel use cases when combined with other MCIM methods and processes as described and illustrated herein, for example. Tasks may be mobile enabled 37 and may be pre-integrated 38 with external calendaring systems, e.g., Microsoft Outlook, Lotus Notes, etc.

Users 31 can access the system of the present approach using client computing devices, such as desktop computers, laptop computers, tablets, mobile communications devices (MCDs) and smart television appliances, for example.

In the exemplary embodiment of the present approach a position may represent a unique combination of, but not limited to, one contact 28 or user 31, one site 20, and one position held by the contact or user at that site. Positions 18 may be integrated with incidents 14 to establish automated incident communication preferences as well as site-specific emergency response roles and protocols, among other functions relating incidents to users, contacts, sites or positions. Positions 18 can be tightly integrated with MCIM analytics, enabling strategic insight into key performance indicators for organizational staff members 28, 31, including allocation of square footage under management, uptime performance track record, audit compliance history 8, 22, 21 workforce efficiency benchmarking and much more. Positions 18 can also be fully mobile enabled 37.

Chatter 32 is a standard Salesforce.com database object and process for enabling enterprise social media, but has novel use cases when combined with other MCIM methods and processes as described and illustrated herein, for example. Chatter can also be fully mobile enabled 37, and can allow use of the device's onboard camera for posting comments, files, polls and pictures 34 directly to records in the system, for example. Chatter can be fully integrated with every MCIM component, as well as the integrated content management system 34, and can also be used to create groups, send automated email communications via “@” mentions, and incorporate hashtags into any topic for use in search, trending and reporting. No matter where a user is, he or she can collaborate with his/her team 31 in real-time. Chatter can include profiles, groups, feeds, instant messaging and more, and can be accessible via mobile device 37, browser, and desktop, for example.

Surveys 33 embody a method and process in accordance with the present approach for capturing, storing, analyzing and acting on answers to a predefined series of questions pertaining to various aspects of a site 20 and its related information (e.g. current landscaping quality, paint quality, all inspections on hand, critical areas 2 clean and free of debris, etc.). Surveys can also be fully mobile enabled 37.

One of ordinary skill in the art would appreciate that there will likely be the need to associate different types of data with many of the objects, processes, methods, and activities described herein. One embodiment of the present approach features an integrated content management method and process which allows for documents and files to be attached to the records to which they are contextually relevant (e.g. floor plans and emergency procedures attached to a site 20 record, manufacturer 27 technical documents attached to an asset record, vendor 27 field service reports 34 attached to a change request 9 or work order 24 via Chatter 32, etc.), thereby further increasing the flexibility of this embodiment of the present approach. The content management method and process can also be fully mobile enabled 37 and is capable of making use of the mobile device's onboard camera and/or integrated content management functionality. Organize, share, search, and manage content including all file types, from traditional business documents such as Microsoft® PowerPoint presentations to audio files, video files, Web pages, and Google® does, for example.

Embodiments of the present approach may feature one or more visualization tools through which desired system data can be visualized (e.g. viewing a portfolio of facilities 20 on a map, meshed with weather, topography and utility data integrated from the external environment 38 for use in disaster recovery planning; visualizing asset dependency networks within and across sites 20, etc.), which greatly increases the ability of a user to digest the large, complex data streams and their interactions, thereby better enabling users to make powerful insights, recognize patterns, or make better decisions, among other benefits.

In some embodiments, the present approach features a suite of data quality management tools through which the accuracy, completeness, uniqueness and relevance of system data (e.g. Models 16, Accounts 27, Contacts 28, etc.) are maintained.

In carrying out the above, it will be appreciated that the system of the present approach can comprise a computer-based system, where the components can be implemented in hardware, software, firmware, or combinations thereof.

Users can access the system of the present approach using client computing devices, such as desktop computers, laptop computers and mobile communications devices (MCDs), for example. It will be appreciated that the system of the present approach can incorporate necessary processing power and memory for storing data and programming that can be employed by the processor(s) to carry out the functions and communications necessary to facilitate the processes and functionalities described herein. Each client computing device can be configured to communicate with an application server (not shown) of the system described herein. Appropriate encryption and other security methodologies can also be employed by the system of the present approach, as will be understood to one of ordinary skill in the art.

Unless otherwise stated, devices or components of the present approach that are in communication with each other do not need to be in continuous communication with each other. Further, devices or components in communication with other devices or components can communicate directly or indirectly through one or more intermediate devices, components or other intermediaries. Further, descriptions of embodiments of the present approach herein wherein several devices and/or components are described as being in communication with one another do not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

One of ordinary skill in the art would appreciate that the management of a data center or multiple, interrelated data centers, may necessitate the creation of mappings of the risk relationships, dependencies and redundancies in order to maximize the uptime of the fore mentioned data center(s). One of ordinary skill would also recognize that it may be advantageous to make a mapping an active part of the system related to activities and events that may affect the uptime of any of the assets in an asset dependency stream, due to their ability to affect the uptime of a business unit, customer channel, and other aspects of operations. The utility of an asset dependency, risk relationship mapping is directly correlated to its ability to streamline the process of identifying the impact of (an) asset(s) or event on the value creation processes, which may include the perspective of a single business unit, customer channel, data center, or portfolio of data centers. A mapping which allows a user to view, or actively alerts users to, the implications of a change to one or more assets in the chain of assets that support an entity's processes for value creation may provide insights into the wide variety of factors which impact those assets. These may include, but are not limited to, vendors' performance, manufacture quality, asset maintenance or alteration, updates to infrastructure, staffing, budgeting, and benchmarking.

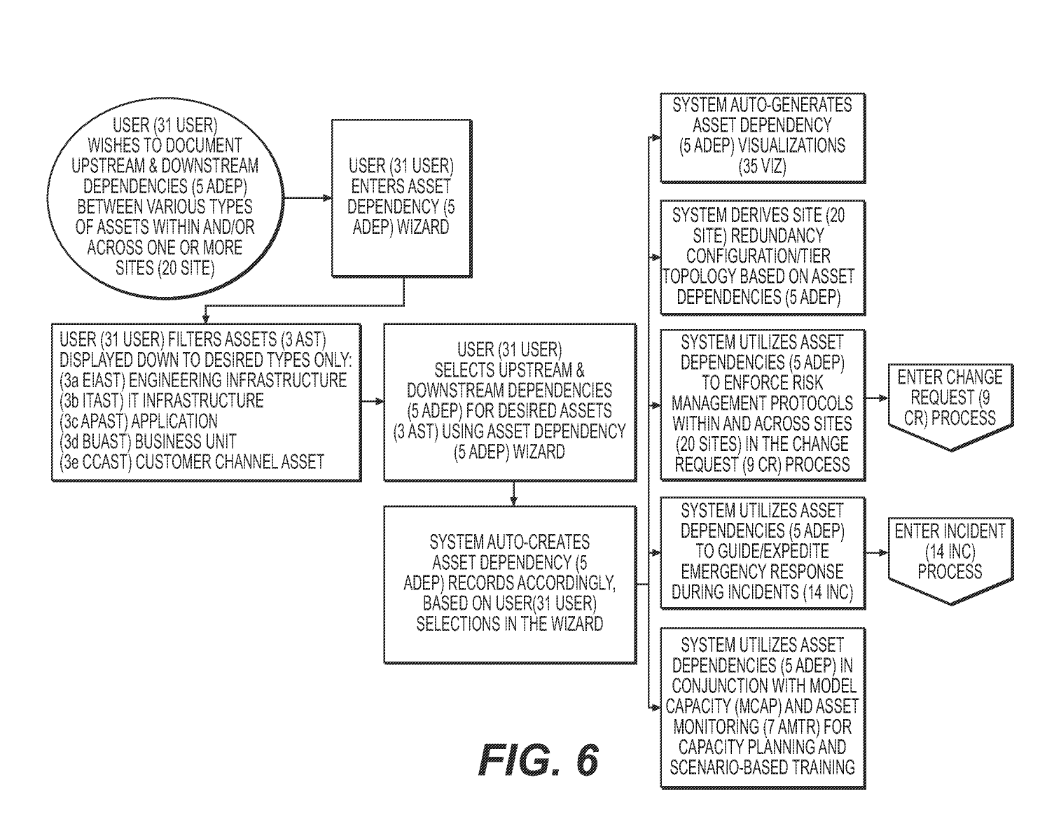

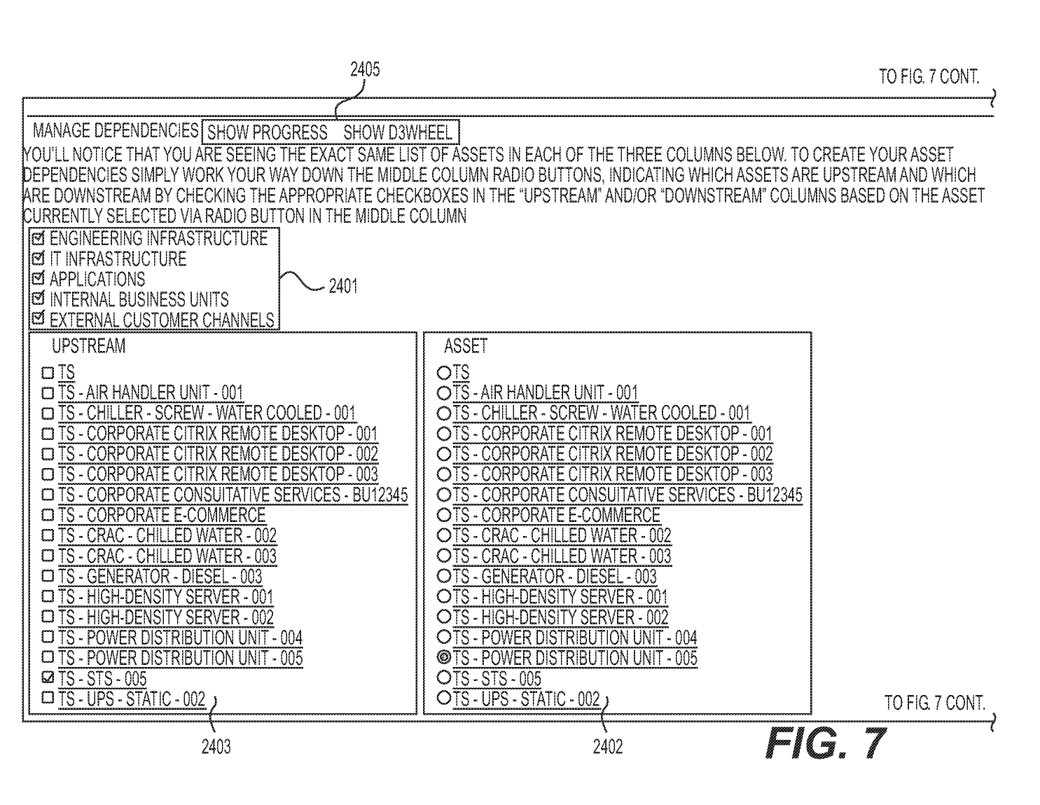

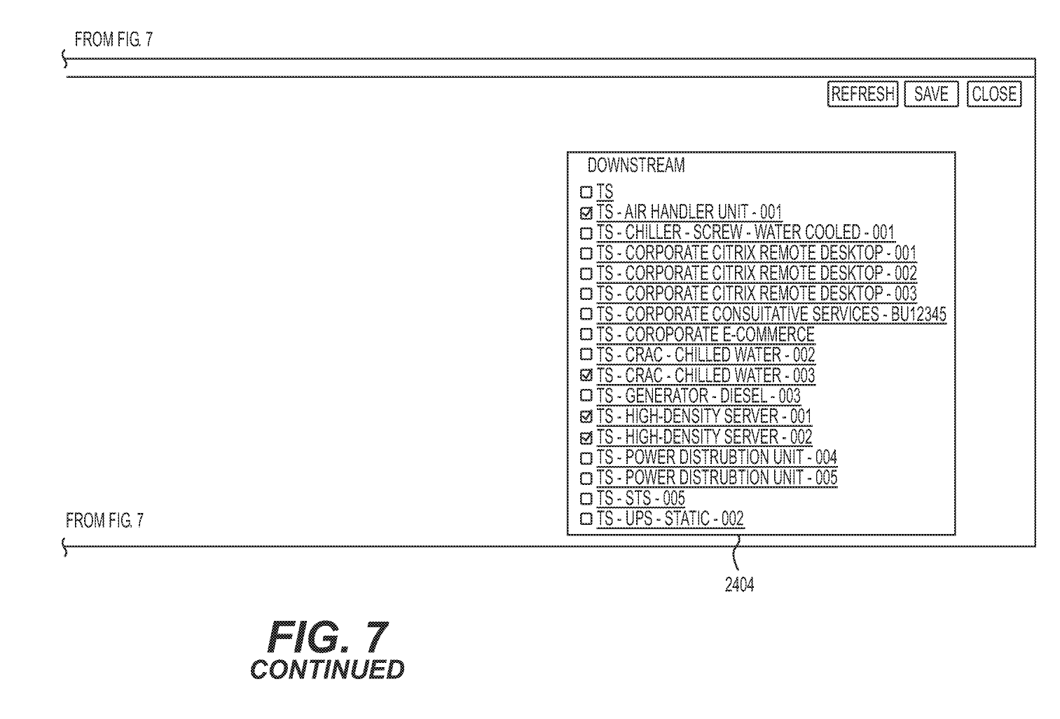

The exemplary embodiment of the present approach employs the logic structure shown in FIG. 6 to map risk relationships and dependencies. FIG. 6 illustrates exemplary steps for a process for mapping risk relationships and dependencies across homogeneous and heterogeneous asset types. This dependency information is very valuable, as it can be used to ensure that planned or unplanned events at one site, do not affect. (or have minimal affect) on events and operations at any/all other interdependent sites (interdependent by virtue of interdependencies between assets residing in, or supported by both sites). Not all of the steps of FIG. 6 have to occur in the order shown, as will be apparent to persons skilled in the relevant art(s) based on the teachings herein. Other operational and structural embodiments will be apparent to persons skilled in the relevant art(s) based on the discussion. These steps are described in detail below.

In the exemplary embodiment of the present approach a user can create asset dependencies with a wizard. After assets have been created, such as by using the system processes described in FIG. 3 or other appropriate means for entering desired data for an organization's assets, a user can define risk relationships and dependencies between assets of the same or different types, and at the same or different sites. The steps shown in FIG. 3 are merely demonstrative.

FIG. 6 illustrates a method for defining risk relationships and dependencies between assets used in the exemplary embodiment. In the embodiment shown in FIG. 6, User 31 may document upstream and downstream dependencies 5 between various types of assets within and/or across one or more sites 20. The system may include an Asset Dependency wizard. For example, User 31 may filter assets 3 displayed down to desired types only: User 31 may select upstream and downstream dependencies 5 for desired Assets 3 using a wizard, for example, which allows for the identification of upstream and/or downstream dependencies. The user could first identify asset type, either Engineering Infrastructure, IT Infrastructure, Applications, Internal Business Units, or External Customer Channels, to create dependencies among those assets by checking a box, which represents a non-exclusive method of choice allowing for dependencies to be created both within and among asset types. Once the user has chosen the type or types of assets for which dependencies will be assigned, the user may see a three column list of assets which may have the same or different sets of assets in each column, the left most column displaying the available upstream assets, the right column showing the available downstream assets, and the middle column displaying the asset for which the upstream and downstream assets are being defined. The user then selects an asset in the middle column 2402, then checks one or more boxes (if appropriate) in the left column to indicate an upstream risk relationship or dependency 2403, then checks one or more boxes (if appropriate) in the right column to indicate a downstream risk relationship or dependency 2404, after which the user may save those dependencies. The user may select another asset in the middle column and repeat the process just described until all desired risk relationships and dependencies have been defined. To assist with the selection and assignment of assets to upstream or downstream dependency statuses, users may hover their cursor over the asset(s) in question to get deeper insight into the asset(s) relevant information. This information may take the form of a picture of the physical asset, the model, tag number, current dependencies, and area, among others. The system automatically generates integrated visualizations of risk relationships and dependencies created, which can be viewed by an end user 2405. The present embodiment may also allow for the assignment of a number of types of relationships, which may include information about the type or depth of redundancy, either through system processes' which assign them automatically based on a sites redundancy classification, among other factors, or may be assigned by the user.

As demonstrated in FIG. 6, the system may auto-create dependency records accordingly, based on user 31 selections in the wizard. The system may also auto-generate asset dependency visualizations 35, as described elsewhere herein. The system may derive site 20 redundancy configurations/tier topology based on asset dependencies 5. In some embodiments, the system utilizes asset dependencies 5 to enforce risk management protocols within and across sites 20 in the change request 9 process. In some embodiments, the system utilizes asset dependencies 5 to guide and/or expedite emergency response during incidents 14. In some embodiments, the system utilizes asset dependencies 5 in conjunction with model capacity and asset monitoring for, as examples, capacity planning and scenario-based training.

The identification of asset dependencies under the present approach allows for mission critical management systems and methods with numerous advantageous features. One of ordinary skill in the art would appreciate the utility of viewing such dependencies in a way that is both effective for understanding the breadth of dependencies, and allows for users to drill down into the specifics of a chain of dependencies with a variety of variables including, but not limited to, site, area, asset type, or asset chain function (i.e. HVAC Cooling systems) in an efficient, effective way.

One such feature is visualization, as described above, which may include for example creating graphical representations of interdependencies between assets. Visualization is a useful tool for a user to quickly identify potential assets that may be impacted by work on an asset, without creating a Bill of Work or Change Request. Visualization.

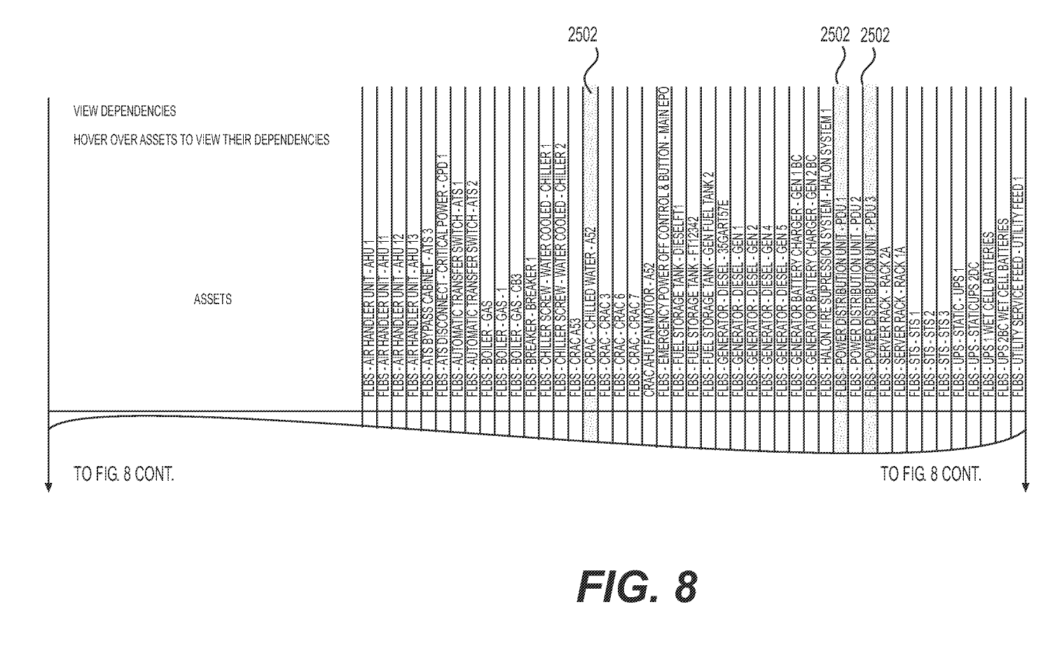

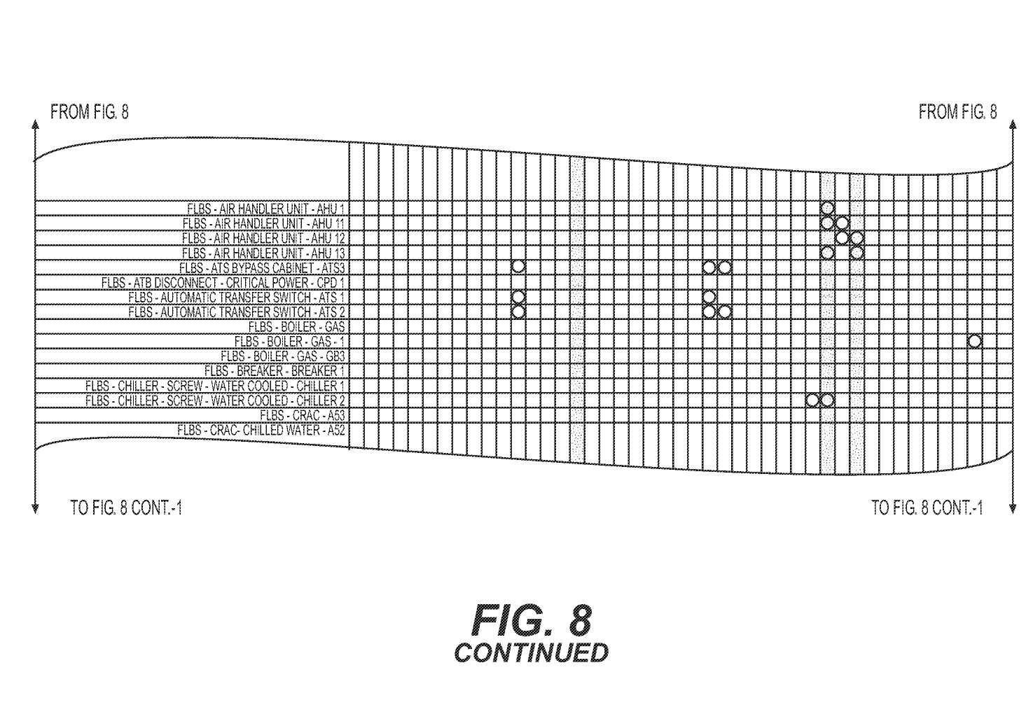

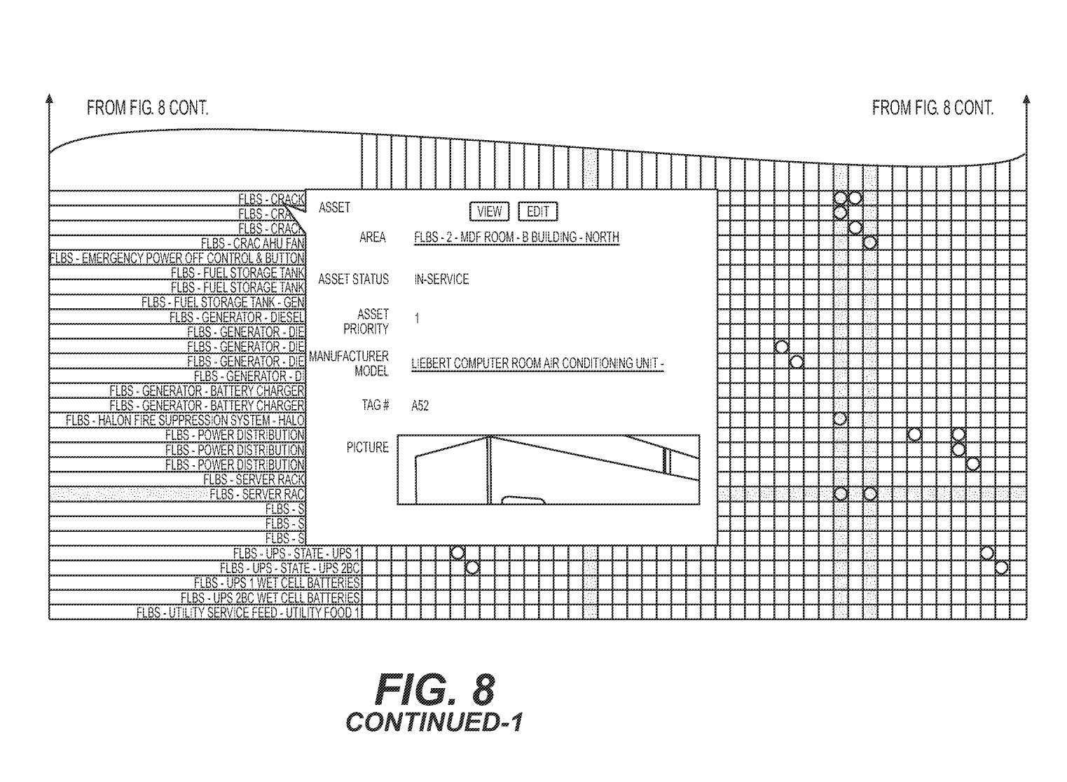

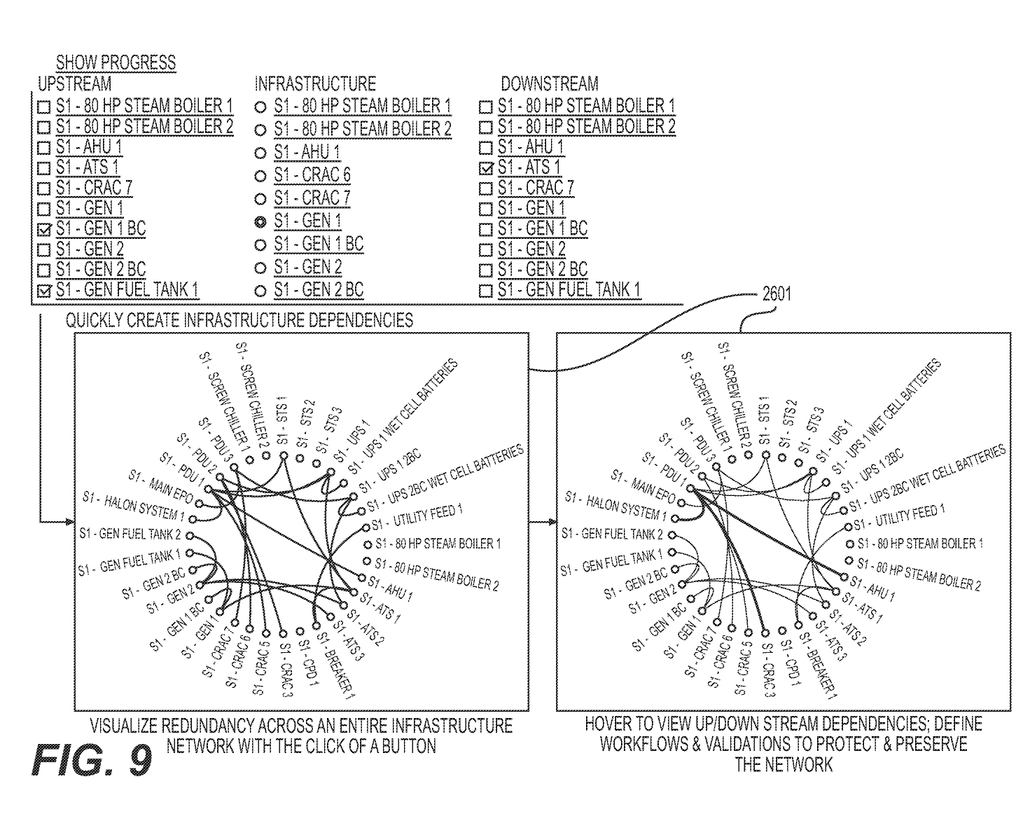

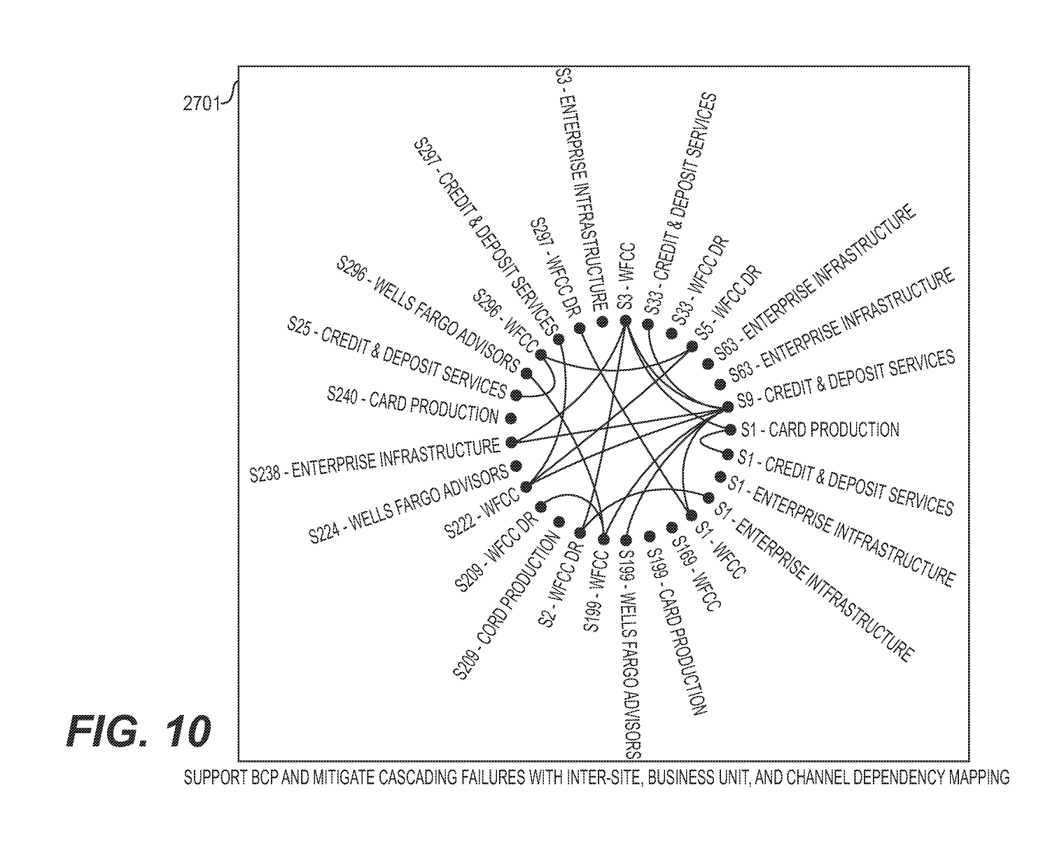

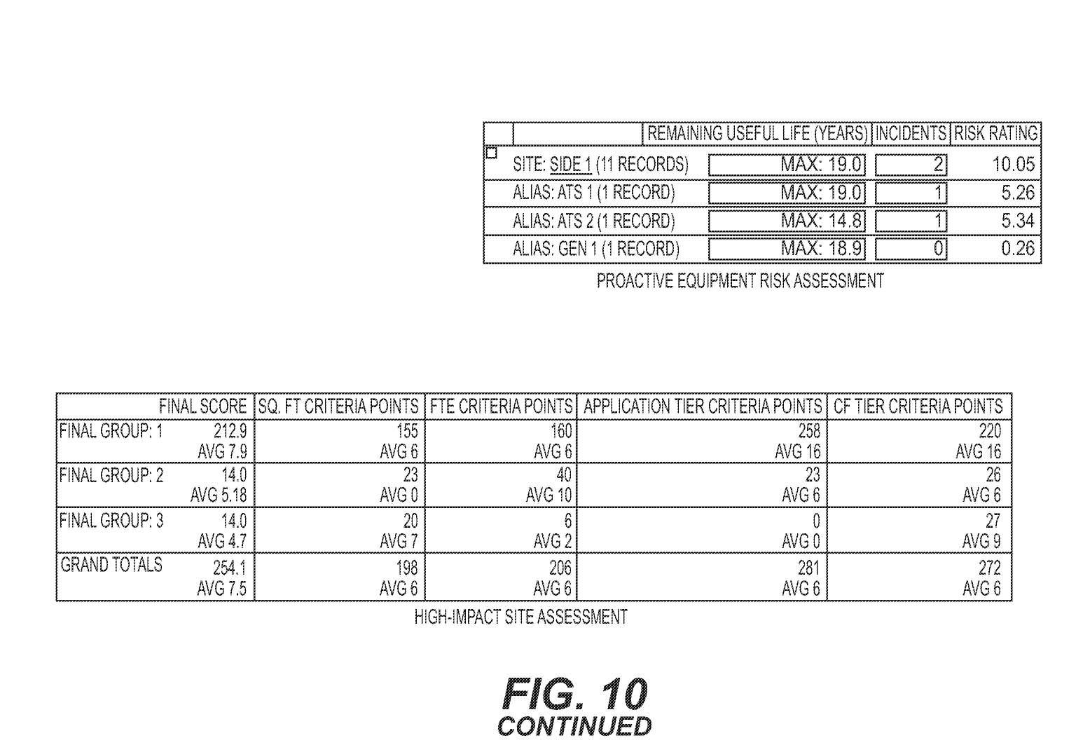

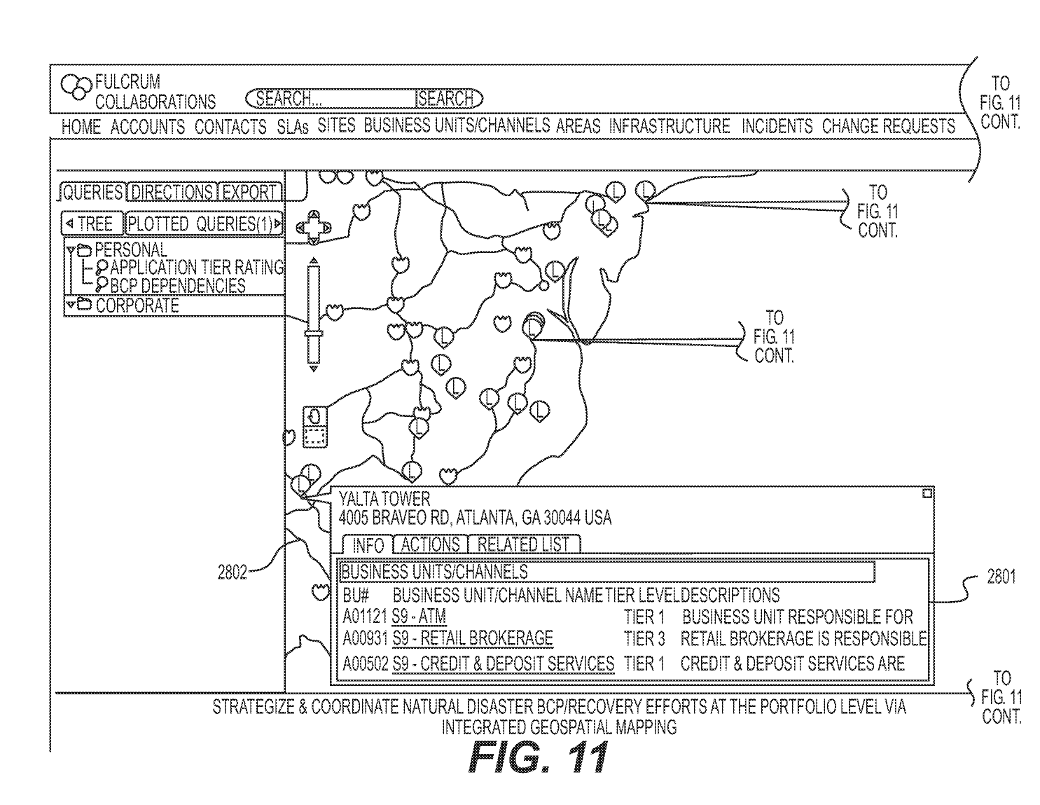

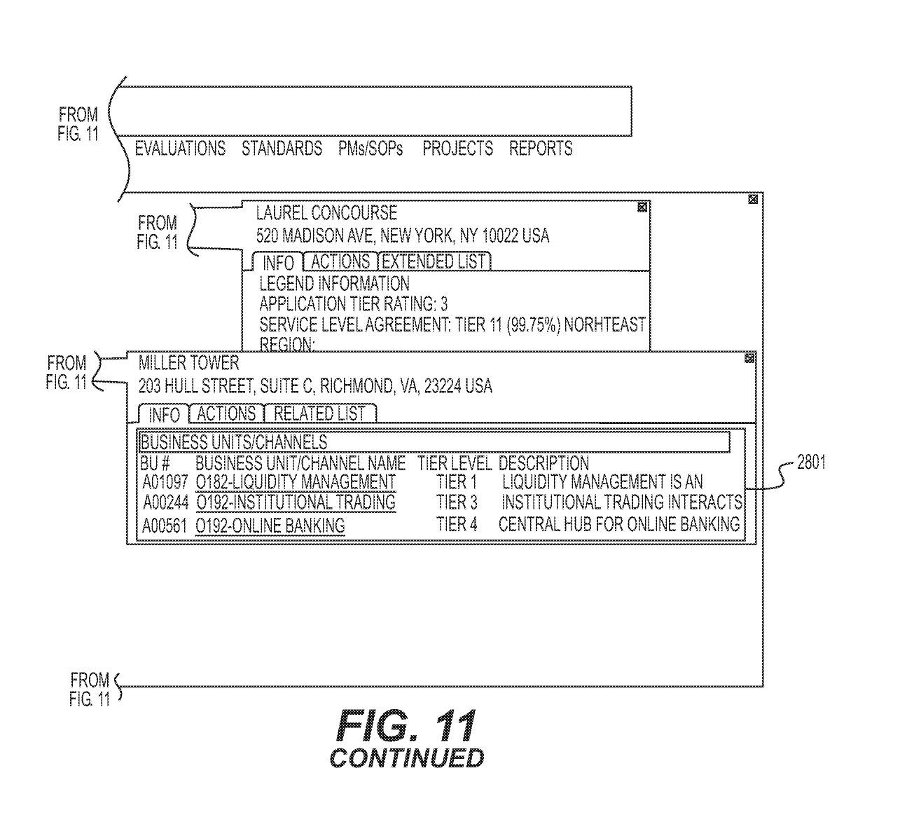

The exemplary embodiment features a variety of visualization features (e.g., graphical representations). For instance, FIGS. 8-11 illustrate several of the integrated asset dependency visualizations automatically generated by MCIM. In FIG. 8, the user allows a cursor to hover over a server rack asset 2501 in the user interface. In response, the MCIM system automatically displays the upstream assets 2502 that are critical to server rack's 2501 proper function. FIG. 9 shows visualizations 2601 across an entire infrastructure, and in the form of circular graphical elements showing dependencies between numerous assets. FIG. 10 shows a visualization of risk relationships and dependencies among the engineering and IT infrastructure assets of a single facility 2701 by assigning risk values based on the remaining useful life and the number of incidents associated with the asset 2702, which represent two of many possible variables by which the present embodiment may assign risk. The information displayed in 2703 represent a wider view of the risks assigned to multiple assets within a site to give a user insight into the total risk profile of a site. FIG. 11 shows risk relationships and dependencies among the business unit and customer channel assets residing in multiple facilities. When risk relationships and dependencies between assets residing in (or supported by, in the case of customer channel assets) multiple sites are assessed, they can be visualized on top of a geospatial Layer 2801. This can enable the user to factor in location-specific risk factors, such as proximity 2802, weather, elevation, climate, utility grid information, or any other relevant data layer that can be formatted into a standardized geospatial data format.

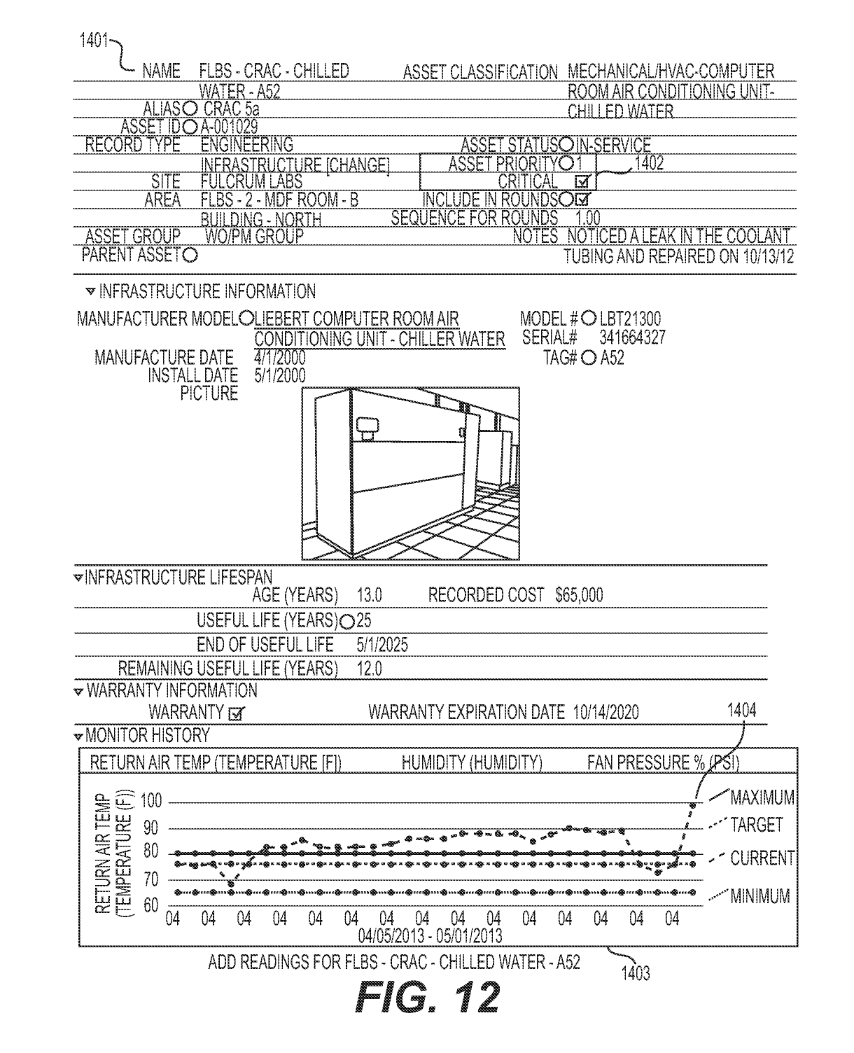

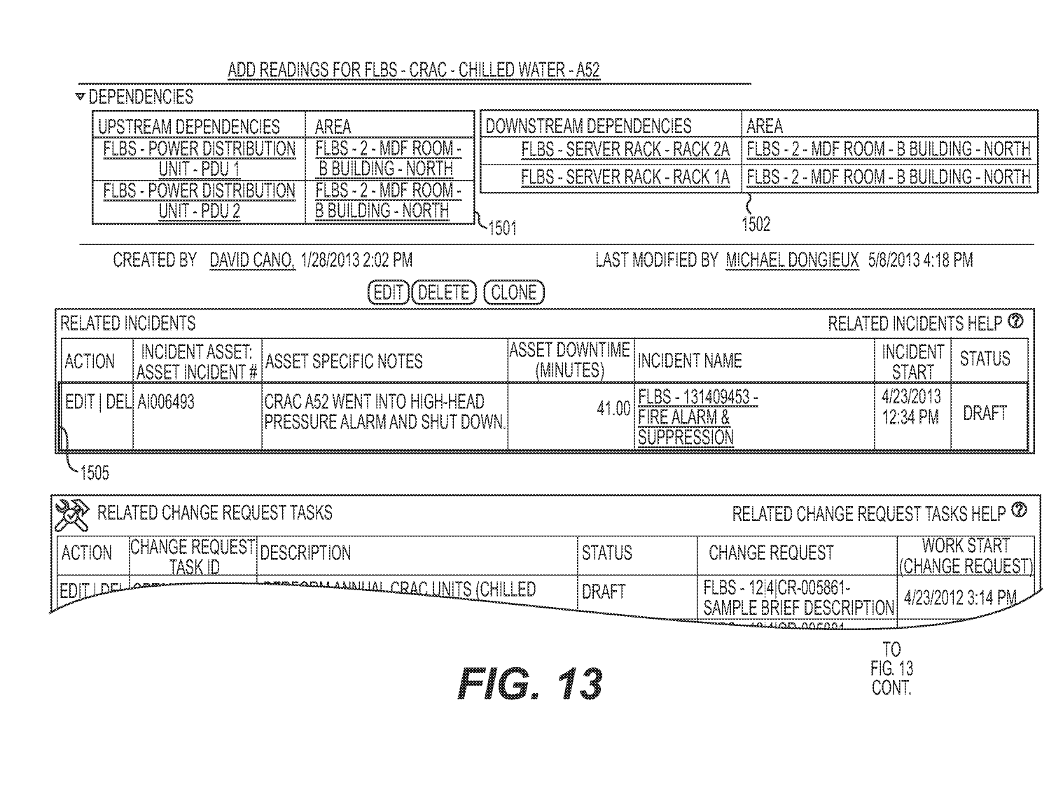

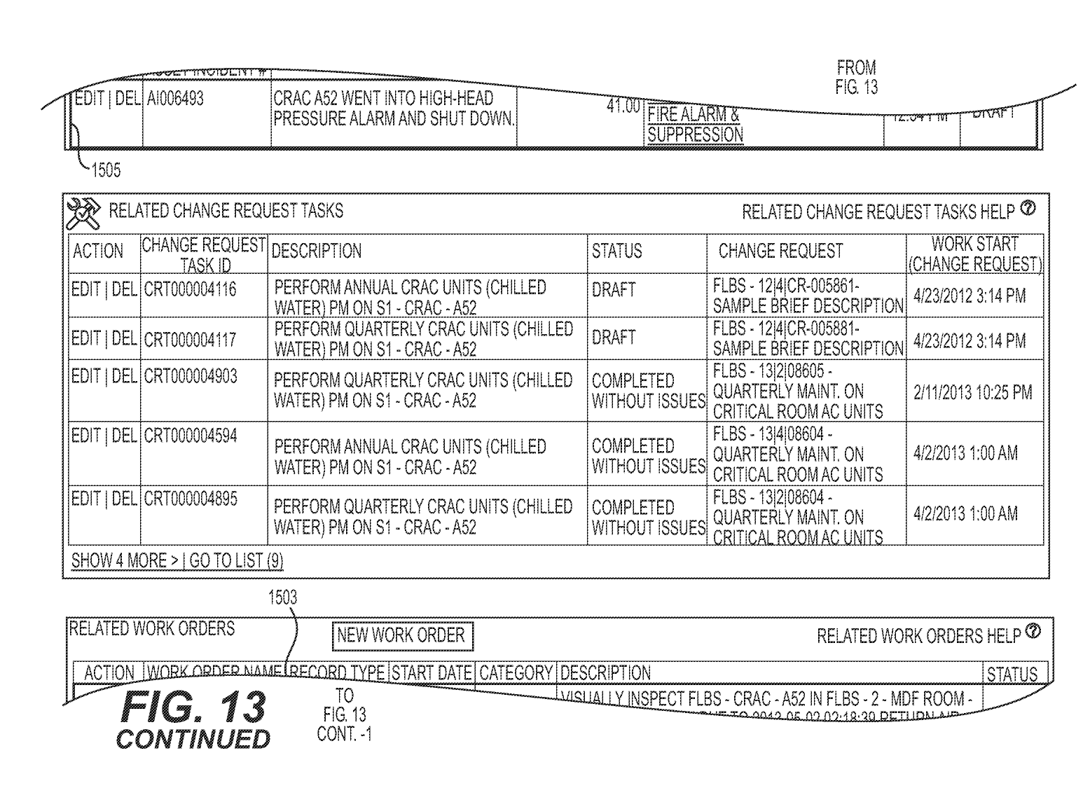

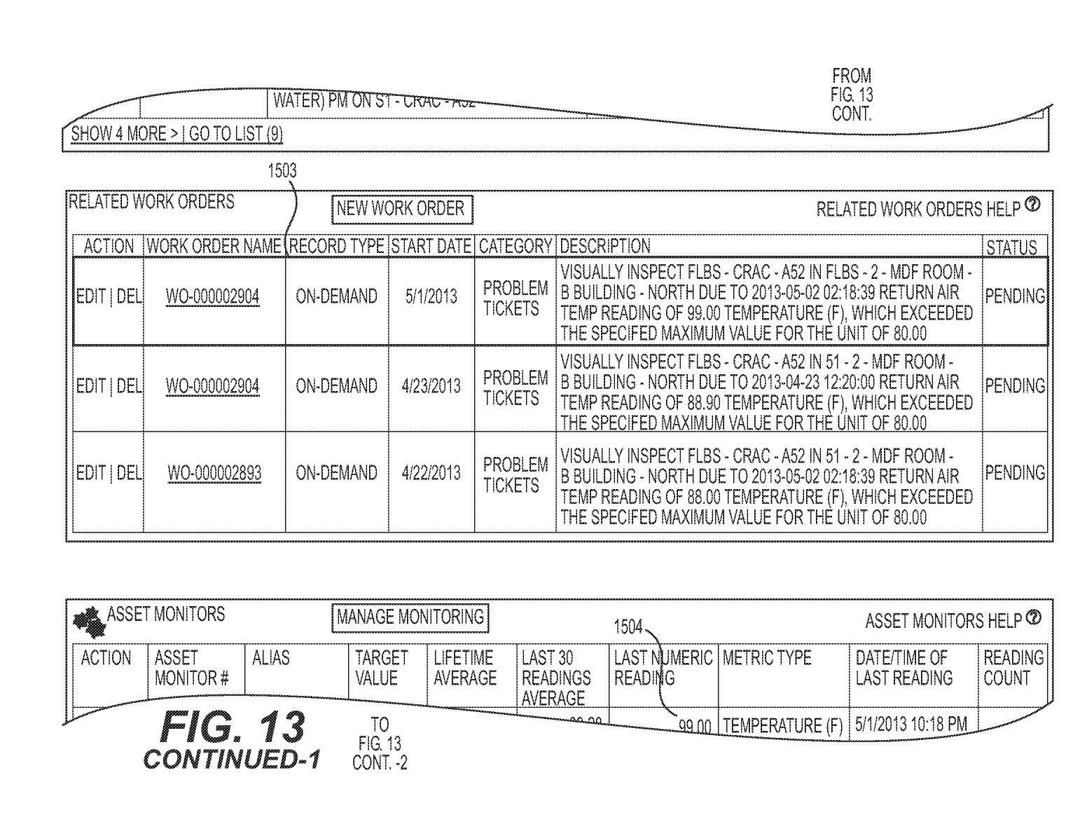

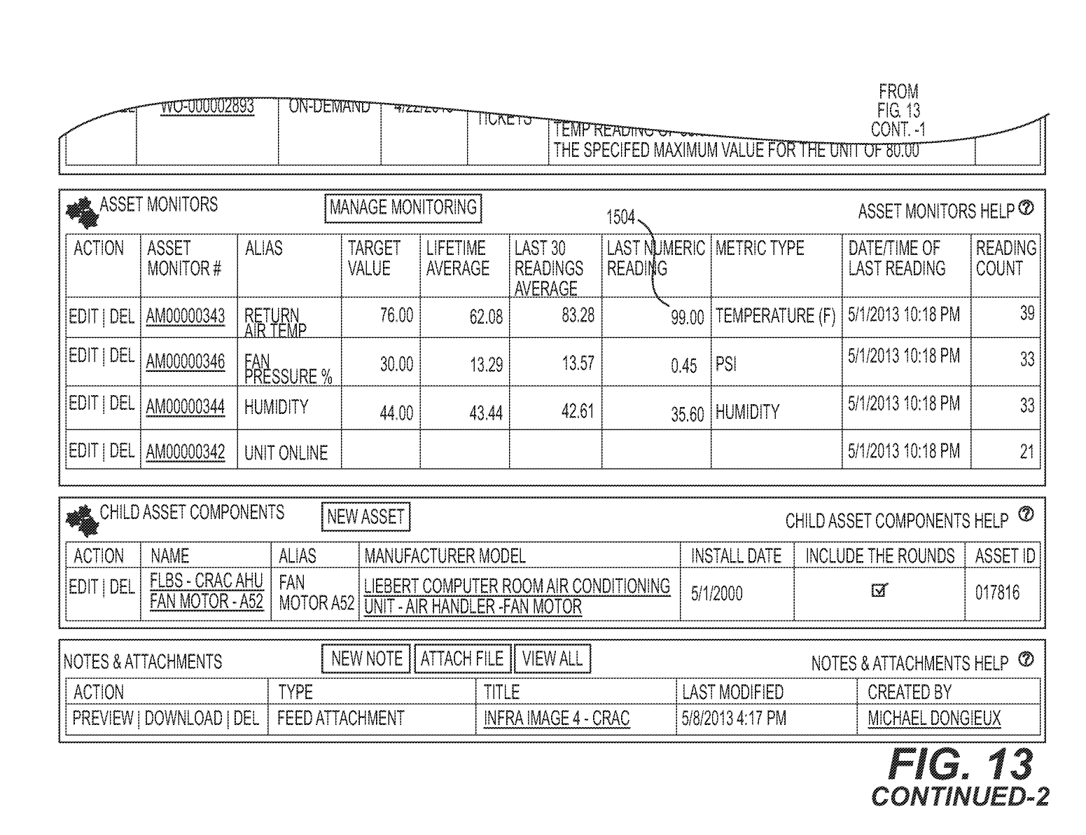

Visualization may be used throughout the system. For example, as shown in FIGS. 12 and 13, in the exemplary embodiment, contextual risk relationship and dependency information may also automatically displayed on every individual asset record, to remind the end user about upstream 1501 and downstream 1502 assets, the risks to which they should consider, before performing work on (via change request or work order process) or otherwise affecting the asset being viewed 1401. Note—FIGS. 12-13 represent the upper and lower portions of a single asset record page in an exemplary embodiment. They have been separated into two figures only to allow them to be viewed at a readable size.

The present approach allows for the rapid and accurate evaluation of risks due to planned events, such as planned maintenance on an upstream asset, and unplanned events, such as asset failures. One of ordinary skill would appreciate that once a system has been populated with data as described herein, numerous methods may be used to evaluate risks in view of planned and unplanned events.

Analysis of the possible impact of a planned change to an upstream asset may be derived from analysis of multi-factor risk. These may include, but are not limited to, the type of work to be performed on the asset, typically either online work, which may not require the asset to be taken out of the dependency stream, or offline work, which requires the asset to be removed from the dependency stream, the position of the asset in a main path, redundant path, or combination of both, the contextual environment of the site which may take into account the actions or events of other sites, or may account for external events such as weather, the risk profile of the asset or assets upstream or downstream based on its historical risk profile, among other factors. Each of these analyses, among others, may be then weighted according their statistical probability and combined for analysis by a user. Analysis of the possible impact of an unplanned event on an asset dependency stream and its dependent value creating activities may occur on a continuous basis, analyzing the rolling risk profile of any of the variables expressed including, but not limited to, assets, sites, external events, and the correlation of any combination of those variables, to create a proactive risk profile of an entire portfolio. One embodiment of the present approach would allow for the correlation of high-visibility and low-visibility risk variables across a wide variety of data streams which would actively recognize patterns of risk and their inter- and intra-asset implications to create a meaningful risk profile which incorporates a wider, deeper set of input variables to produce a full, accurate picture of the constantly evolving risk profile of a portfolio, highlighting weaknesses and strengths within and among asset dependencies.

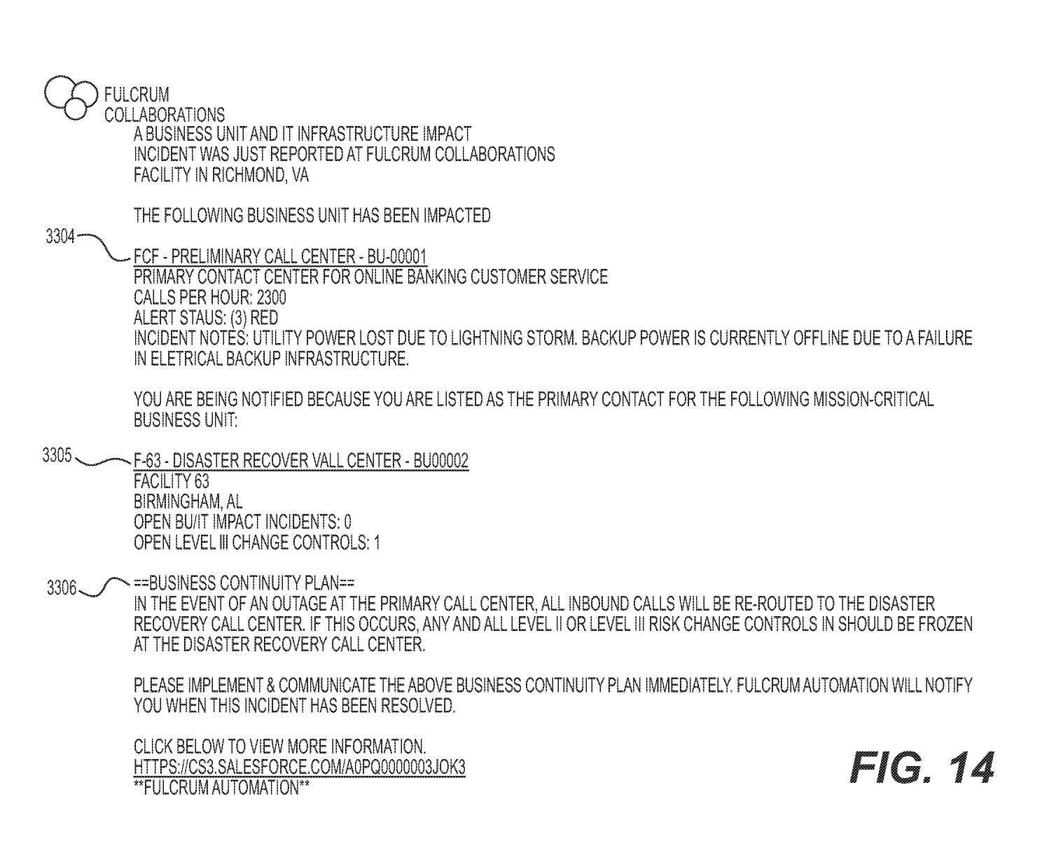

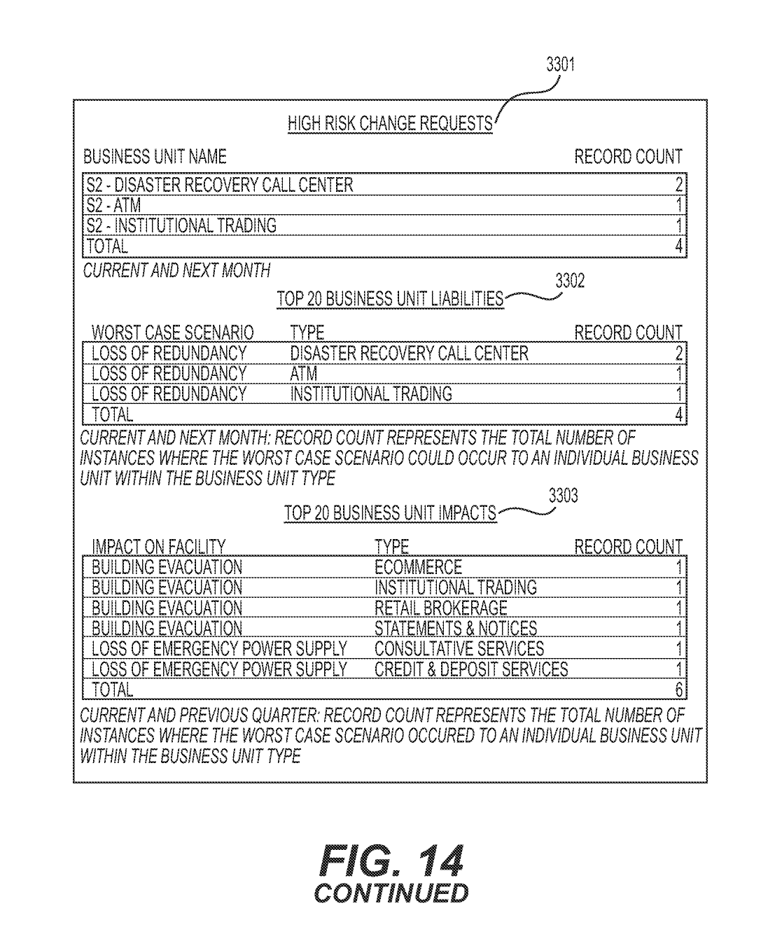

The exemplary embodiment features modules for risk assessment. For example, FIG. 14 shows one of many possible iterations of a risk horizon forecast for assets with direct or indirect risk relationships or dependencies on assets undergoing planned events 3301. Utilizing the logic described above, a potential impact horizon forecast for assets with direct or indirect risk relationships or dependencies on assets undergoing planned events may be created, one iteration of which can also be seen in 3302. Historical impact data for assets with direct or indirect risk relationships or dependencies on assets that experienced unplanned events can also be seen in 3303. An example of an automatic notification sent to pre-defined recipients alerting them to an unplanned event in-progress that is impacting an asset(s) 3304 which shares a risk relationship or dependency with an asset that the recipient(s) are responsible for, can also be seen 3305. This alert also communicates any predefined business continuity plan 3306 pertaining to the asses(s) involved.

One of ordinary skill in the art would appreciate the utility of a database of work performed across an organization, industry, or vertical market, which is standardized to the requirements of that specific area. Work templates to be used in this way may be created and evolved as the users, sites, organizations, verticals, and industries come to consensus about the “best practices” for the performance of semi-repetitive but important work, or may be dictated by the any of the parties previously mentioned for their specific domain. This library may act as an iterative, investigative tool to discover new “best practices”, and to ensure those practices are used throughout a portfolio.

However, one of ordinary skill would recognize that this template library's utility is drastically increased by the presence of an associated standards-based asset database which may house all of the assets and their associated standards within, without, or both, of any organization, vertical or industry. One of ordinary skill would recognize that standards-based assets may include data about the methods and processes for categorizing and defining pervasive organizational processes, procedures, and protocols pertaining to life-cycle considerations, quality-assurance and quality-control processes, representing an umbrella under which all applicable work templates, work-steps, manufacturer models, and site specific exceptions are created and maintained. The use of abstraction on the work template library and standards-based asset database permits the convenient grouping of asset models and related work templates to form a common standard. Part of the value these two systems create is in their ability to provide a customer new to a system similar to that described here with a large repository of collective knowledge and experience on which to build their own standards. Another part of the value created is in the described evolutionary, iterative process across many disparate sites within a portfolio which form the common standards. In the exemplary embodiment of the present approach each subsequent new user need not begin building their work templates for preventative maintenance of a specific asset from nothing, but instead may, for example, build upon the knowledge already present in the system about that specific model's necessary preventative maintenance and, if the user agrees to the common standard, may then be used to assign bills of work based on work templates to specific assets, in an automated fashion. However, one with ordinary skill in the art would appreciate that the benefits are not limited to those described herein, but extend to the multitude of possible permutations of value created as the library and asset database grow and evolve.

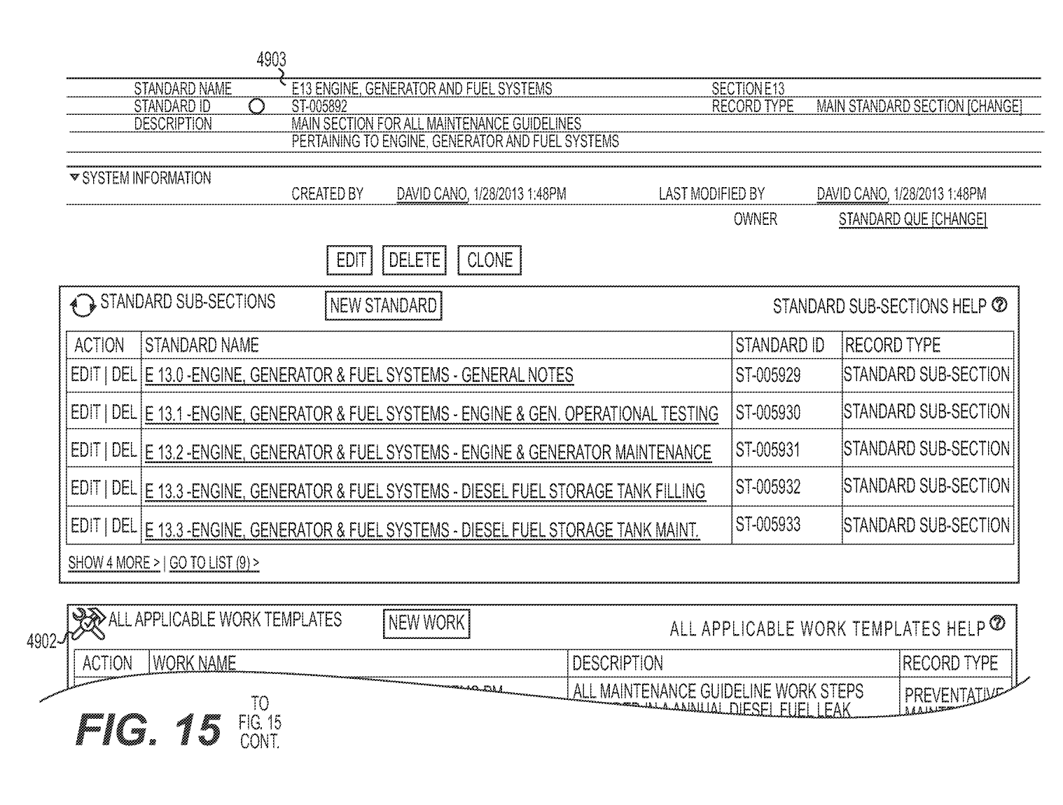

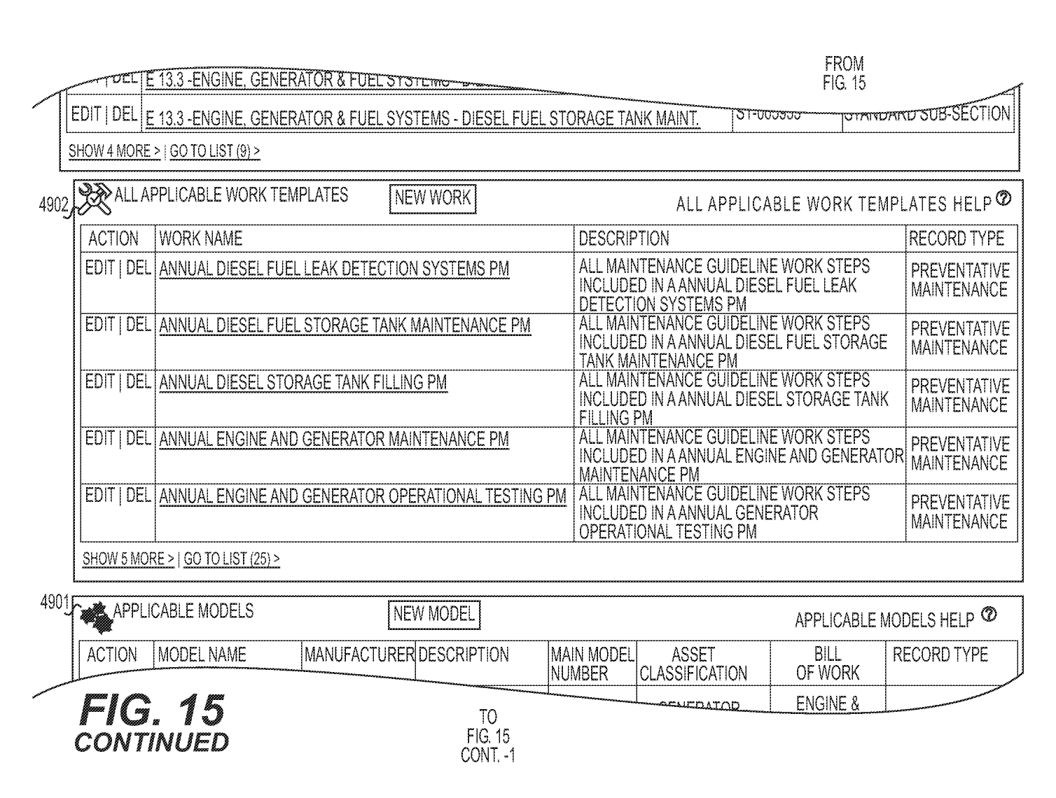

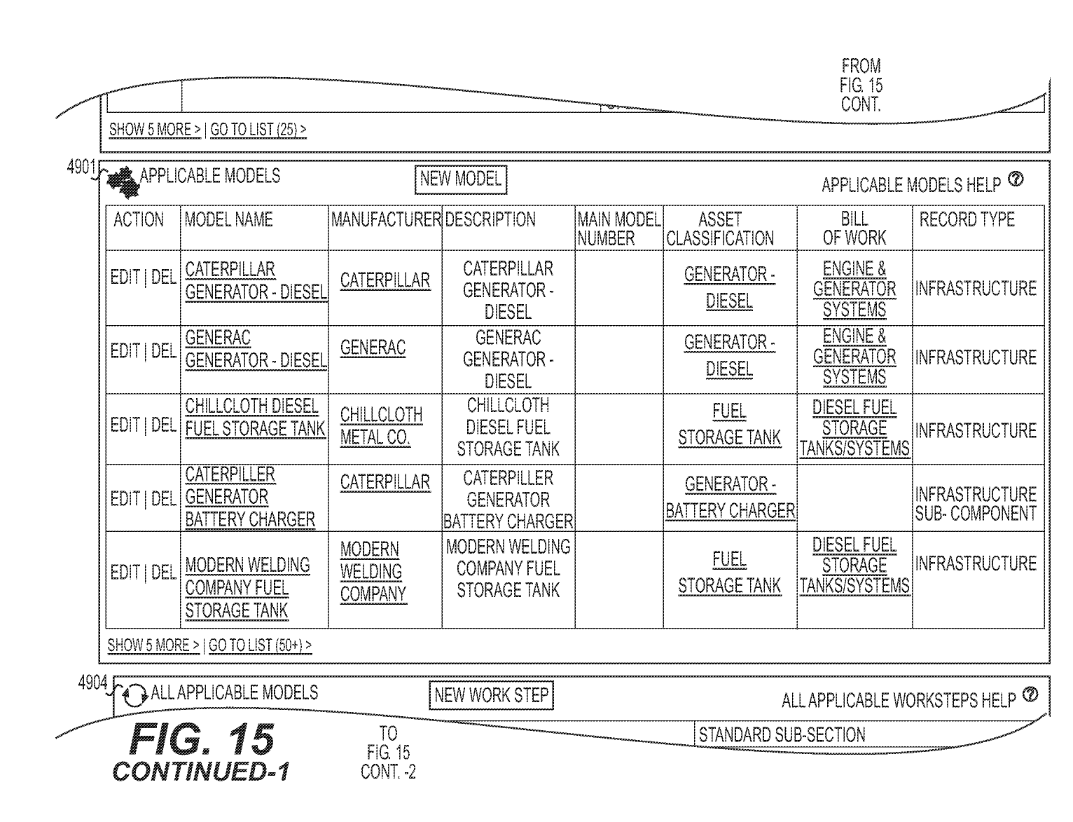

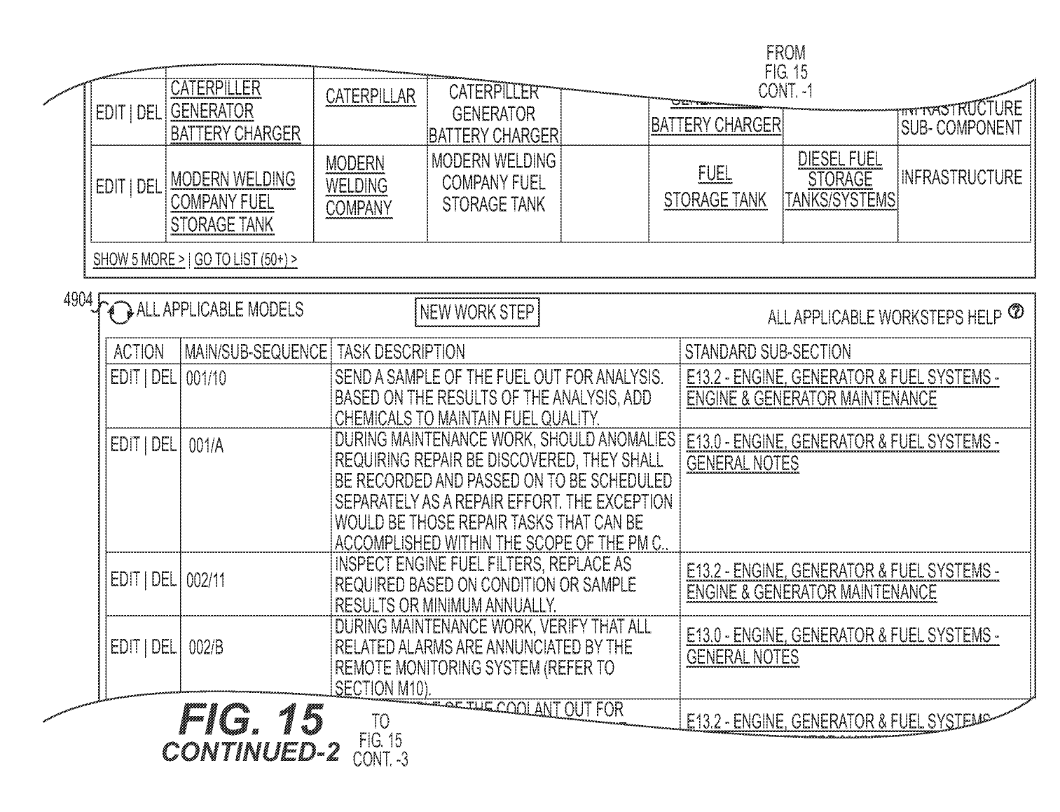

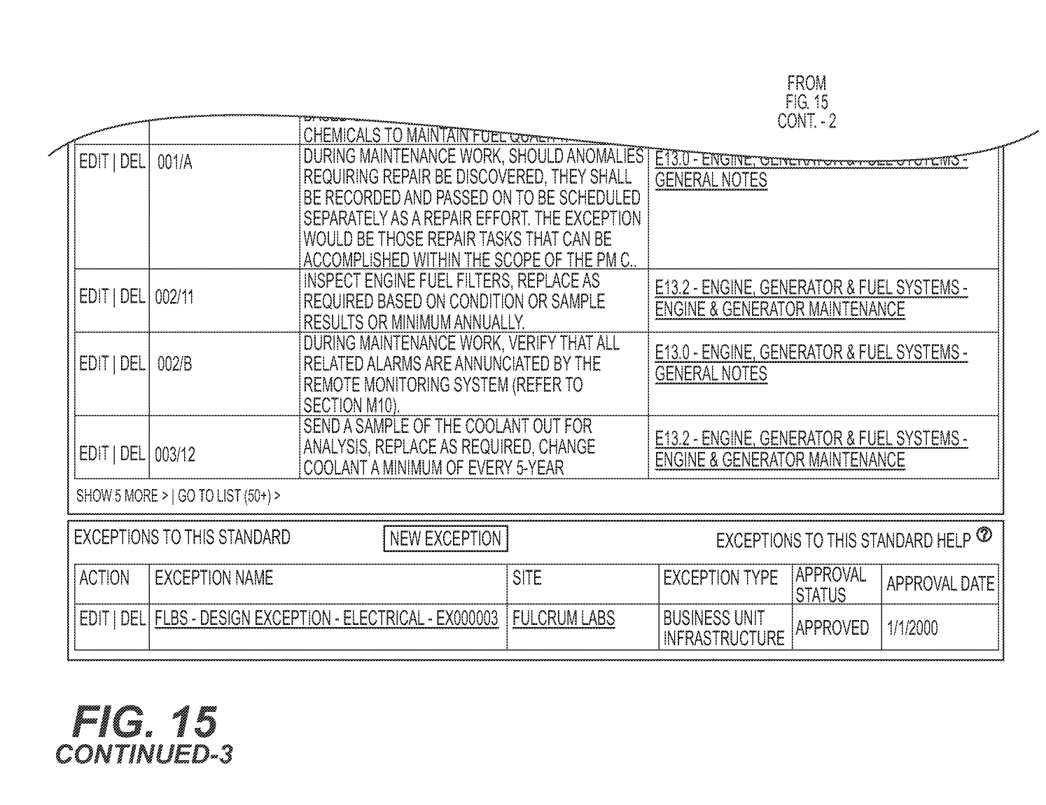

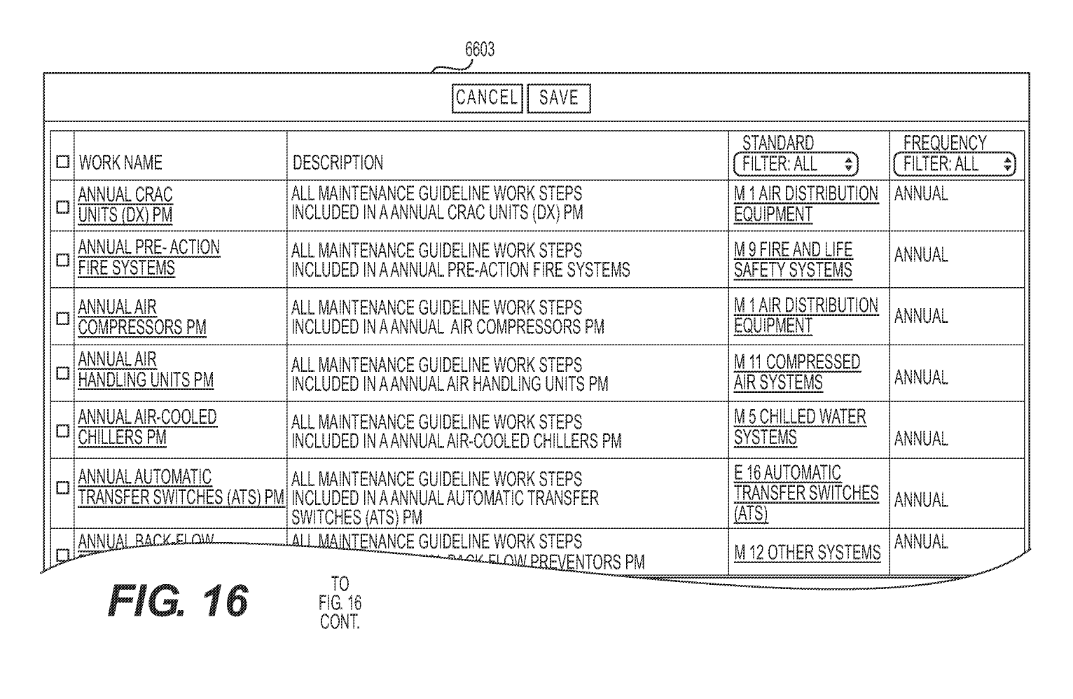

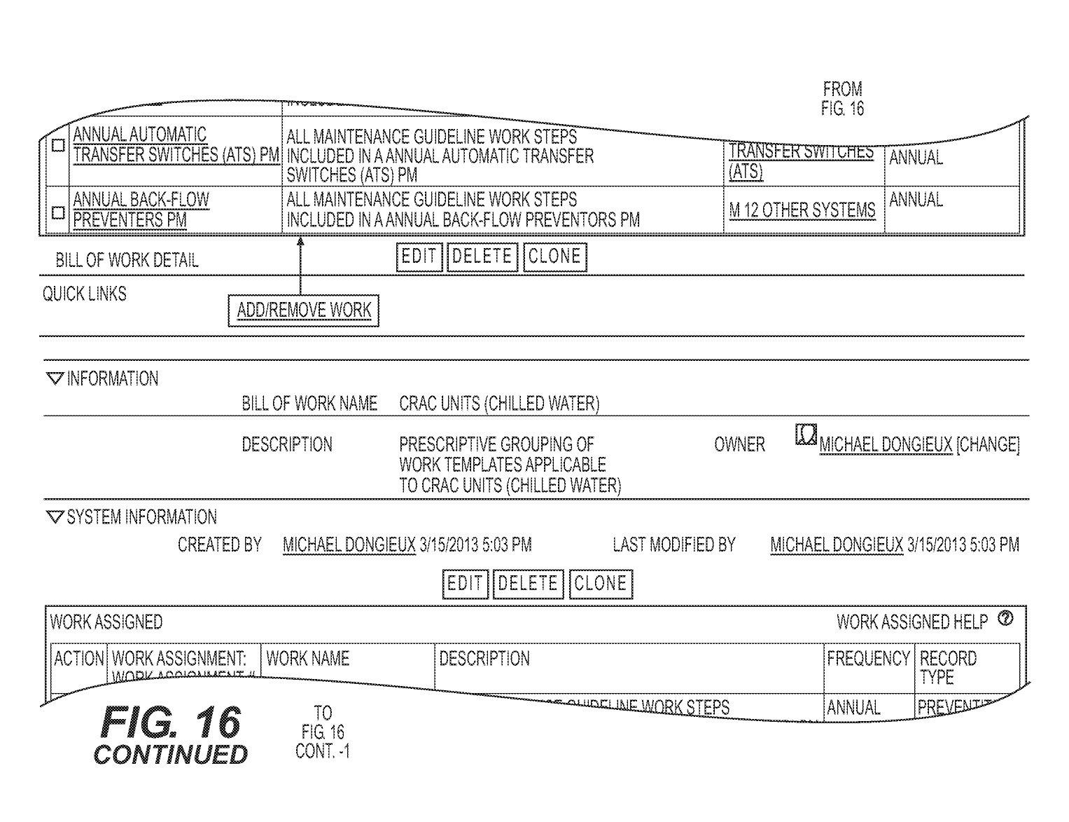

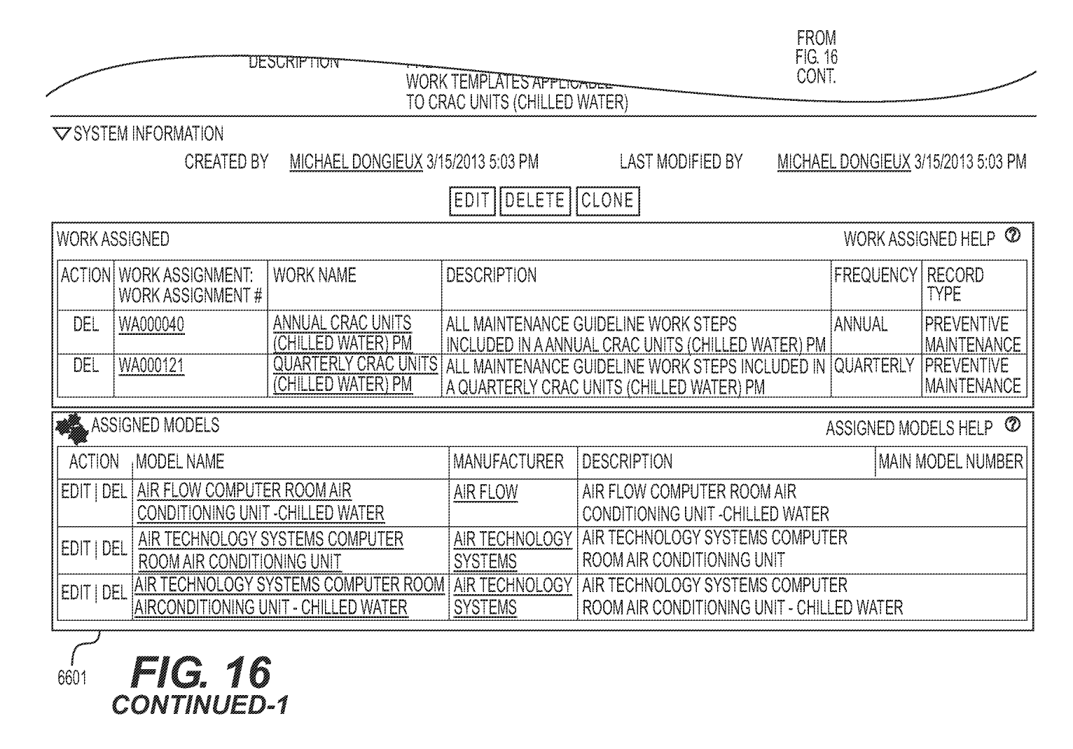

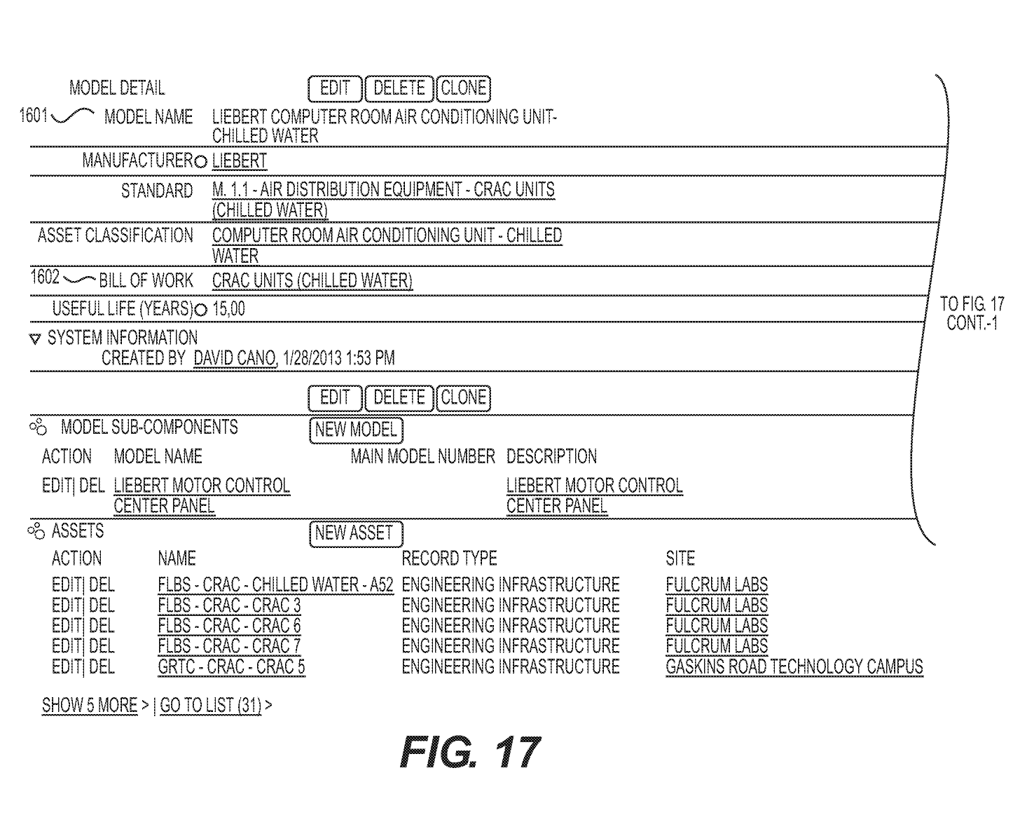

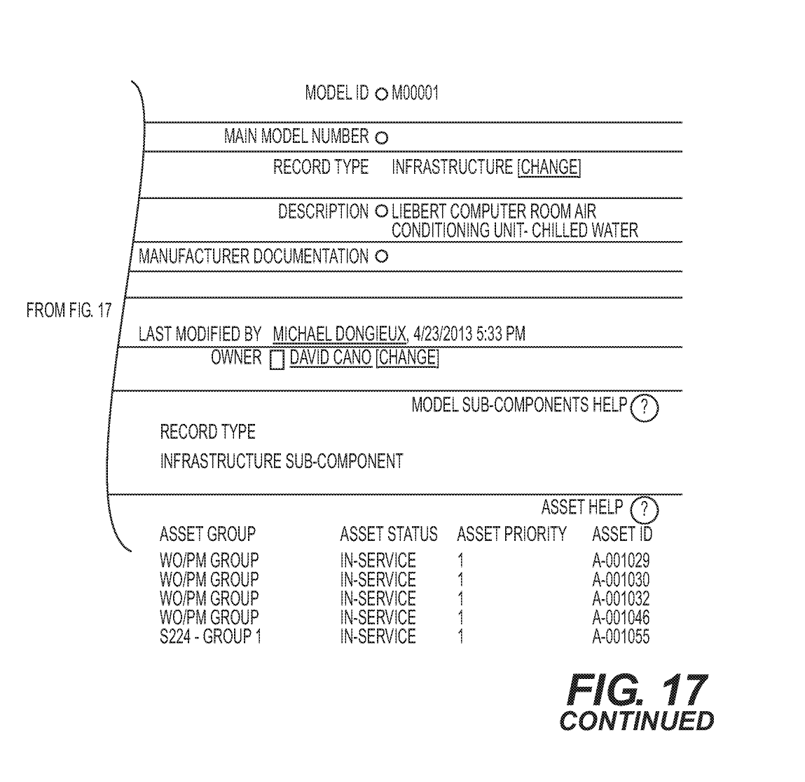

As shown in FIG. 15, asset models 4901 and relevant work templates 4902 (preventive maintenance, standard operating procedures, and custom work) in the exemplary embodiment are grouped together under a common, course-trained Standard 4903. Next, as shown in in FIG. 16, MCIM uses a Bill of Work to achieve fine-grain prescription of specific work templates 6601 to specific manufacturer models 6602, via the process seen in step 6603. The basic logic behind the MCIM implementation of these concepts is set forth in FIG. 72. Work templates may be prescribed to one or more hills of work through this process. As shown in FIG. 17, the exemplary embodiment assigns Manufacturer Models 1601 a bill of work 1602, which indirectly assigns that bill of work, and all work templates related thereto, to all installed assets of that manufacturer model 1603. As demonstrated by the exemplary embodiment, the present approach allows for the advantageous use of abstraction to conveniently create and manage work templates for numerous assets.

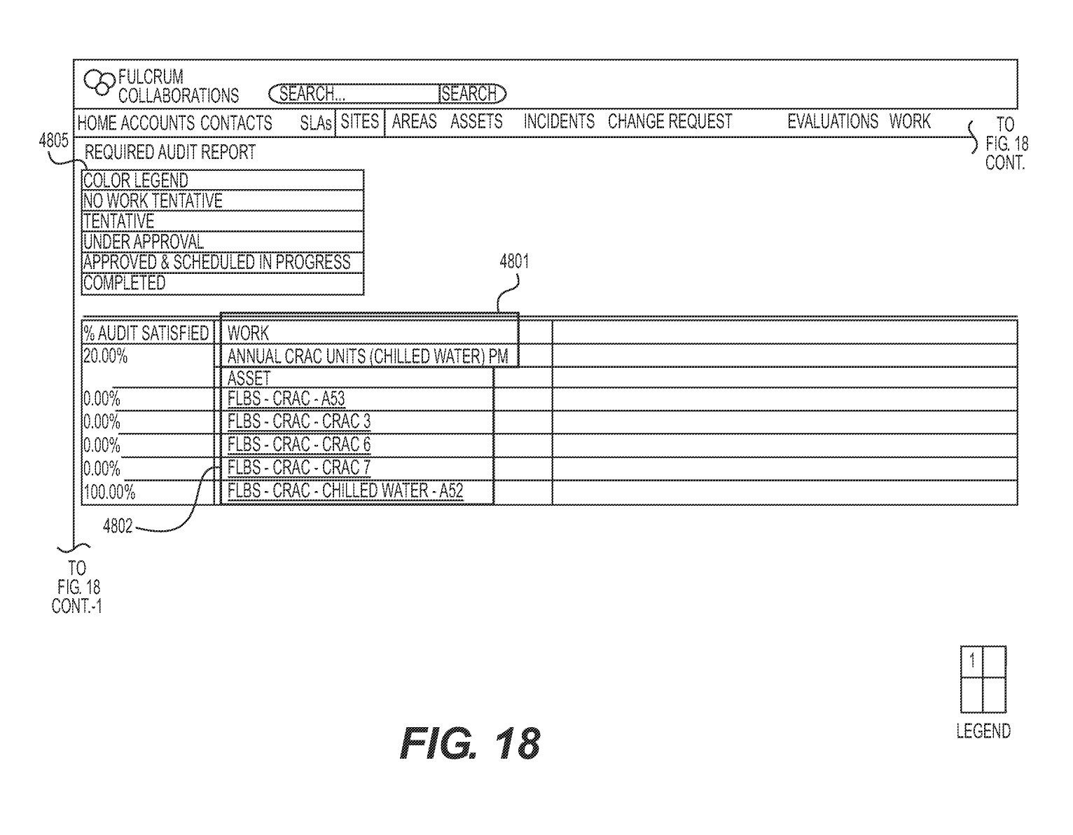

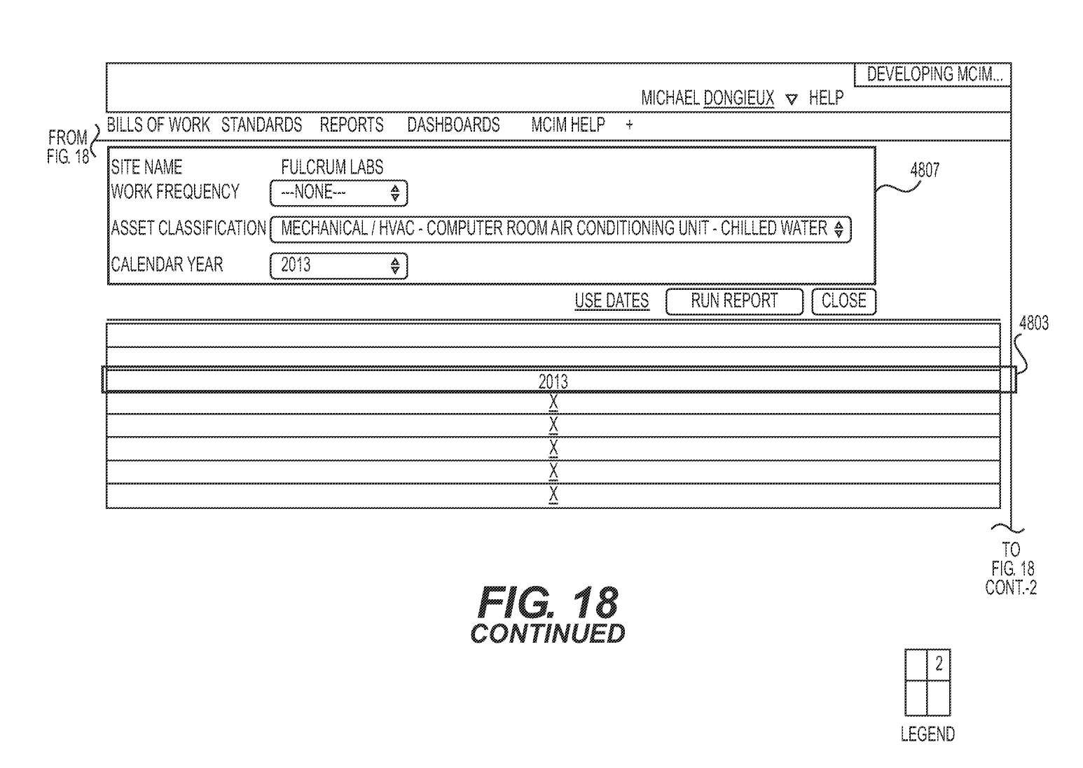

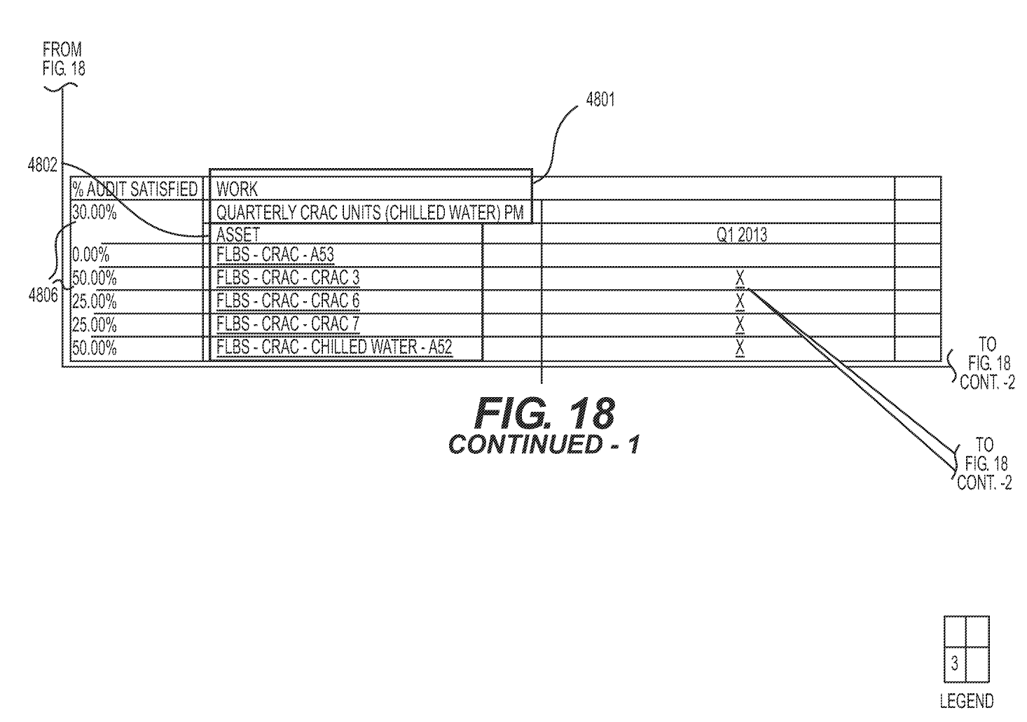

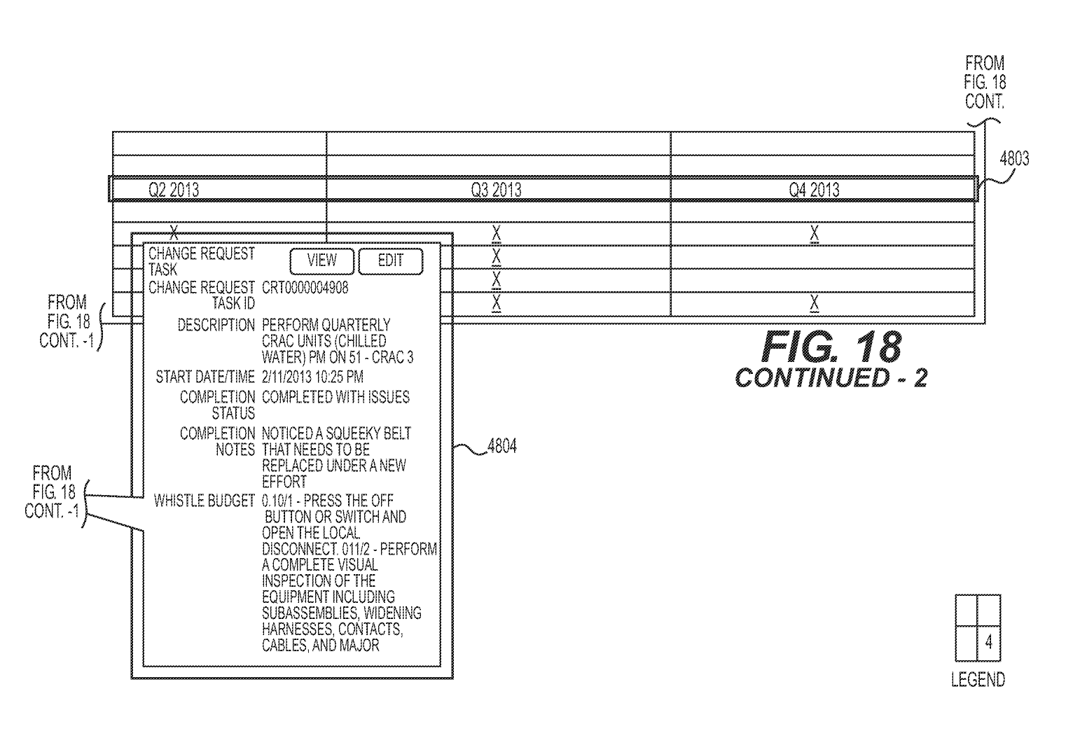

FIG. 18 demonstrates an audit report that may be included in the present approach. The audit report may be automatically generated by the system, which displays a matrix containing all required work templates for a site (or group of sites) for a specified period 4801, all assets upon which each work template must be performed 4802, and each period 4803 in which each work template must be performed on each related asset during the specified period. This prescription is possible due to the relationship between assets, their manufacturer model's bill of work, and the work templates assigned to that bill of work. As work templates are performed on assets over the course of a given period (whether via change request, or work order process), the audit report is automatically populated with links to each specific change request or work order that is eligible to satisfy each individual cell in the matrix (each cell representing a combination of work template, asset, period and current status of the work) 4804. As change requests and work orders progress through creation, approval and completion phases, the audit report's cells change color according to the color legend 4805, and the percentage of audit satisfied is automatically updated at both the work template level, as well as the individual asset level 4806. The process allows for the user to filter the audit report down by various criteria (such as work frequency, asset classification, or year, among others) 4807, allowing a user to ensure in advance that all maintenance has been scheduled for an upcoming year, for example.

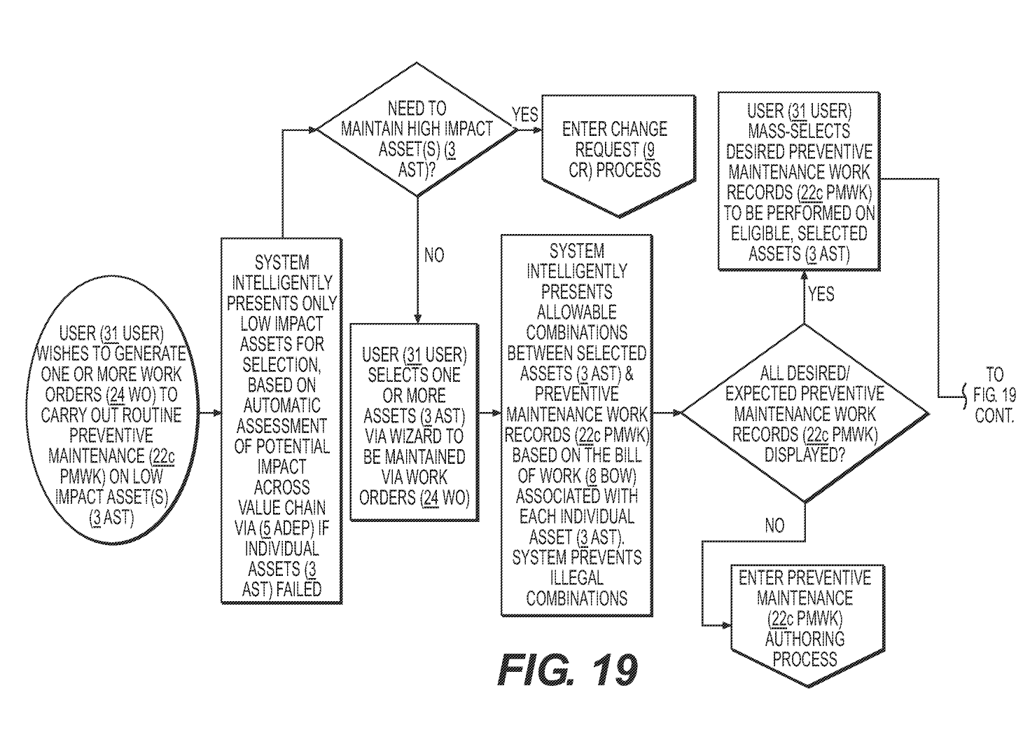

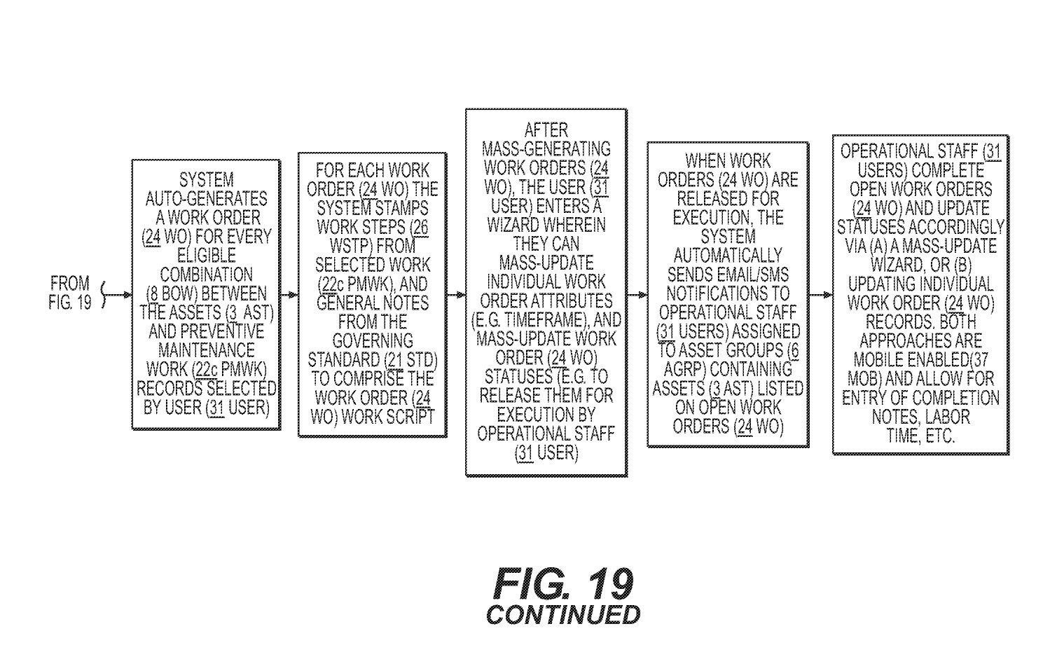

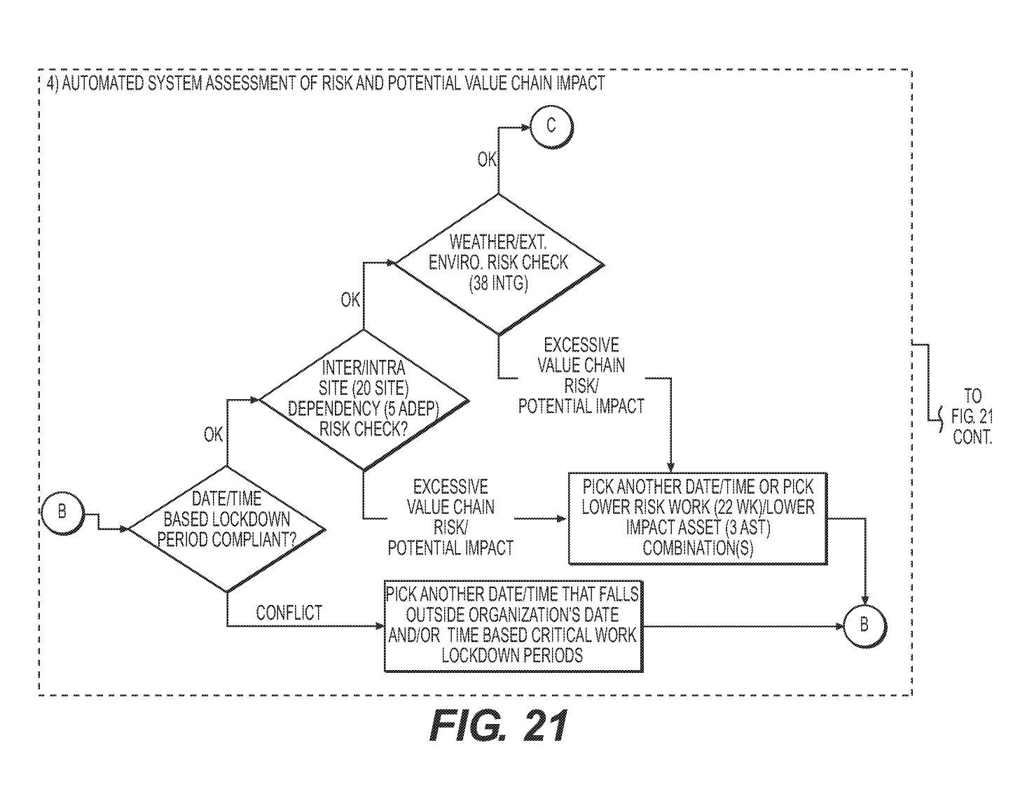

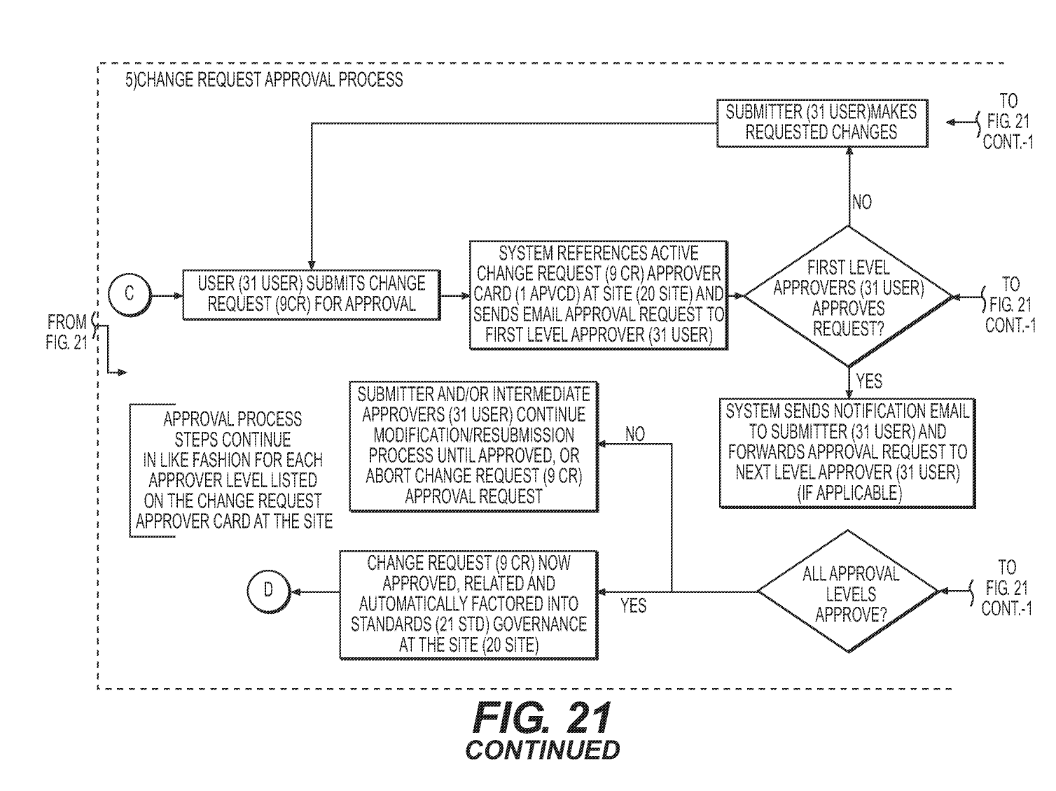

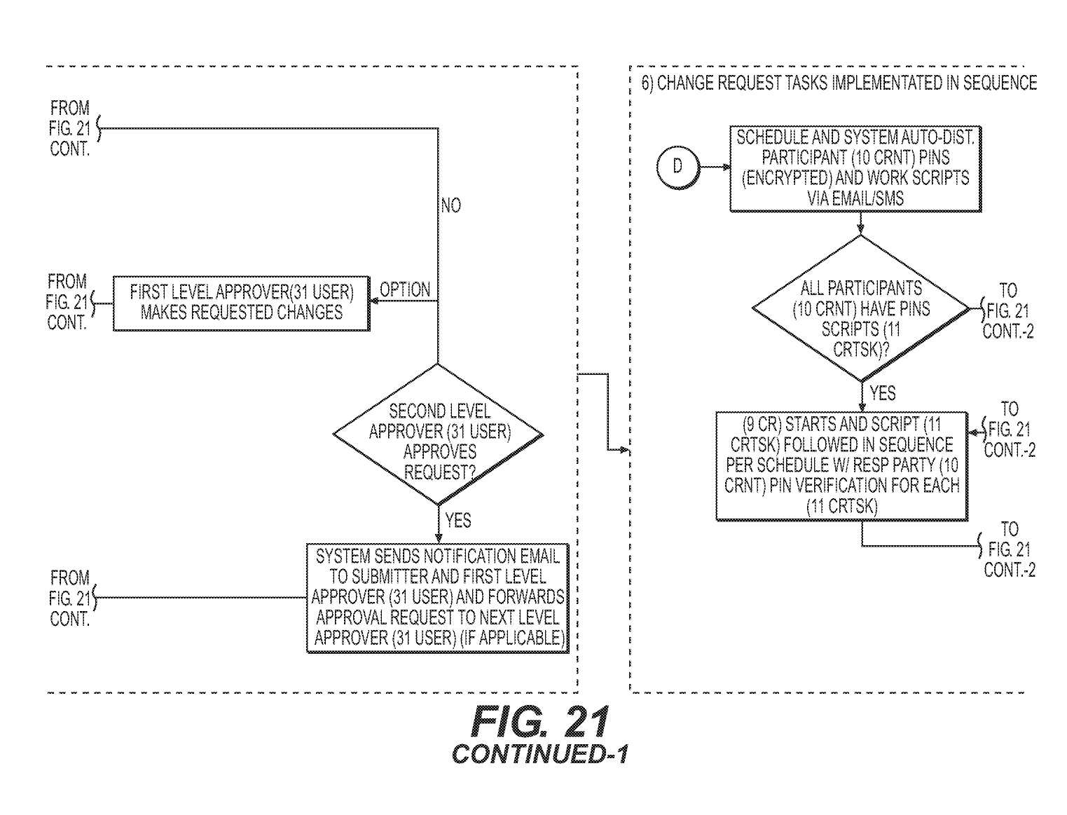

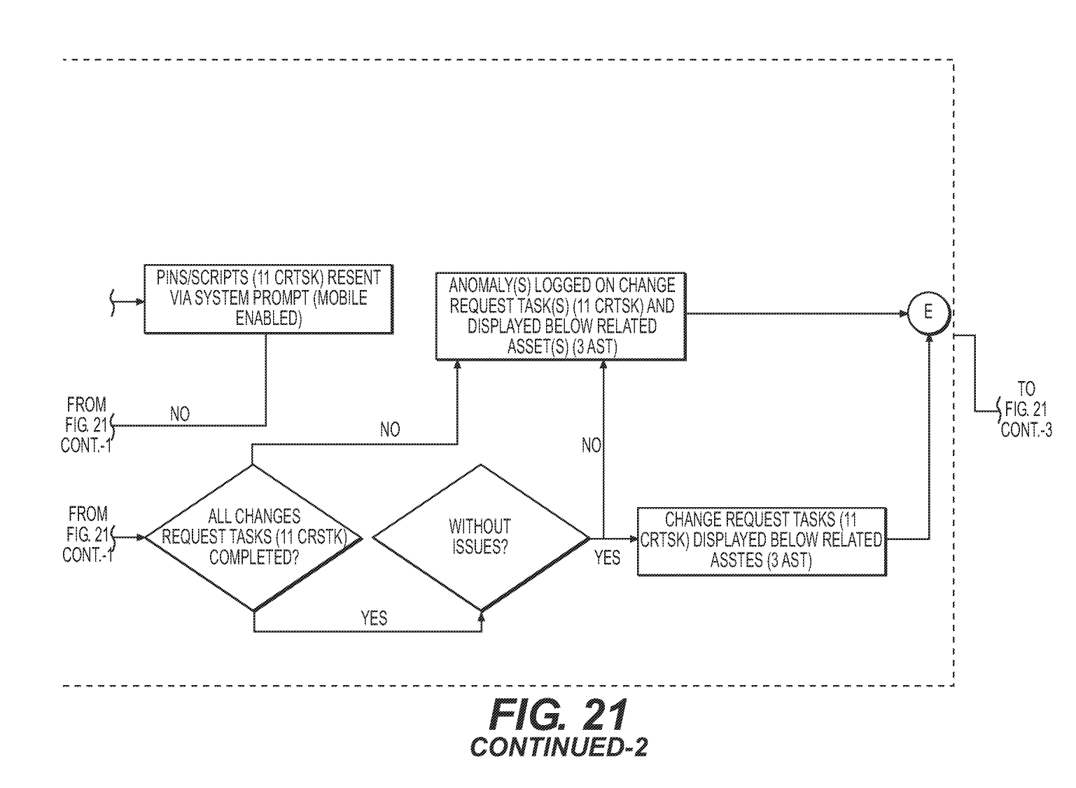

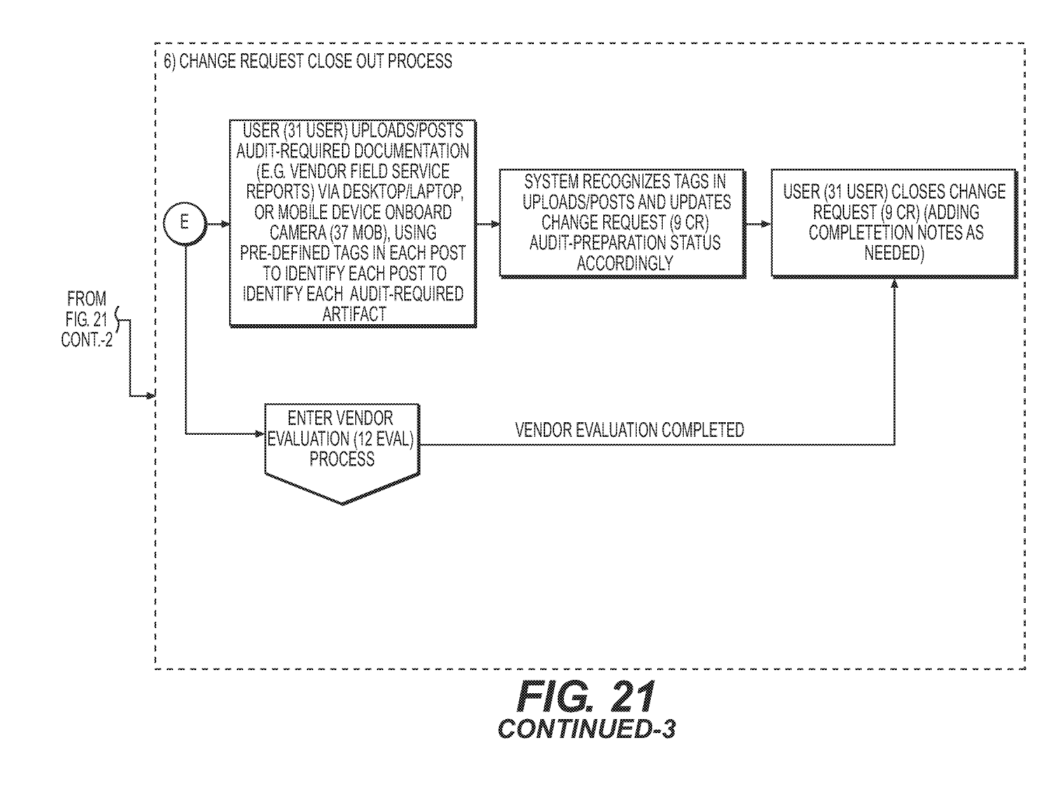

One of ordinary skill in the art would appreciate the need for integrating the process for the creation of work orders, which are typically less likely to cause substantial impact due to many factors, such as the type of work performed or the asset on which work is performed, and the creation of change requests, which have a higher probability of causing impact to the value creation chain within an organization due to many factors, such as, but not limited to, those mentioned for work orders. Therefore, correct assignment of a work order or change request to an asset are of critical importance. One of the keys to streamlining this process is to utilize a database of standards-based assets for which work can be assigned for a work template library, similar to those described above. Assignment of assets to, among other possible combinations of risk profile not accounted for in this binary example, low-risk work or a relatively high-risk change request can be done on a case by assign analysis of the asset's relative position in support of the value creation activities of an organization, the type of work being done, and the timing of the work, among other factors. However, as this is a labor intensive process without the assistance of a work template library created in association with a database of standards-based assets within a dependency, risk mapped framework one of ordinary skill in the art would recognize the utility in tying those functions together in a system that allowed for the automatic processing and assignment of a specific set of available work based on the characteristics of the scenario, empowered to relate the broad and specific contexts around said scenario, then automatically create the necessary work order or change request to be fulfilled. FIGS. 19-21 illustrates exemplary steps for a process for a work order process and a change request process to access both a shared work template library and shared asset database. Not all of the steps of FIGS. 19-21 have to occur in the order shown, as will be apparent to persons skilled in the relevant art(s) based on the teachings herein. Other operational and structural embodiments will be apparent to persons skilled in the relevant art(s) based on the following discussion. These steps are described in detail below.

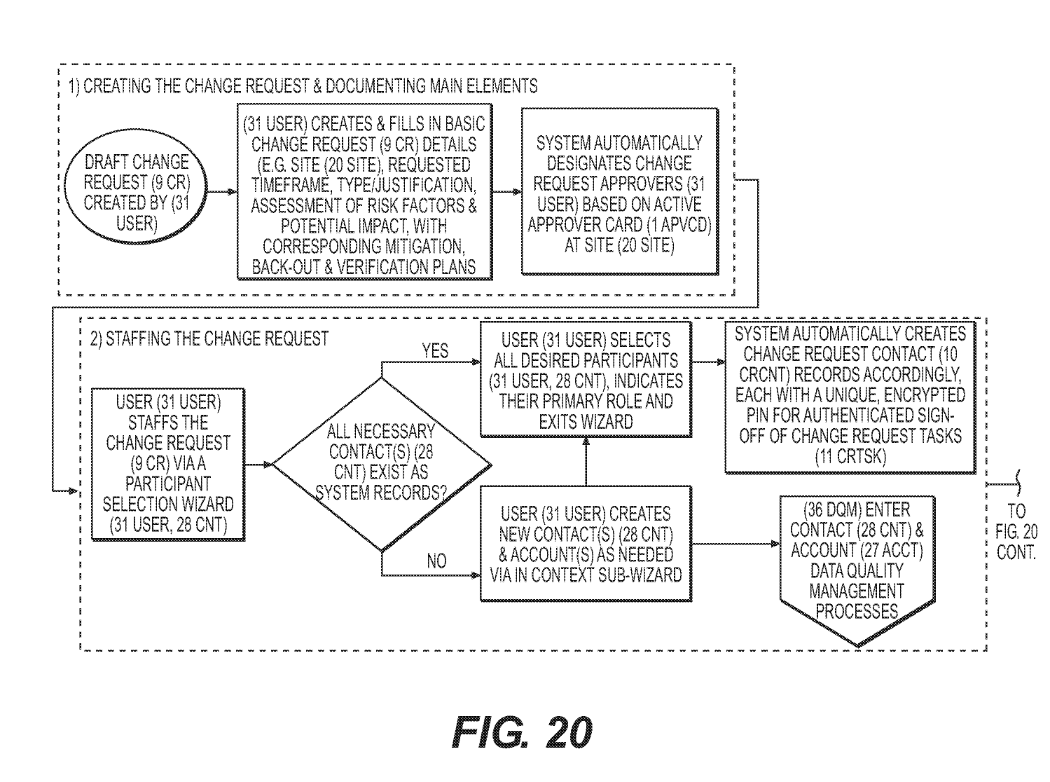

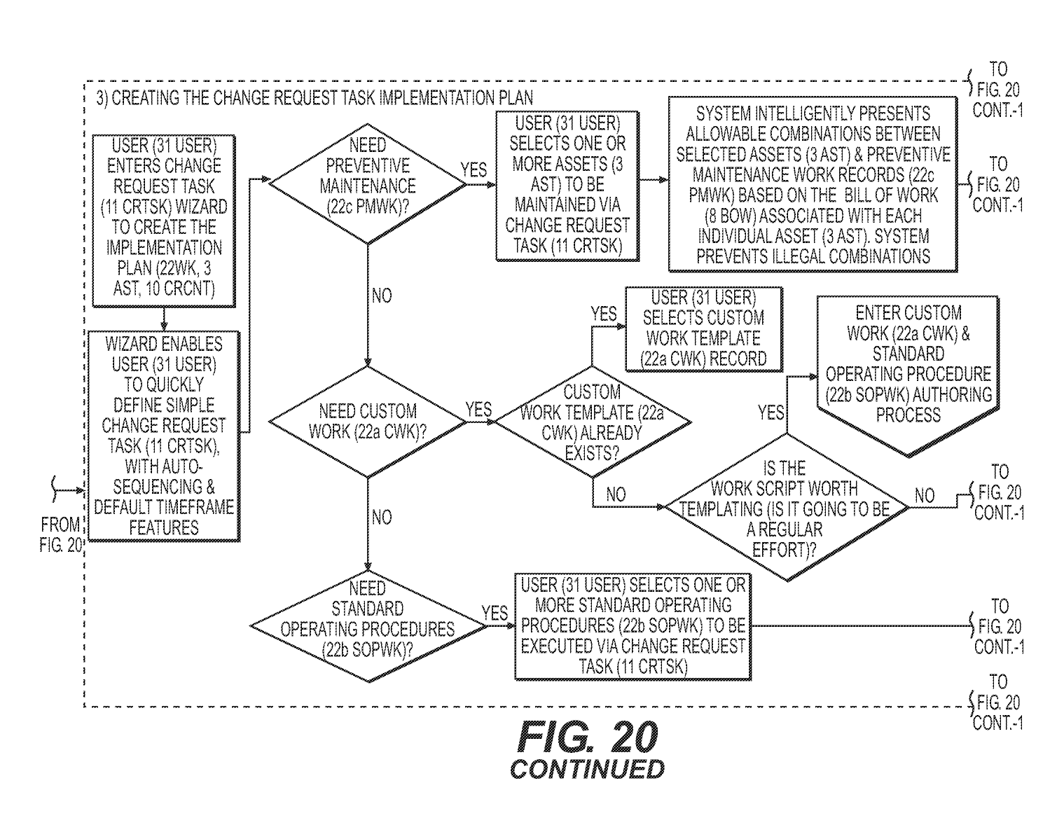

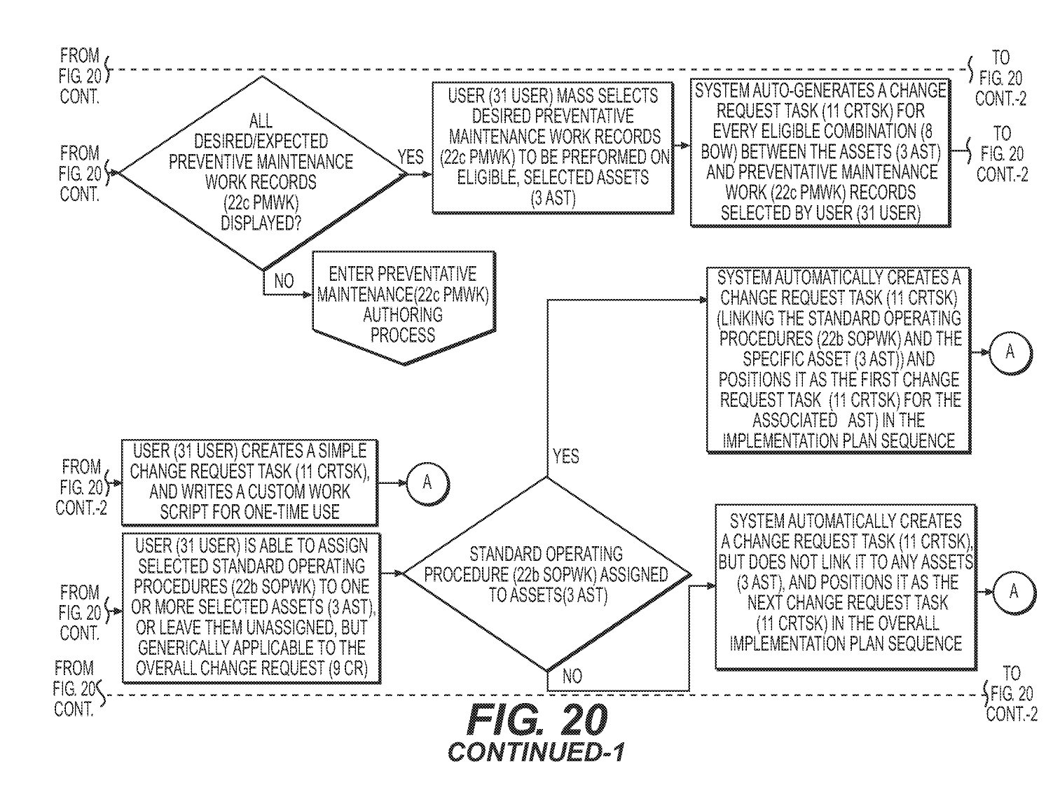

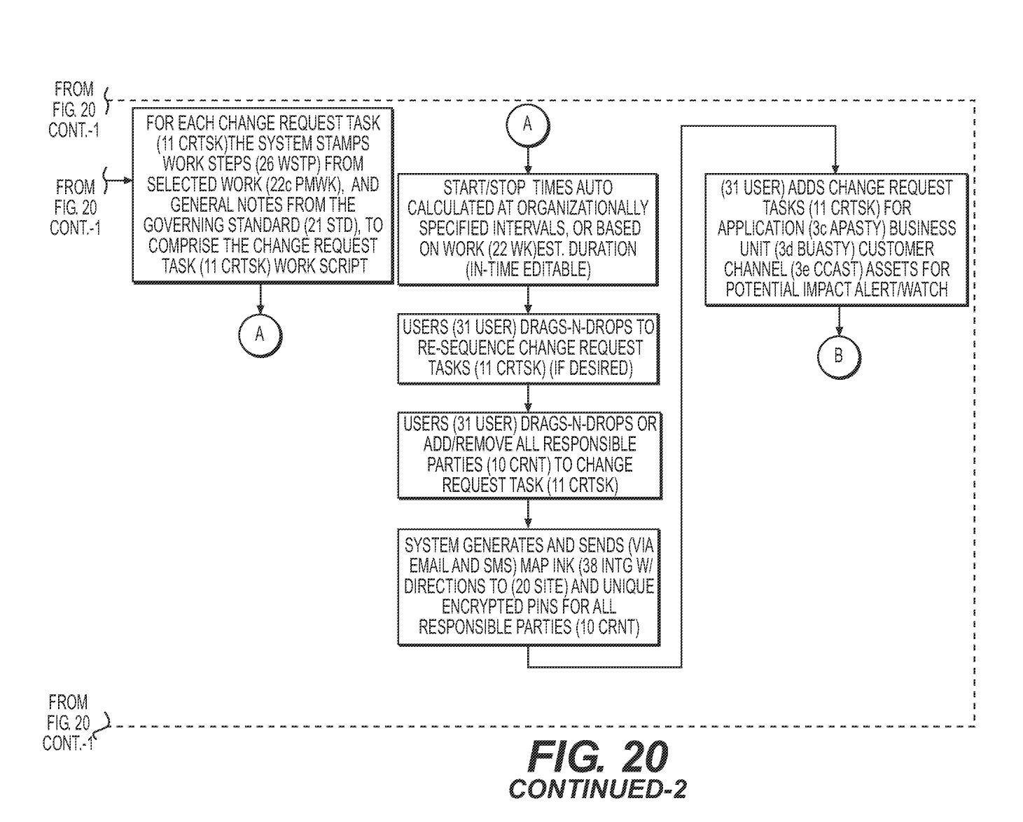

In the embodiment shown in FIG. 20, User 31 generates a draft Change Request 9, and fills in basic change request 9 details (e.g., site 20, requested timeframe, Type/Justification, etc. The system may assess risk factors and potential impact, with corresponding mitigation, back-out and verification plans. The system may automatically designate Change Request approvers based on, for example, active Approver Card 1 at site 20. User 31 may staff the Change Request 9, such as using a participant selection wizard. If necessary Contact(s) 28 already exist as system records, then User 31 selects all desired participants and may indicate primary role. The system may automatically create Change Request Contact 10 records accordingly, and may include a unique, encrypted PIN for the authenticated sign-off of Change Request Tasks 11. If Contact(s) 28 records are not in the system, then User 31 creates new Contact(s) 28 & Account(s) as needed via in context sub-wizard. User 31 may then enter a Change Request Task 11 wizard to create the implementation plan. The wizard may enable User 31 to quickly define simple Change Request Tasks 11, with auto-sequencing & default timeframe features. If the tasks require Preventive Maintenance 22c, then User 31 selects one or more assets 3 to be maintained via Change Request Task 11. The system may present allowable combinations between selected assets 3, and preventive maintenance work records 22c based on the Bill of Work 8 associated with each individual asset 3. The system may prevent illegal combinations. Desired and/or expected preventive maintenance work records 22c may be displayed. If not, then the system may enter a Preventive Maintenance 22c Authoring Process. If yes, then User 31 may mass-select desired preventive maintenance work records 22c to be performed on eligible, selected assets 3. The system may auto-generate a Change Request Task 11 for eligible combinations 8 between the assets 3 and preventive maintenance work 22c records selected by User 31. For each Change Request Task 11, the System may stamp work steps 26 from selected Work 22c general notes from the governing Standard 21, to comprise the Change Request Task 11 work script.

If the task does not need Preventive Maintenance 22c, then the system may determine whether the task requires Custom Work 22a. If so, then the system determines whether a Custom Work Template 22a exists? If so, User 31 may select the Custom Work Template 22a Record. If not, then the system determines whether the work script worth templating (i.e., is it going to be a regular work effort)? If yes, the User 31 may enter a Custom Work 22a and Standard Operating Procedure 22b Authoring Process. If not, User 31 may create a simple Change Request Task 11, and write a custom work script for one-time use.

If the task does not require Custom Work 22a, User 31 may select one or more Standard Operating Procedures 22b to be executed via Change Request Task 11. User 31 may to assign selected Standard Operating Procedures 22b to one or more selected assets 3, or leave them unassigned. Assignments may be generically applicable to the overall Change Request 9. If a Standard Operating Procedure 22b is assigned to Asset 3, then the system may automatically create a Change Request Task 11 (linking the Standard Operating Procedures 22b and the specific asset 3). The system may position the Standard Operating Procedure 22b as the first Change Request Tasks 11 for the associated asset 3 in the implementation plan sequence.

If there is no Standard Operating Procedure 22b assigned to the Asset 3, then the system may automatically create a Change Request Task 11, but not link it to any asset 3. The system may also position the task as the next Change Request Task 11 in the overall implementation plan sequence. The system may calculate start and stop times at specified intervals. The system may base times on Work 22 estimated duration (in-line editable). User 31 may alter intervals and sequence, such as by dragging and dropping tasks to re-sequence Change Request Tasks 11 (if desired). The system may issue (e.g., via email & SMS) a map link 38 with directions and unique encrypted PINS for all responsible parties 10. User 31 may add Change Request Tasks 11 to other assets, e.g., Application 3c, Business Unit 3d, and Customer Channel 3e assets for potential impact alert/watch.

User 31 may then enter a Change Request Task 11 wizard to create the implementation plan. The wizard may enable User 31 to quickly define simple Change Request Tasks 11, with auto-sequencing & default timeframe features. If the tasks require Preventive Maintenance 22c, then User 31 selects one or more assets 3 to be maintained via Change Request Task 11. The system may present allowable combinations between selected assets 3, and preventive maintenance work records 22c based on the Bill of Work 8 associated with each individual asset 3. The system may prevent illegal combinations. Desired and/or expected preventive maintenance work records 22c may be displayed. If not, then the system may enter a Preventive Maintenance 22c Authoring Process. If yes, then User 31 may mass-select desired preventive maintenance work records 22c to be performed on eligible, selected assets 3. The system may auto-generate a Change Request Task 11 for eligible combinations 8 between the assets 3 and preventive maintenance work 22c records selected by User 31. For each Change Request Task 11, the System may stamp work steps 26 from selected Work 22c general notes from the governing Standard 21, to comprise the Change Request Task 11 work script. If the task does not need Preventive Maintenance 22c, then the system may determine whether the task requires Custom Work 22a. If so, then the system determines whether a Custom Work Template 22a exists? If so, User 31 may select the Custom Work Template 22a Record. If not, then the system determines whether the work script worth templating (i.e., is it going to be a regular work effort)? If yes, the User 31 may enter a Custom Work 22a and Standard Operating Procedure 22b Authoring Process. If not, User 31 may create a simple Change Request Task 11, and write a custom work script for one-time use. If the task does not require Custom Work 22a, User 31 may select one or more Standard Operating Procedures 22b to be executed via Change Request Task 11. User 31 may to assign selected Standard Operating Procedures 22b to one or more selected assets 3, or leave them unassigned. Assignments may be generically applicable to the overall Change Request 9. If a Standard Operating Procedure 22b is assigned to Asset 3, then the system may automatically create a Change Request Task 11 (linking the Standard Operating Procedures 22b and the specific asset 3). The system may position the Standard Operating Procedure 22b as the first Change Request Tasks 11 for the associated asset 3 in the implementation plan sequence. If there is no Standard Operating Procedure 22b assigned to the Asset 3, then the system may automatically create a Change Request Task 11, but not link it to any asset 3. The system may also position the task as the next Change Request Task 11 in the overall implementation plan sequence. The system may calculate start and stop times at specified intervals. The system may base times on Work 22 estimated duration (in-line editable). User 31 may alter intervals and sequence, such as by dragging and dropping tasks to re-sequence Change Request Tasks 11 (if desired). The system may issue (e.g., via email & SMS) a map link 38 with directions and unique encrypted PINs for all responsible parties 10. User 31 may add Change Request Tasks 11 to other assets, e.g., Application 3c, Business Unit 3d, and Customer Channel 3e assets for potential impact alert/watch.

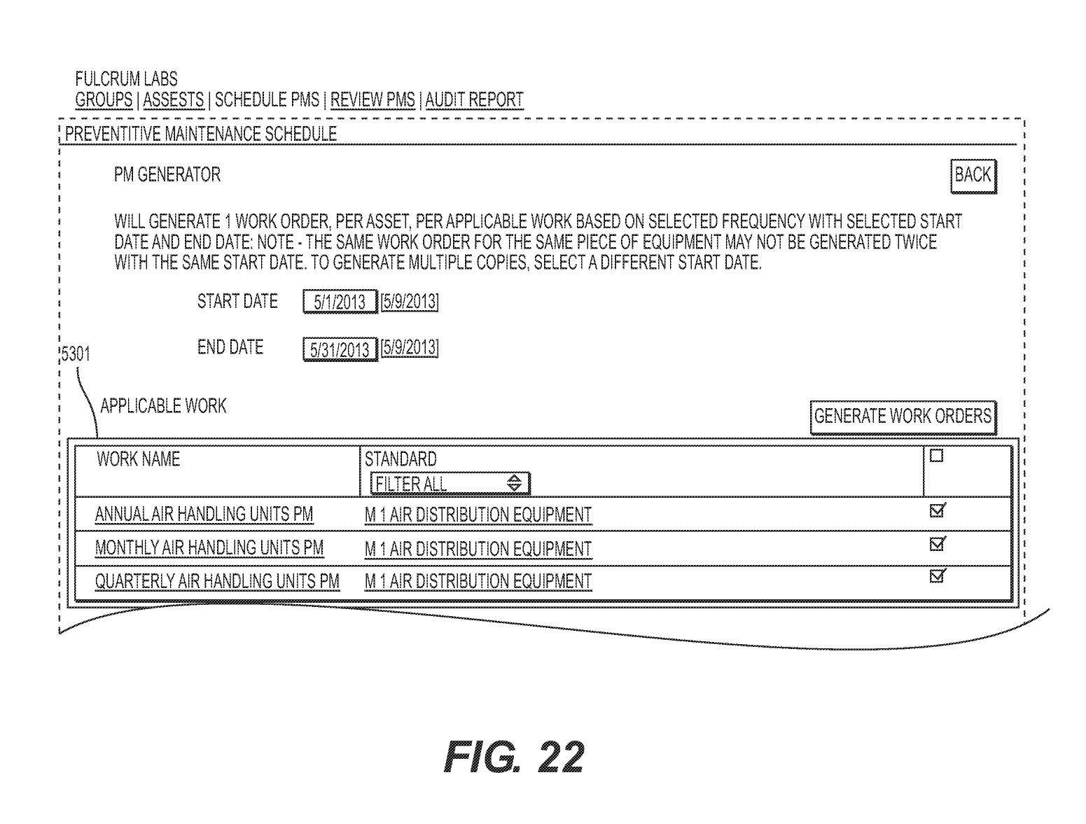

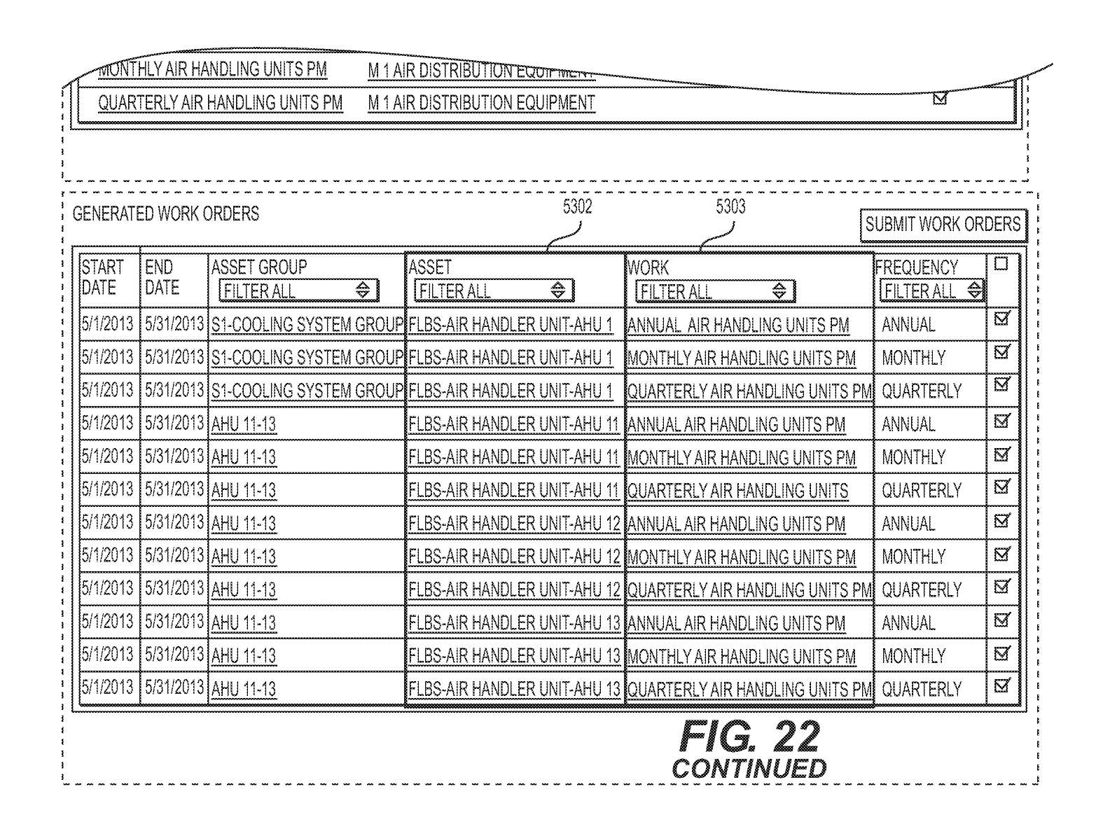

As demonstrated in FIG. 22, a user selects assets upon which to perform maintenance via the work order process. Because work order processes are traditionally less rigorous than change request processes from a risk mitigation standpoint, the system is able to evaluate the potential impact (priority/criticality 1402, current operating status 1403, upstream and downstream risk relationships and dependencies 1501, 1502), of each selected asset against the level of risk of each eligible, selected work template 5003, and either allow or disallow the use of the work order process based on configurable risk tolerance settings. As discussed above, FIG. 19 provides a flowchart summary of a method for the decision making process just described. In the embodiment shown in FIG. 19, User 31 may generate one or more Work Orders 24 for, e.g., routine Preventive Maintenance 22c on Low Impact asset(s) 3. The system may present only low impact assets for selection based on automatic assessment of potential impact across value chain. If the Work Order 24 involves a high impact asset(s) 3, then the system may enter a Change Request 9 process. If not, then User 31 may select one or more assets 3 via a wizard to for the Work Order(s) 24. The system may present allowable combinations between selected assets 3, and may prevent illegal combinations. The system may decide whether desired/expected preventive maintenance work records 22c are displayed. If not, then the system may enter a Preventive Maintenance 22c Authoring Process. If yes, User 31 may mass select desired preventive work records 22c to be performed on eligible, selected assets 3. The system may then auto-generate a Work Order 24 for eligible combinations 8 between the assets 3 and preventive maintenance work 22c records. For each Work Order 24, the system may stamp work steps 26 from selected Work 22c, and general notes from the governing Standards 21, to comprise the Work Order 24 work script. After generating work orders 24, User 31 may enter a wizard to mass-update individual work order attributes (e.g., timeframe) and mass-update work order 24 statuses (e.g., to release them for execution by operational staff 31. When work orders 24 are released for execution, the system may automatically send notifications (e.g., email/SMS) staff 31 assigned to asset groups 6 containing assets 3 listed on open work orders 24. Staff 31 may complete open work orders 24 and update statuses accordingly via, for example, (a) a mass-update wizard, or (b) updating individual work order 24 records. Both approaches may be mobile-enabled (37 MOB) and allow for entry of completion notes, labor time, etc.

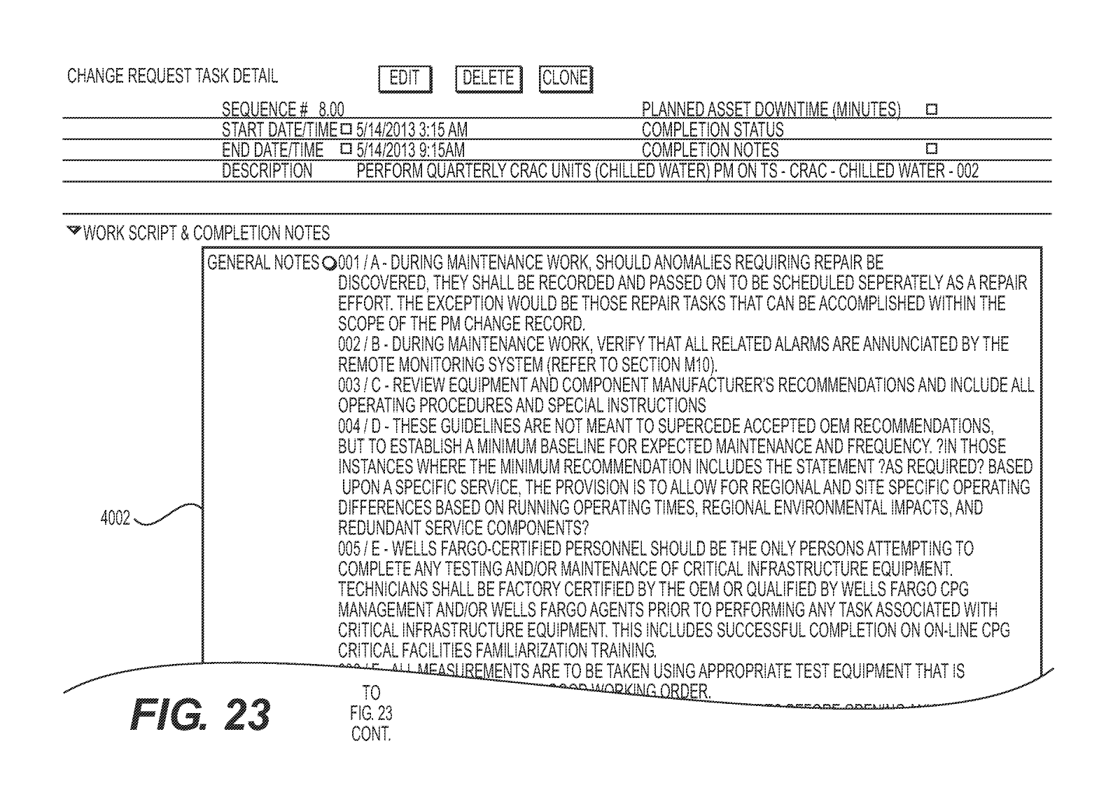

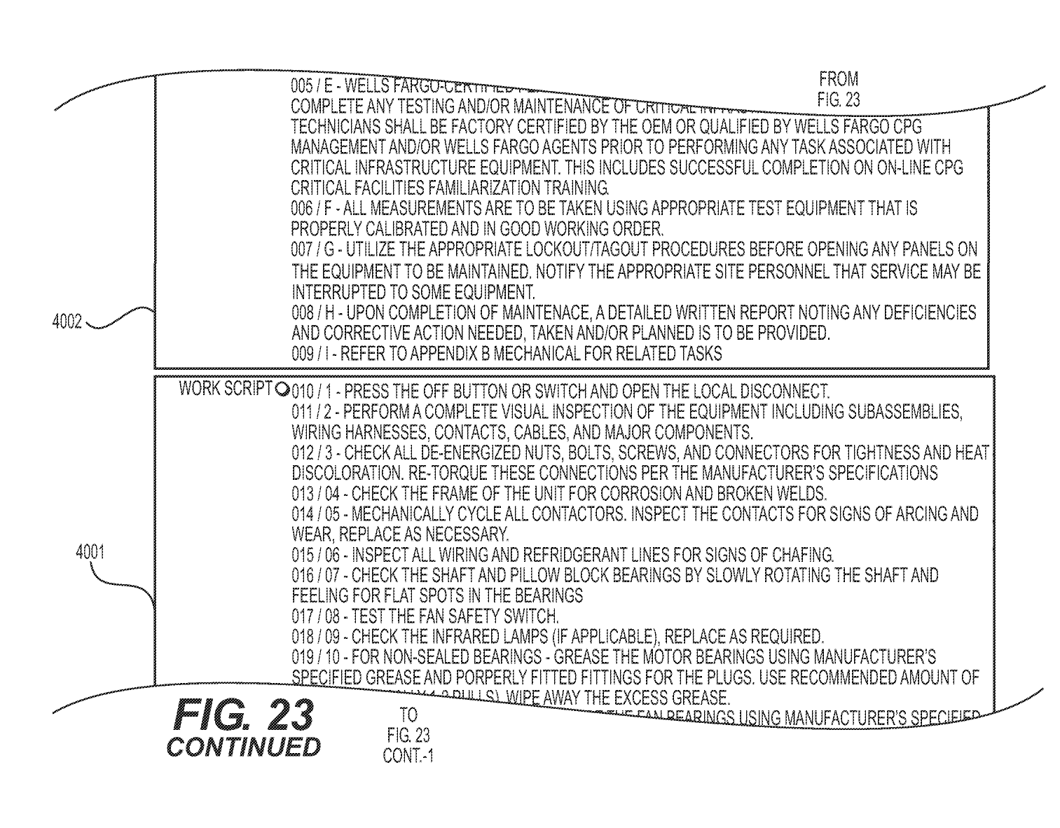

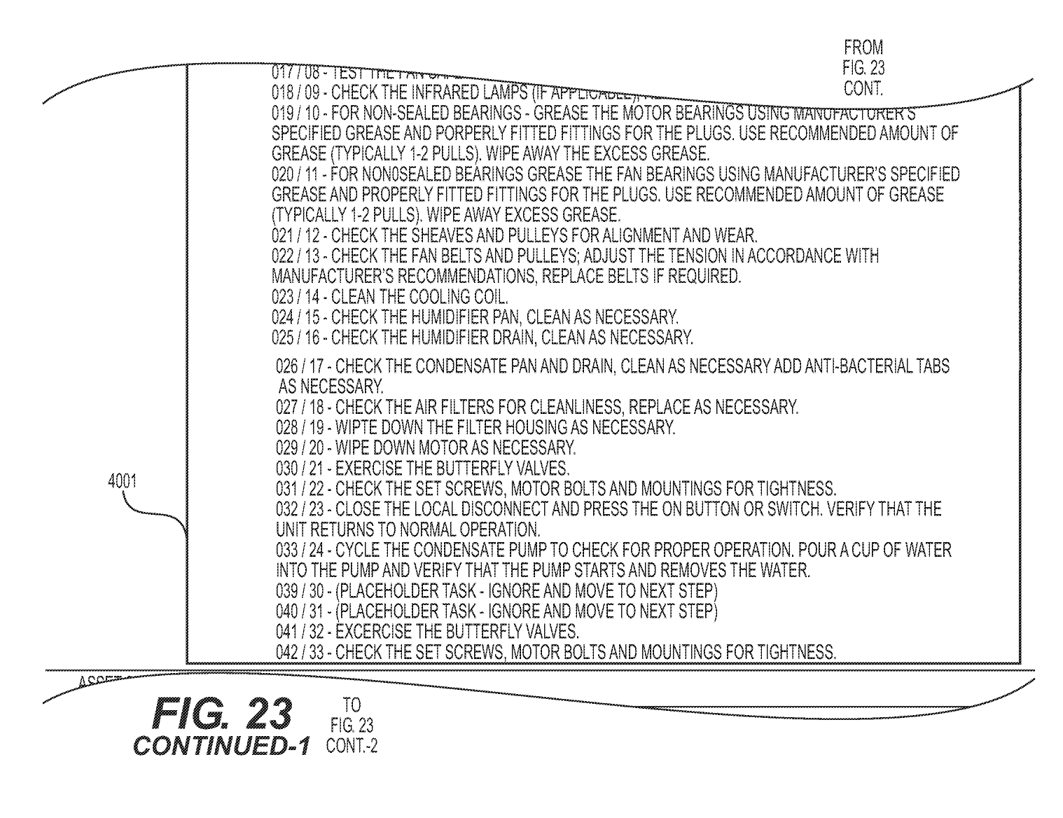

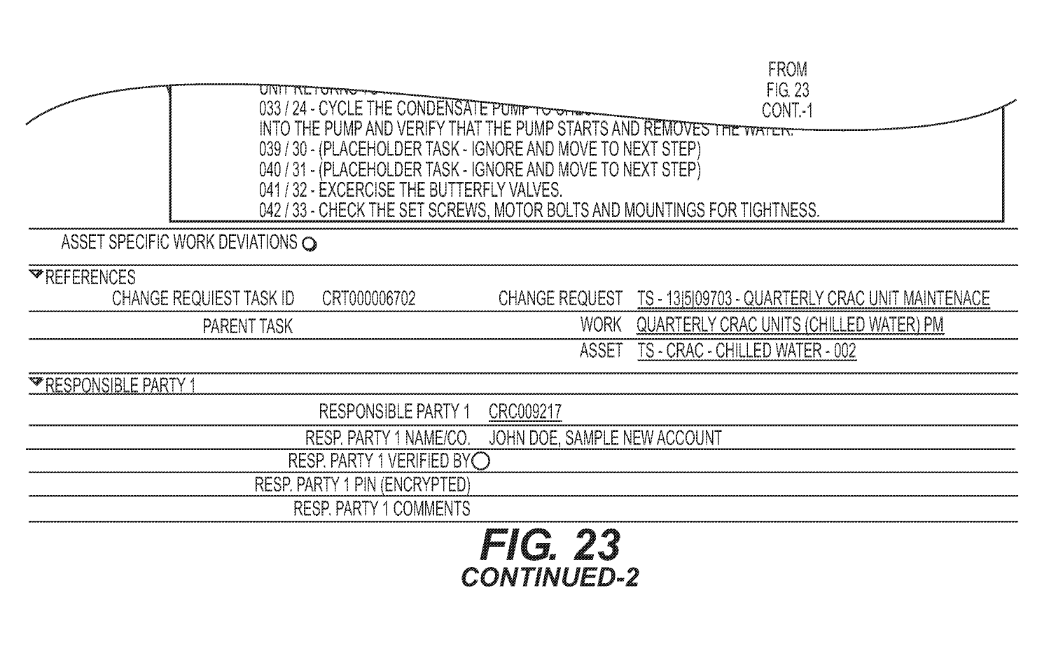

If allowed to proceed, only eligible work templates which are related to the selected asset(s) manufacturer model's bill of work are displayed for selection, as seen in 5301. The user selects which of the eligible work templates they wish to schedule for the selected asset(s), after which a preview of all combinations of asset 5202 and work template 5303 are displayed for review before final submission. Upon submission, a new work order is created for each selected, eligible combination of asset and work template. Upon submission, the work script section 4001 of each new work order or change request task, demonstratively shown in FIG. 23, is automatically populated with all work steps 5002 listed under the relevant work template 5001 at that point in time, and any general notes 4904 from the common course-grained standard 4903 of the asset and work are also populated in the general notes section. This method and process ensures that (a) the most recent versions of work templates are always used when creating and performing new work orders or change requests, and (b) the integrity of the steps taken in historical work efforts is preserved on the work order or change request.

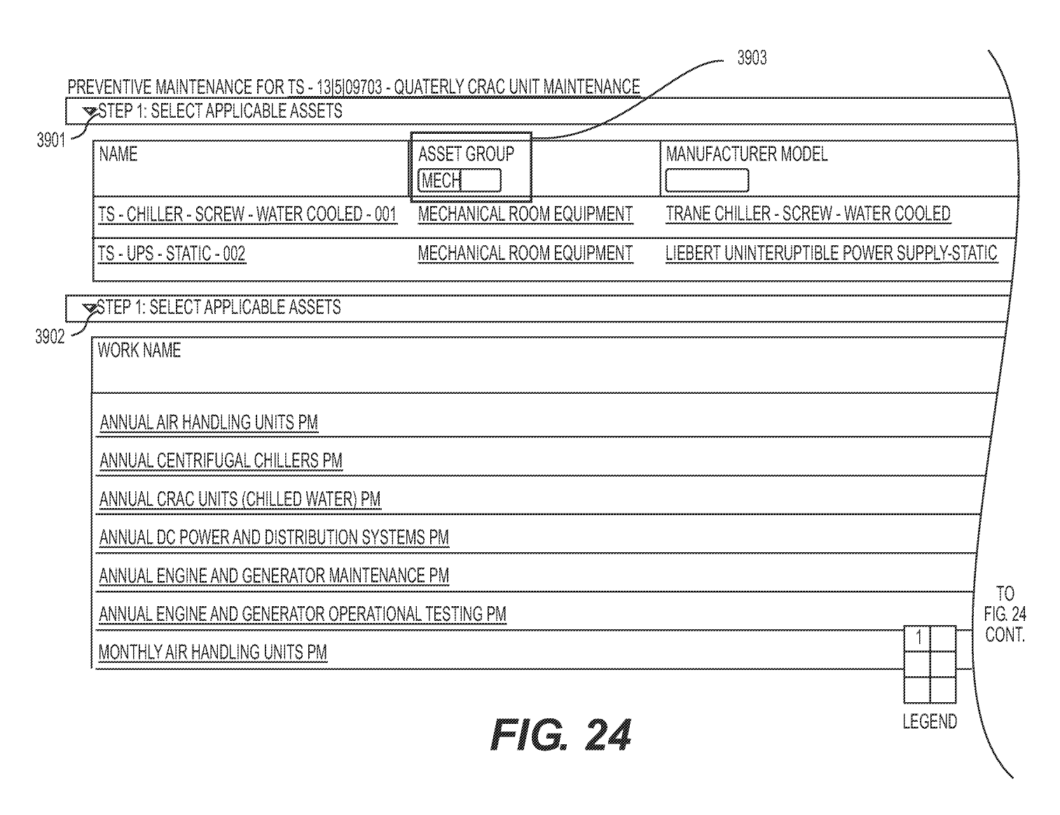

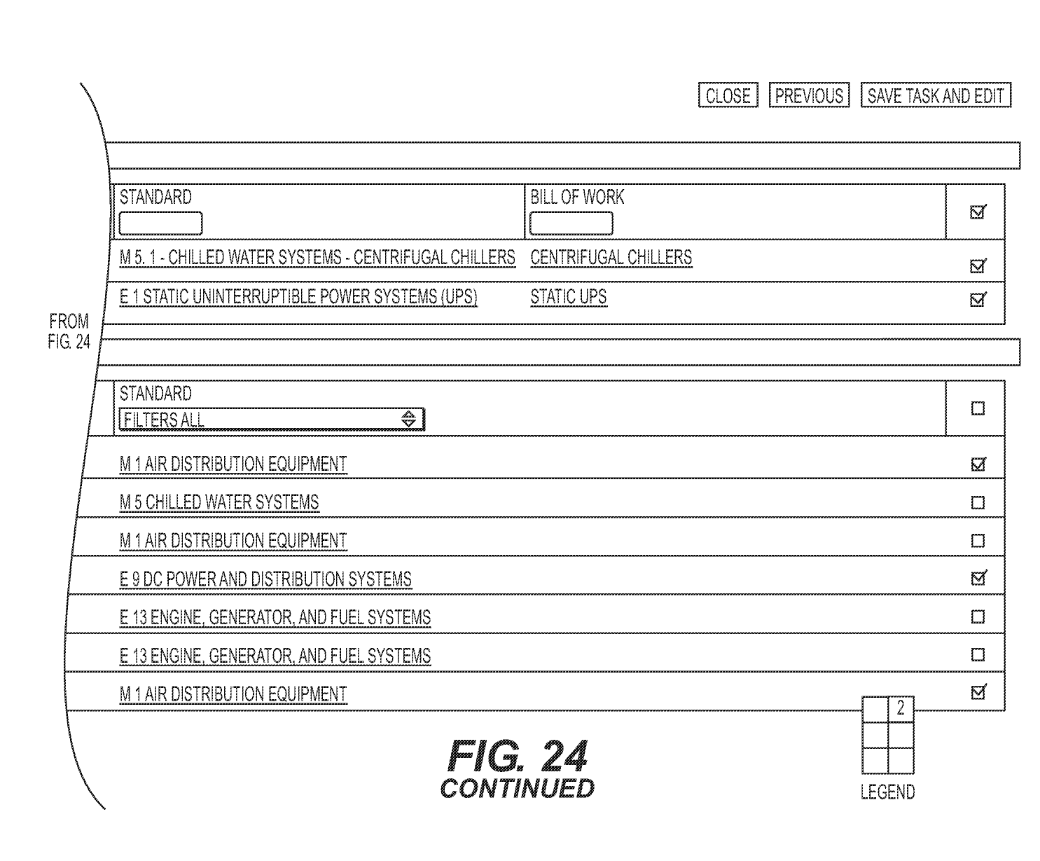

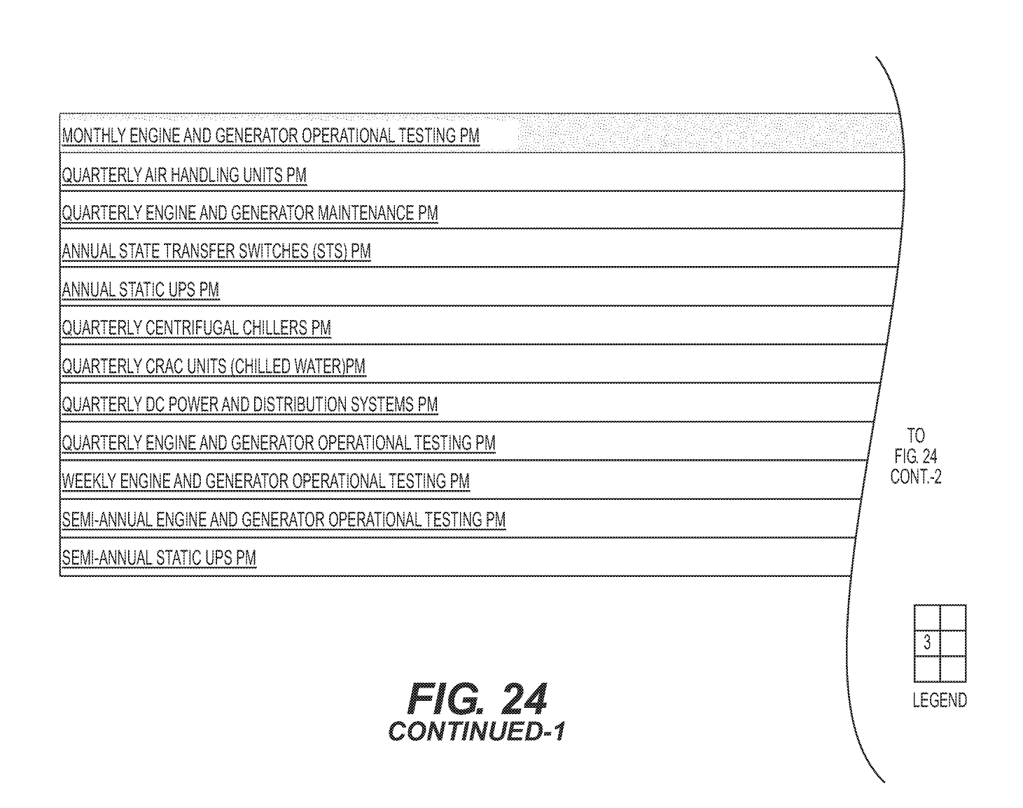

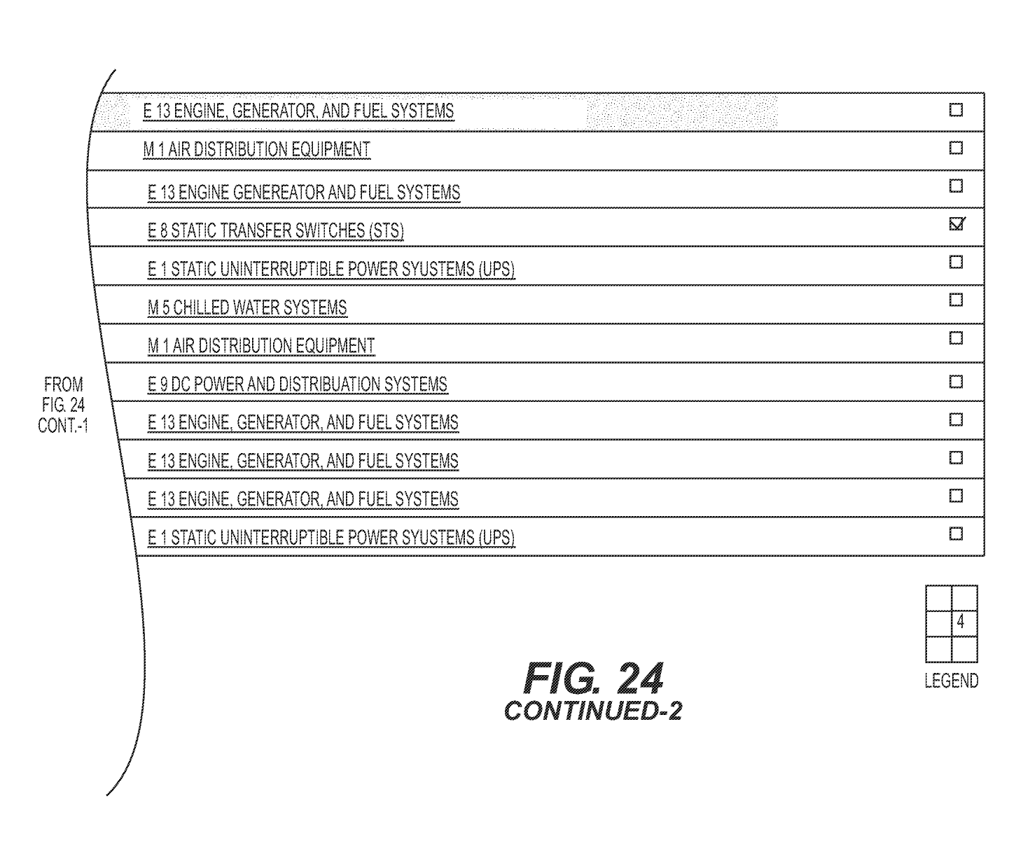

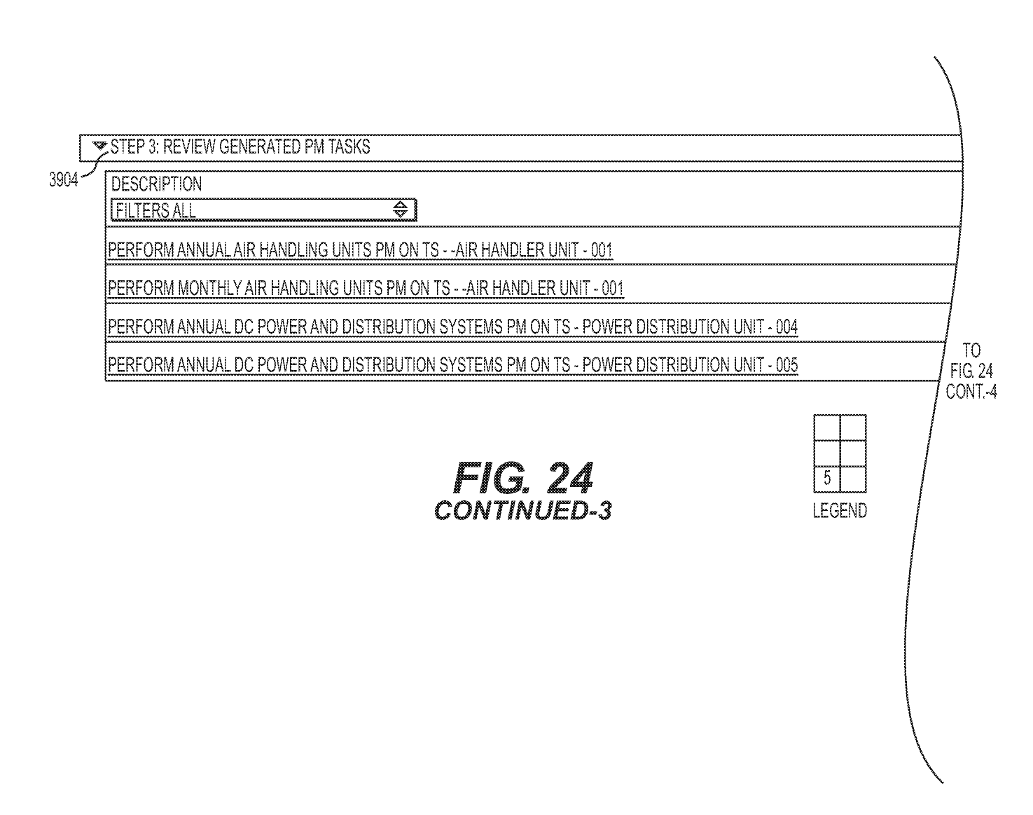

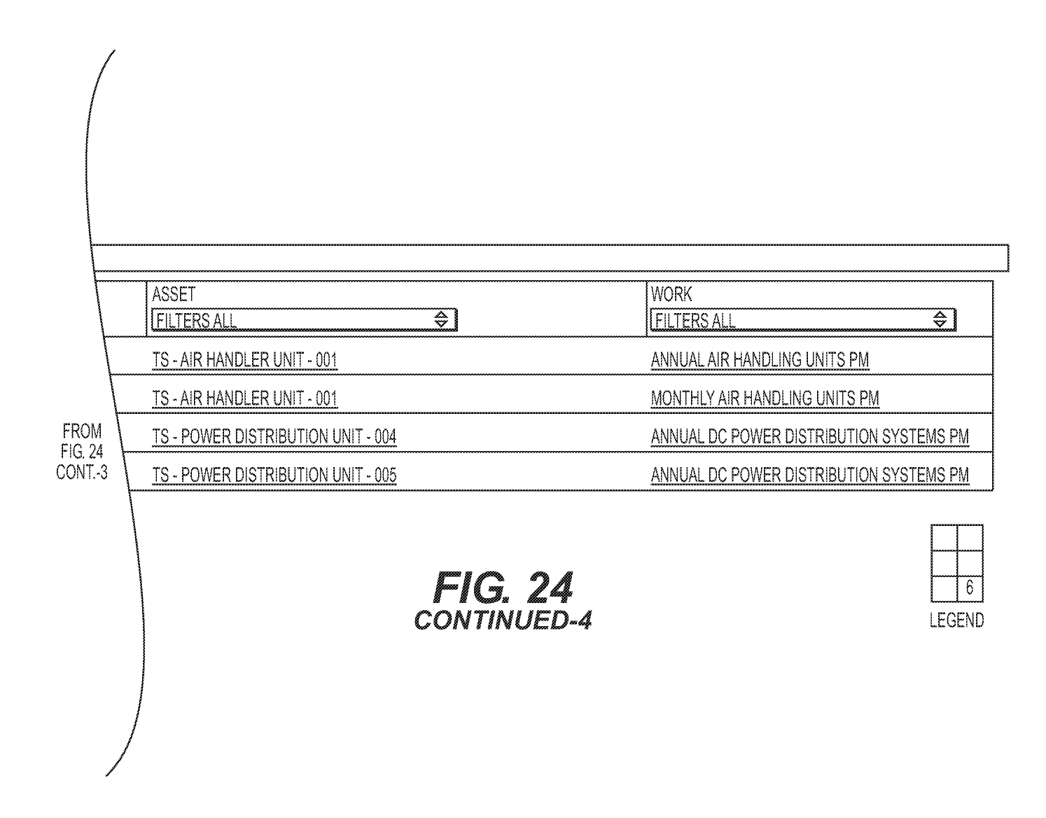

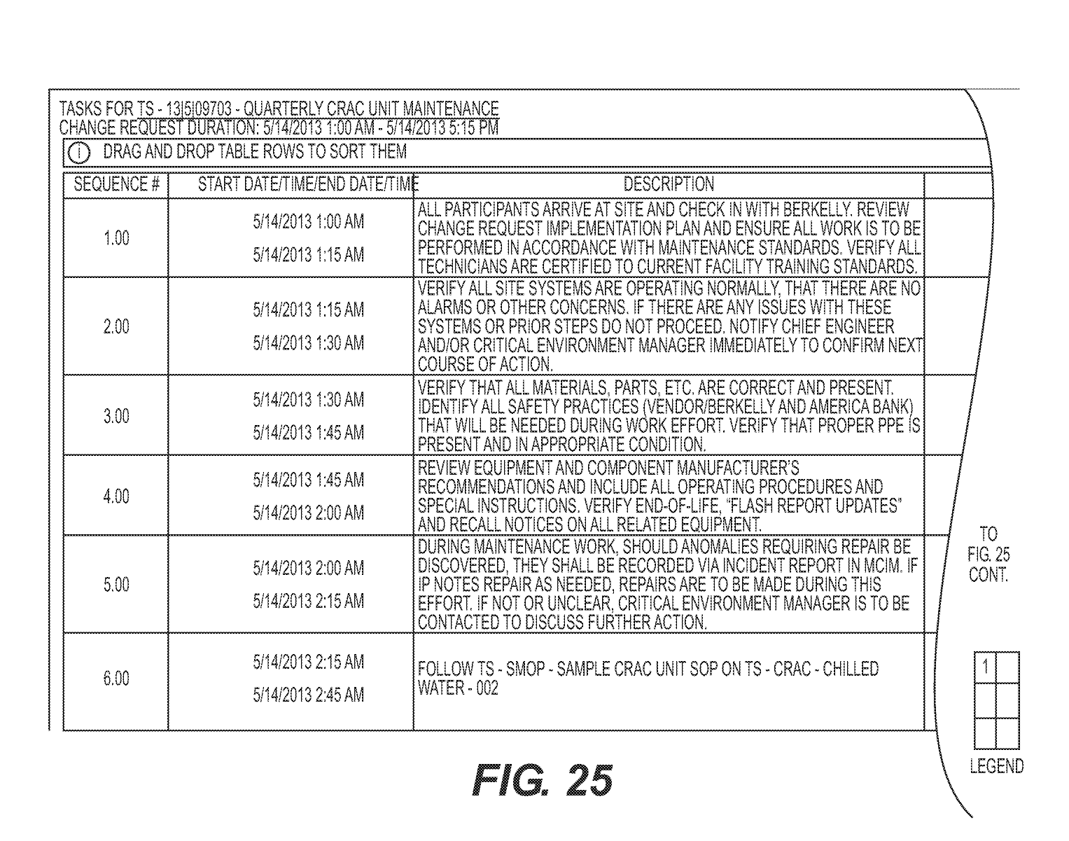

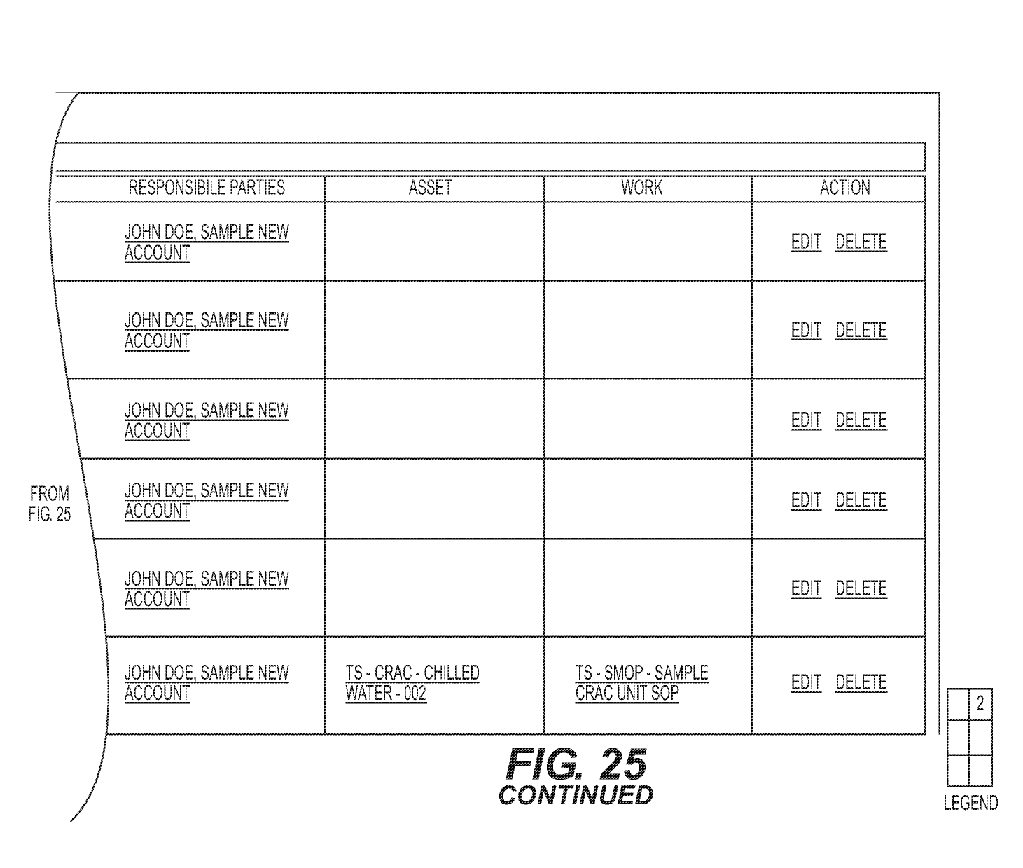

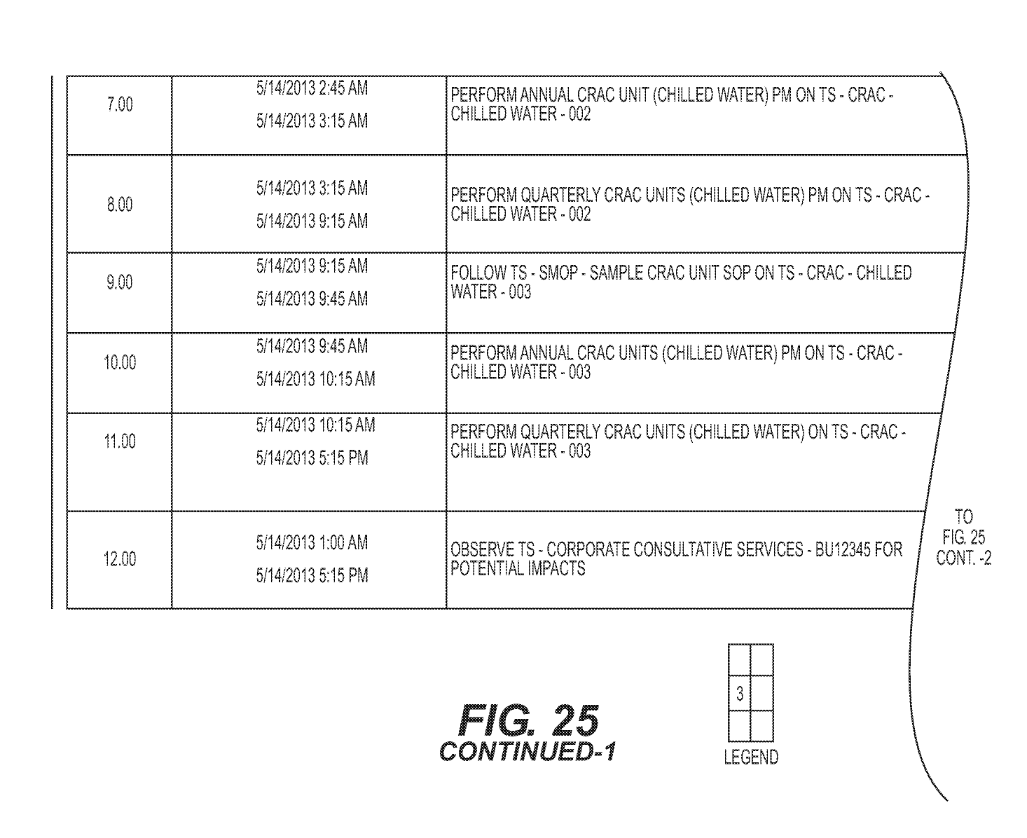

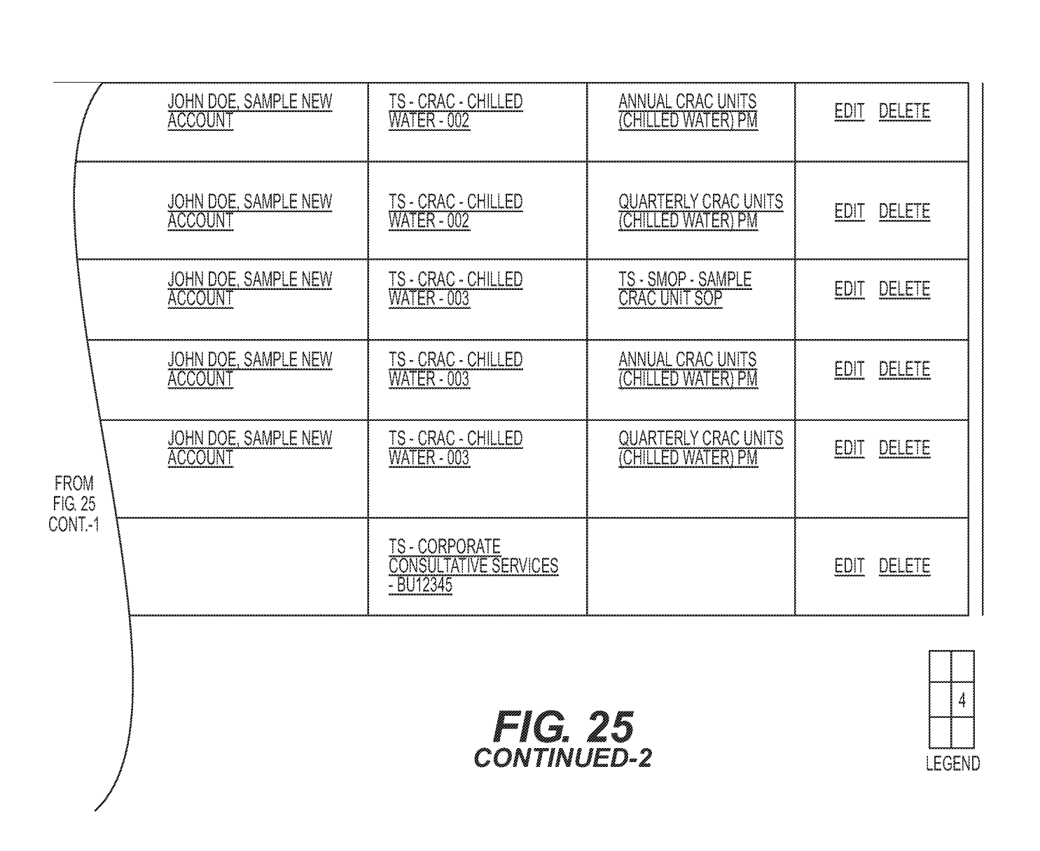

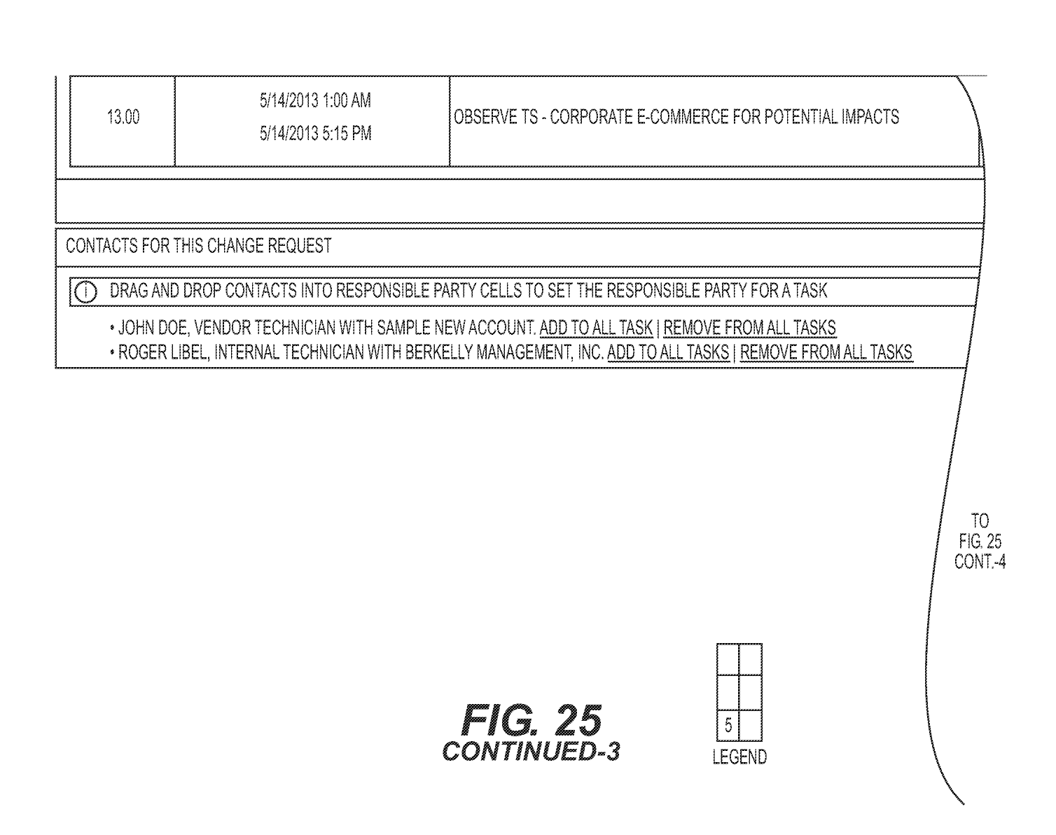

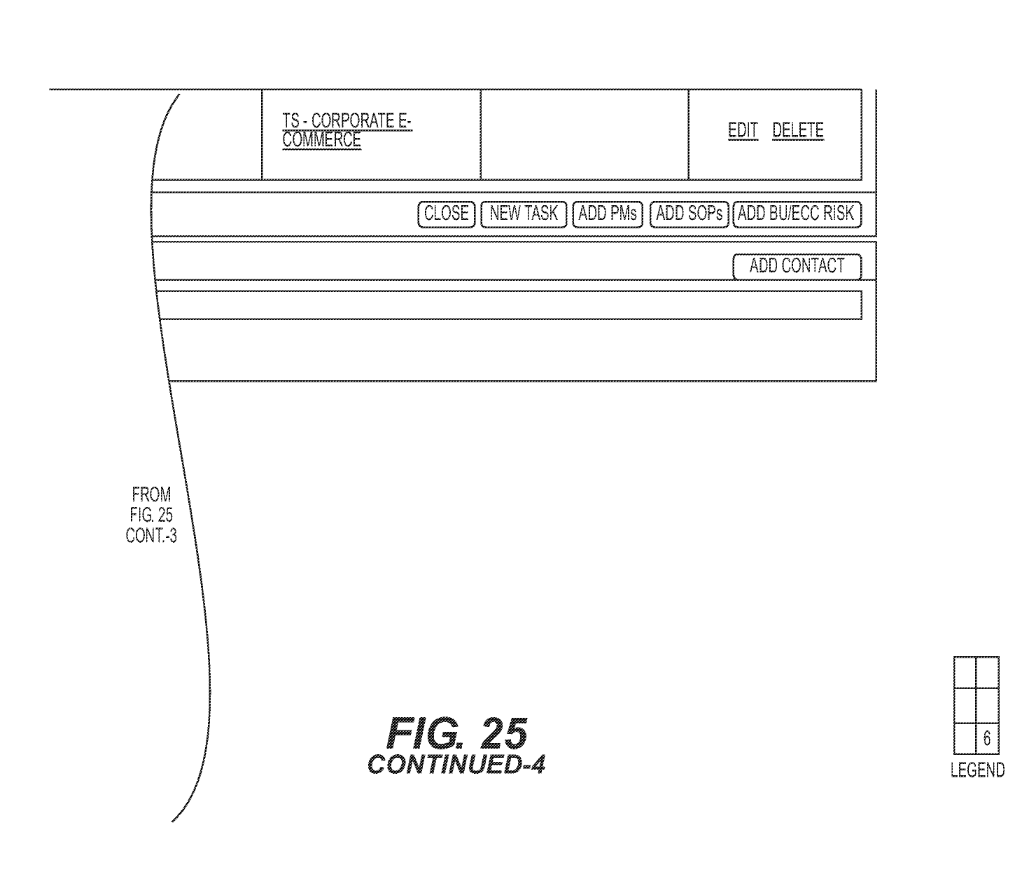

Similar to the work order process in FIG. 22 (but more rigorous from a risk mitigation standpoint), FIG. 24 shows a demonstrative screen capture in which a user selects assets 3901 upon which to perform maintenance via the change request process. In some embodiments, only eligible work templates which are related to the selected asset(s)' manufacturer model's bill of work are displayed for selection, as seen in 3902 (note—the assets and corresponding bills of work responsible for some work templates seen in 3902 aren't display in 3901 due to the filter applied in 3903, which was done to allow the image to fit on a single page). The user selects which of the eligible work templates they wish to schedule for the selected asset(s), after which a preview of all selected, eligible combinations of asset 5202 and work template 5303 are displayed for review before final submission. Upon submission, the work script section 4001 of each new work order or change request task, shown in FIG. 23, may be automatically populated with all work steps 5002 listed under the relevant work template 5001 at that point in time, and any general notes 4904 from the common course-grained standard 4903 of the asset and work are also populated in the general notes section. This method and process helps to ensure that (a) the most recent versions of work templates are always used when creating and performing new work orders or change requests, and (b) the integrity of the steps taken in historical work efforts is preserved on the work order or change request. Once a change request implementation plan, such as the demonstrative plan illustrated in FIG. 25, has been created, such as in the preceding steps, the system can assist the user in selecting a suitable time to perform the work, based on the system's awareness of planned and unplanned events occurring to other assets which share risk relationships and/or dependencies with one or more assets involved in the current change request. Using this method and process, the system can prevent the user from unknowingly creating collective circumstances wherein risk and/or potential impact is increased to an unacceptable level.

The utility of a set of standards for an organization are based on its concentration of knowledge and experience to create a framework that incorporates the collective experience of past incidents, impacts, processes, vendor performance, or asset lifecycle, among many others, to mitigate the future incidence of risk and events that impact the processes of value creation. Therefore the utility of any single sub-division of an organization is limited in its ability to create inclusive and powerful risk minimizing standards. This idea can be further abstracted to apply to the organizations within an industry, or industries within a market vertical. The process for creating these cross-organizational benchmarks at a standing point in time is straight forward, but creating a benchmark that evolves over time and may utilize a continuously changing stream of data to discern the standards and practices which are most beneficial requires a robust system that provides transparent hierarchies for any particular standard, permits user input through a community, and mitigates the probability of sharing sensitive information among participants may require the creation of a self-policed, or organizationally governed, system.

Embodiments of the present approach may include a module for automatic standards benchmarking and evolution both within and among organizations, which may, in turn, provide a position whereby industry standards can be created utilizing the data, which may be anonymized, of each user and organization to create an evolving standard which maximizes the relative benefit to all parties, while minimizing external exposure of possibly sensitive information. The present approach, in one embodiment, permits through the creation of a community of users who may interact in a virtual space to discuss the standards as they evolve, create leadership hierarchies which may allow for the organization to police itself, may include a system of voting on those approaches deemed most effective, and may include a set of algorithms that can process the large amount of data concerning events, impacts, and user behavior to promote or create those standards which are likely to be most effective. Another embodiment of the present approach would permit these standards to be processed from any combination of user and system generated data concerning events, impacts and user behavior, among other relevant variables likely to impact the utility of a standard, to provide an evolving set of standards which are available to all users in a centrally accessible database, where each organization may choose which, if any, of the standards they wish to adopt. In some embodiments, this module may be based on an integrated incident process.

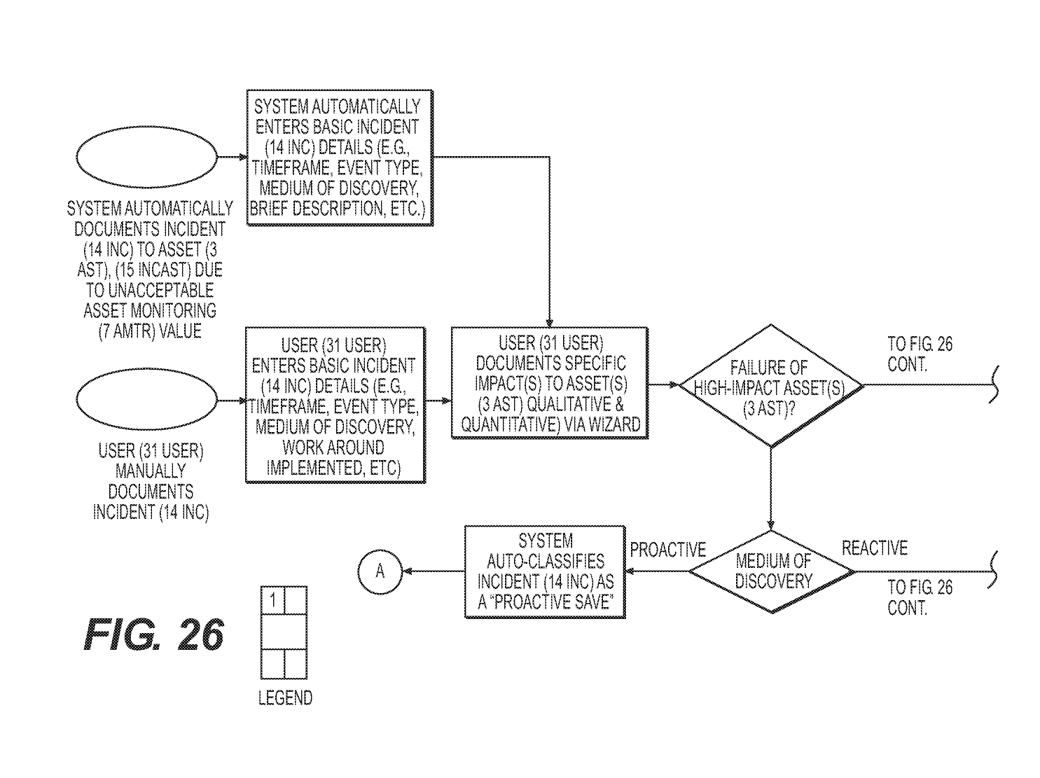

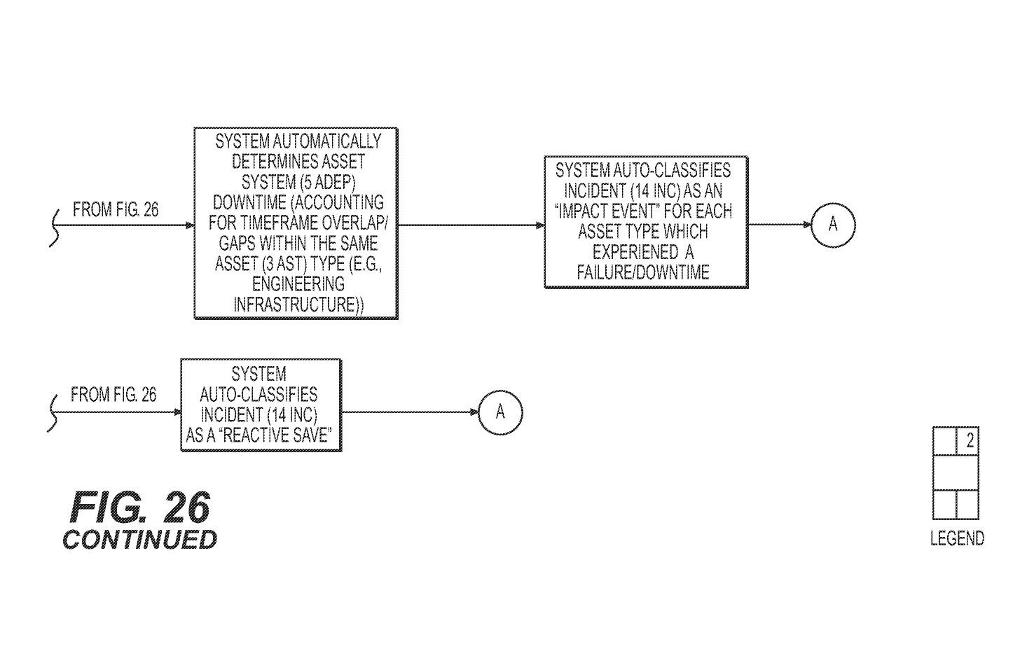

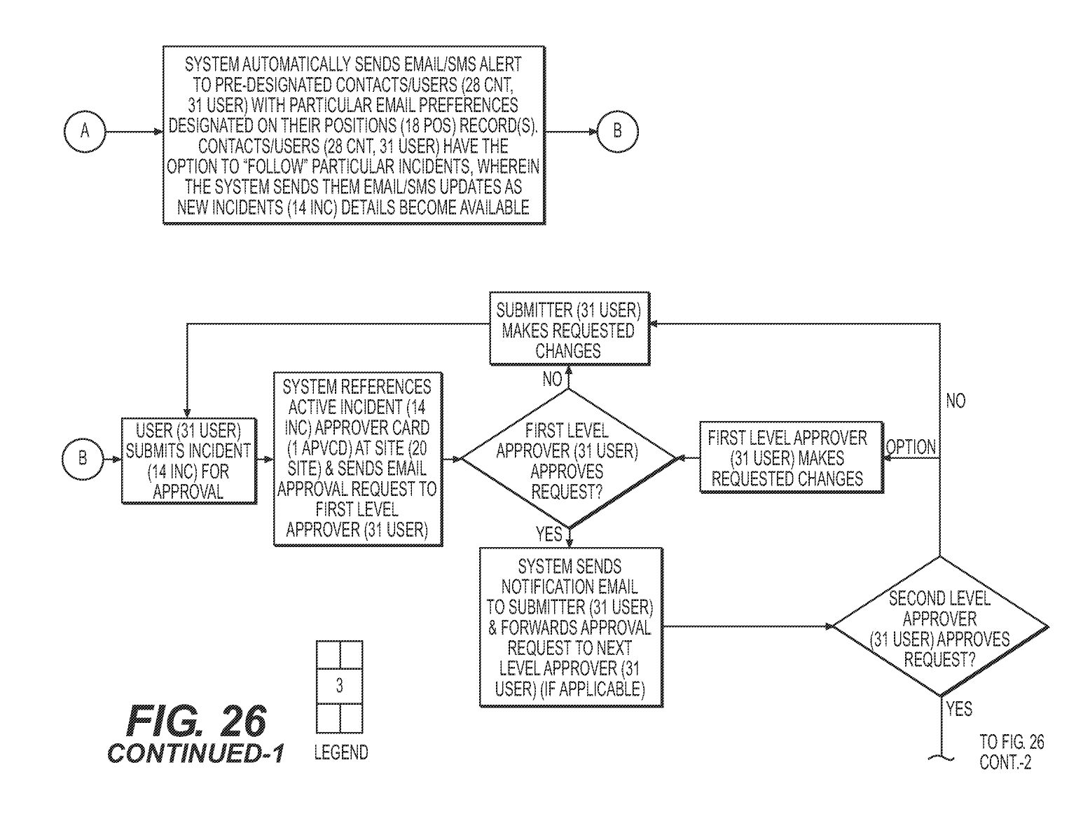

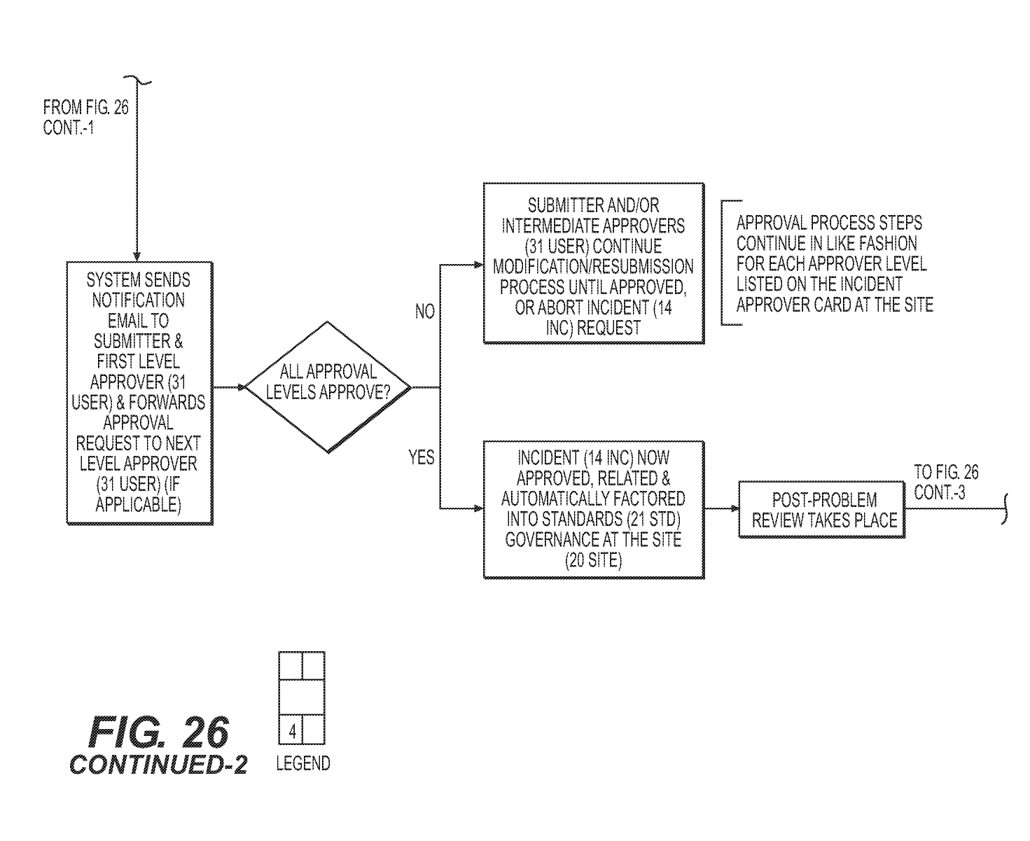

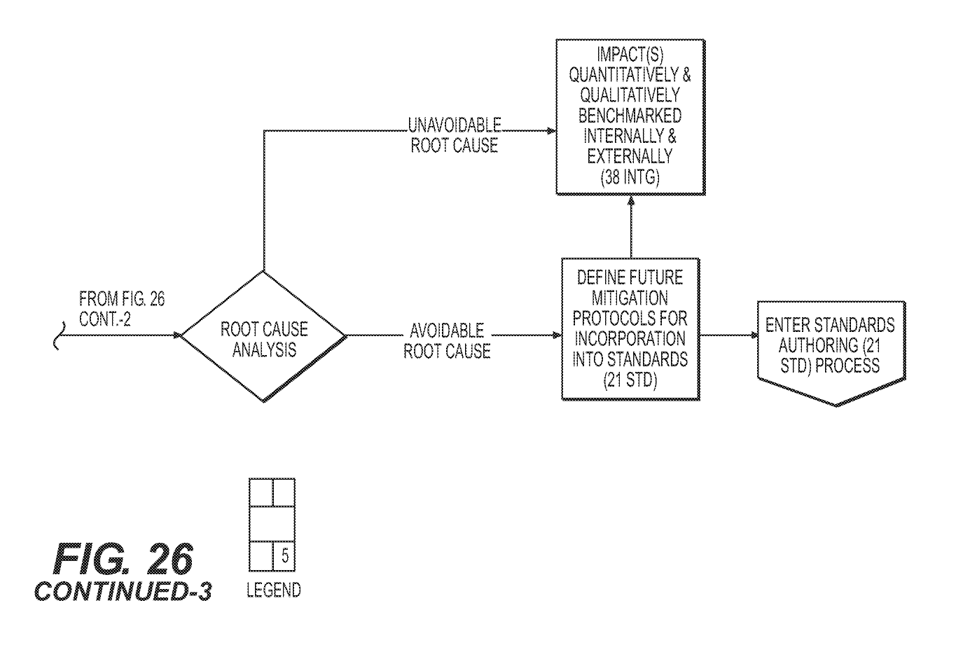

FIG. 26 illustrates exemplary steps for a process for automatic standards benchmarking and evolution based on an integrated incident process as used in the exemplary embodiment of the present approach. As shown in FIG. 26, the system may automatically document Incident 14 to asset 3 due to, for example, an unacceptable Asset Monitoring value. The system may automatically enter basic Incident 14 details (e.g. timeframe, event type, medium of discovery, brief description, etc.). User 31 may document specific impact(s) to asset(s) 3 (qualitative and quantitative) via, for example, a wizard. If the incident involved failure of high-impact asset(s) 3, then the system may automatically determine asset system downtime (accounting for timeframe overlap/gaps within the same asset 3 type (e.g. Engineering Infrastructure)). The system may then classify Incident 14 as an “Impact Event,” for each asset type which experienced a failure/downtime. If there was no high-impact asset failure, then the system determines the medium through which Incident 14 was discovered, and classify accordingly. For example, if the medium was proactive, the system may classify it as a “Proactive Save.” If the medium was reactive, then the system may classify incident 14 as a “Reactive Save.” The system may then automatically send an alert, such as by email or SMS, to predesigned contacts/users. The alert may include particular preferences designated on Positions 18 record(s). Contacts and users may have the option to “Follow” particular incidents, wherein the system sends updates as details become available. User 31 may then submit Incident 14 for Approval. The system may issue a request for approval referencing, e.g., active Incident 14 Approver Card 1 at Site 20. A first level approver may approve the Incident report, or request changes. The system may send notification for subsequent approvals, if necessary. Once all approvals had been received, the system may engage in post-problem review, including root cause analysis. If the root cause is determined to be unavoidable, the Impact(s) may be quantitatively and qualitatively benchmarked internally and externally. If the root cause was avoidable, future mitigation protocols may be defined and incorporated into Standards 21. Not all of the steps of FIG. 26 need to occur, and not all steps need to occur in the order shown, as will be apparent to persons skilled in the art based on the teachings herein. Other operational and structural embodiments of such this module will be apparent to persons skilled in the art based on the teachings herein. These steps are described in detail below.

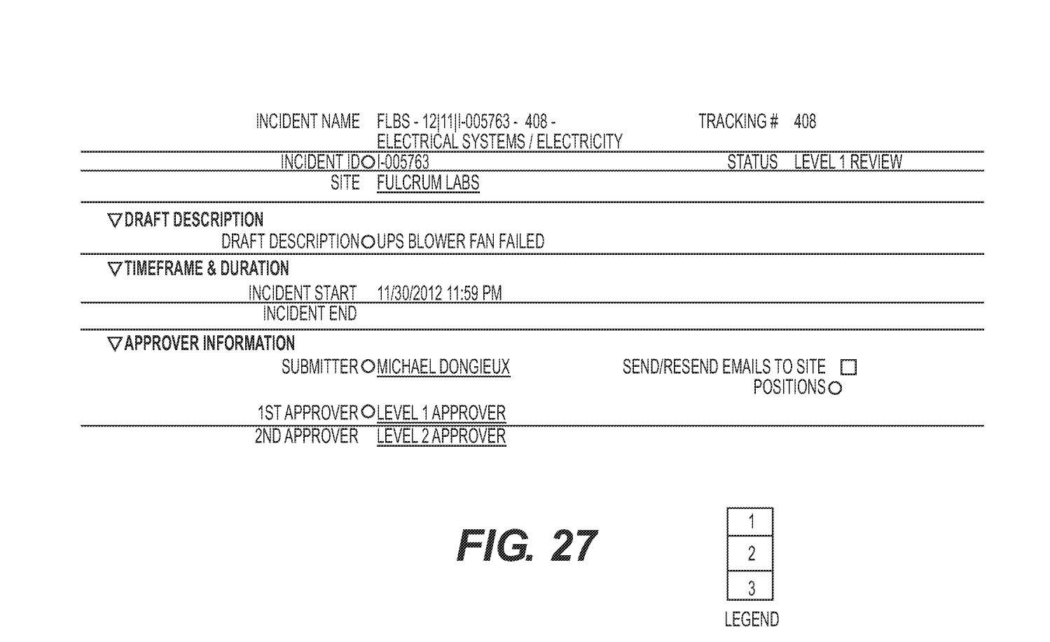

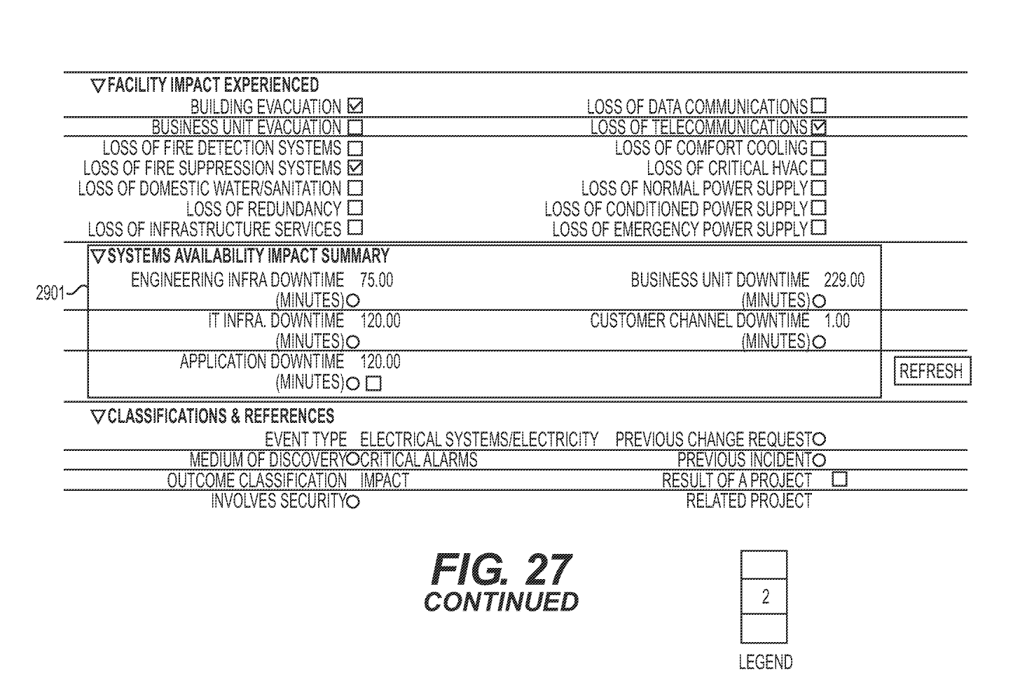

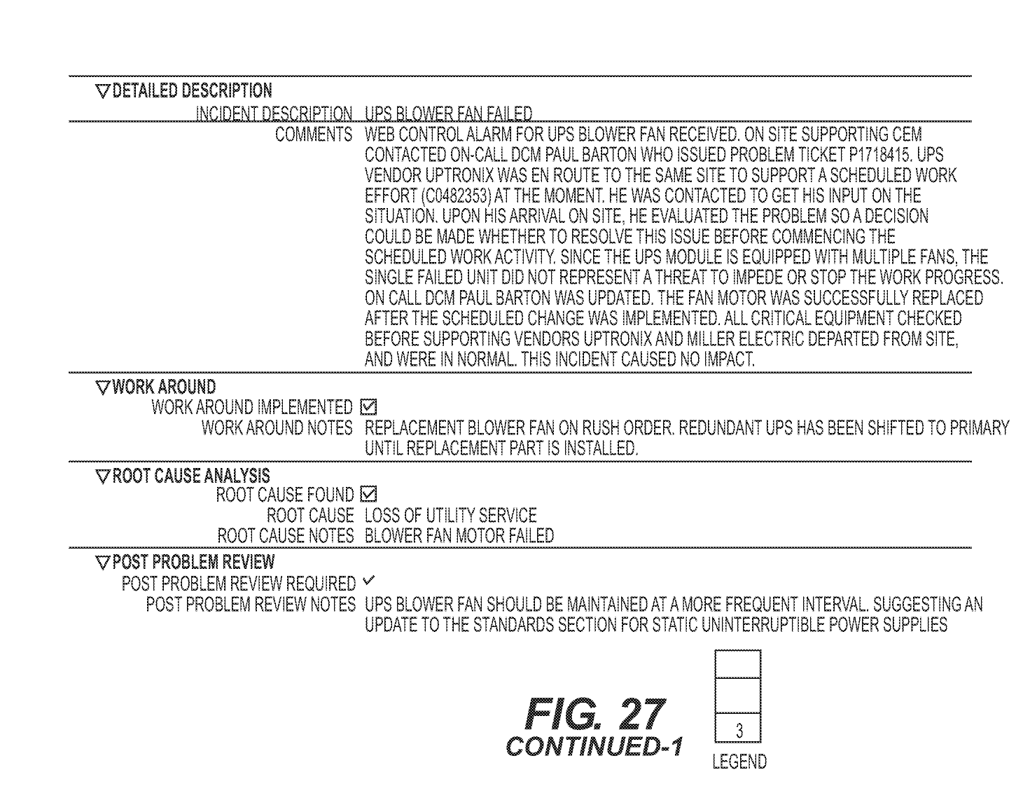

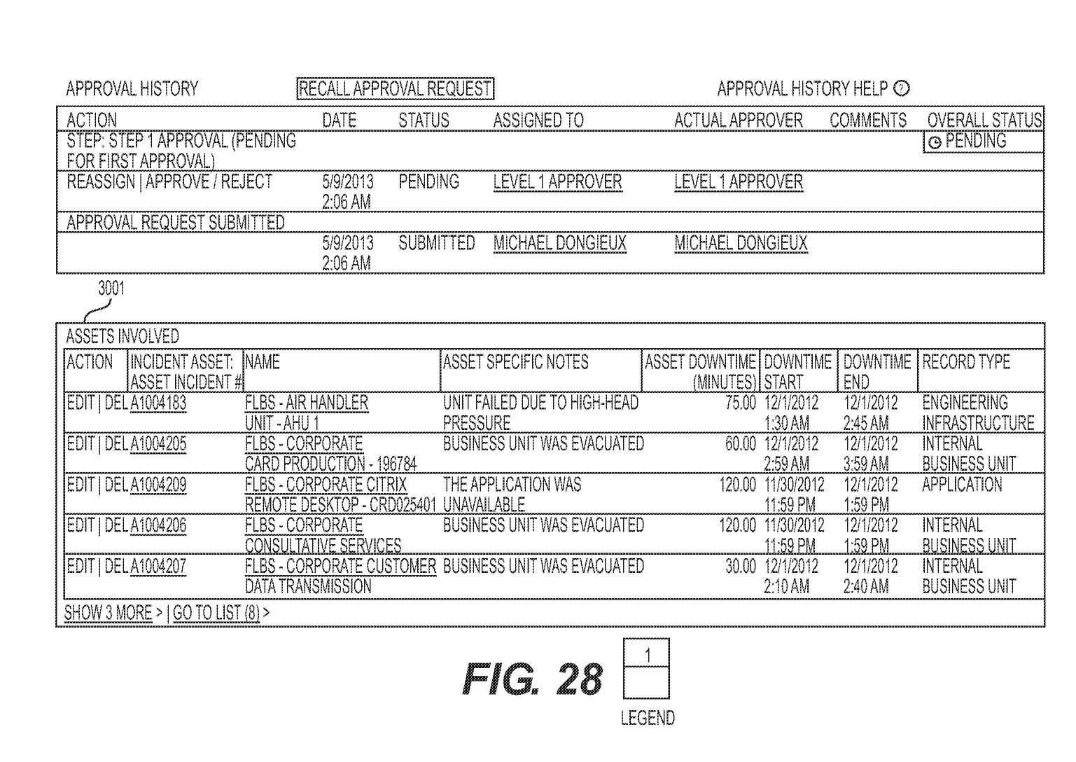

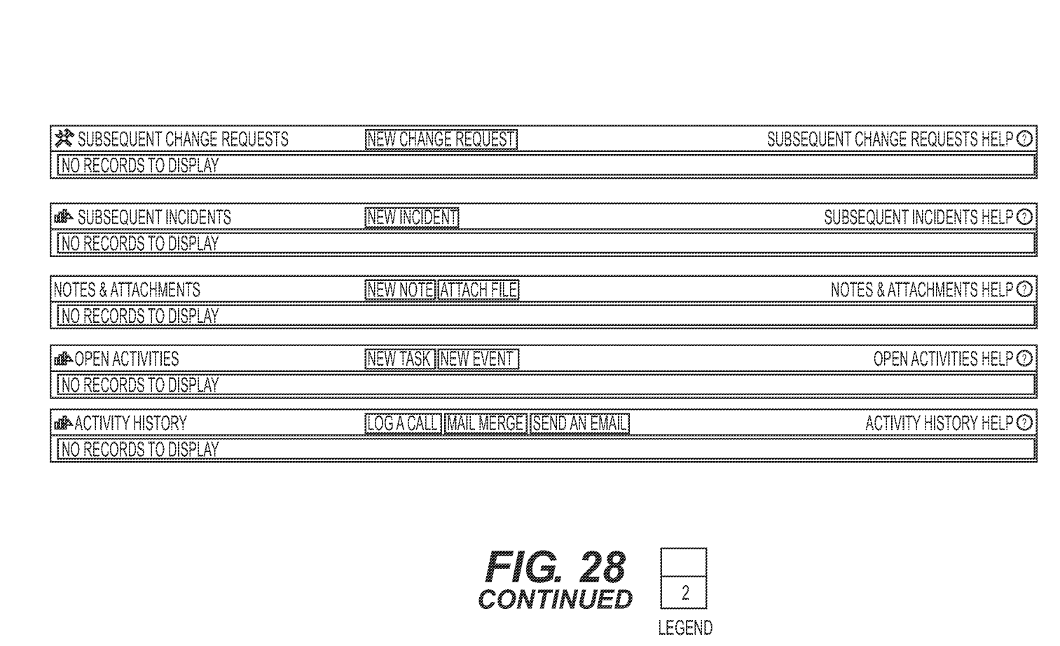

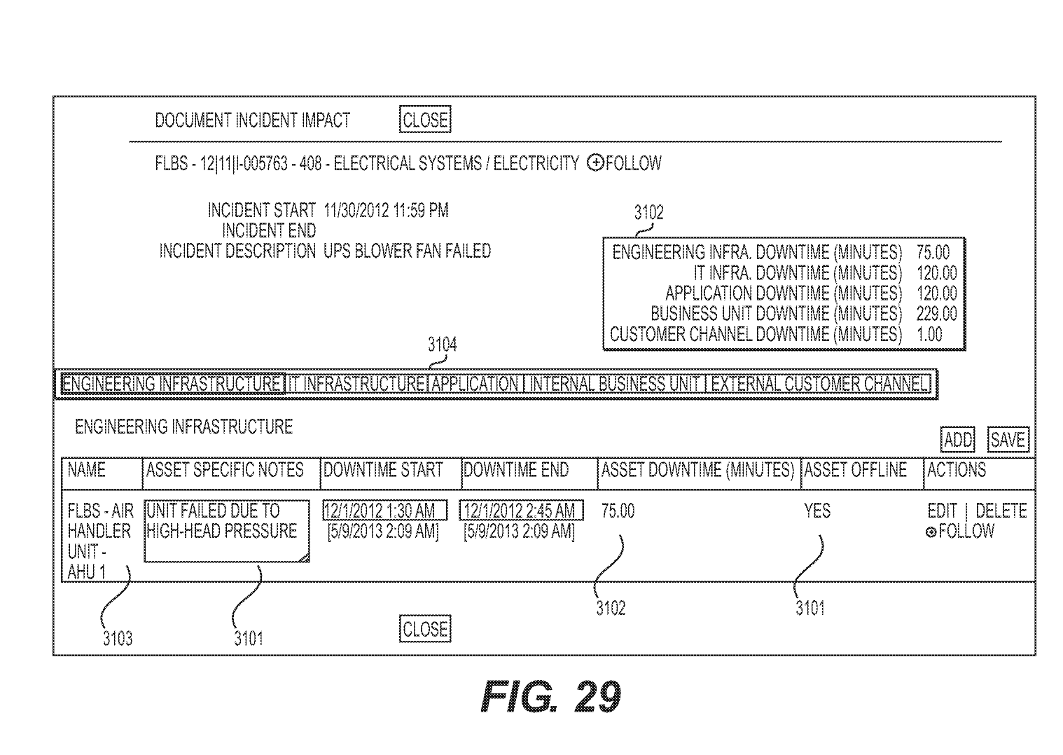

FIGS. 27 and 28 show an exemplary incident report. An incident report can be created manually by a user, or created automatically by the system based on an out-of-specification reading on an asset (1404, 1504). The specific impact(s) to specific asset(s) shown in 3001 may documented by the user via, for example, the wizard shown in FIG. 29. By documenting and associating specific impacts (both qualitative 3101 and quantitative 3102 in nature) to specific assets 3103, the system can identify common modes of failure across all assets sharing a common attribute(s) and/or relationship(s) (or combination of attributes and/or relationships), based on ad hoc or standardized segmentation. Impacts can be associated with any of the five asset types 3104. The aggregate quantitative impact (“downtime”) to each of the five types of asset systems is automatically calculated 2901 (wizard view shown in 3105), and accounts for prevention or reduction of impact to any of the five types of asset systems, by virtue of redundancy among the assets within that system. In this way, a user is able to view impact to an individual asset apart from the impact to the asset system to which it belongs.

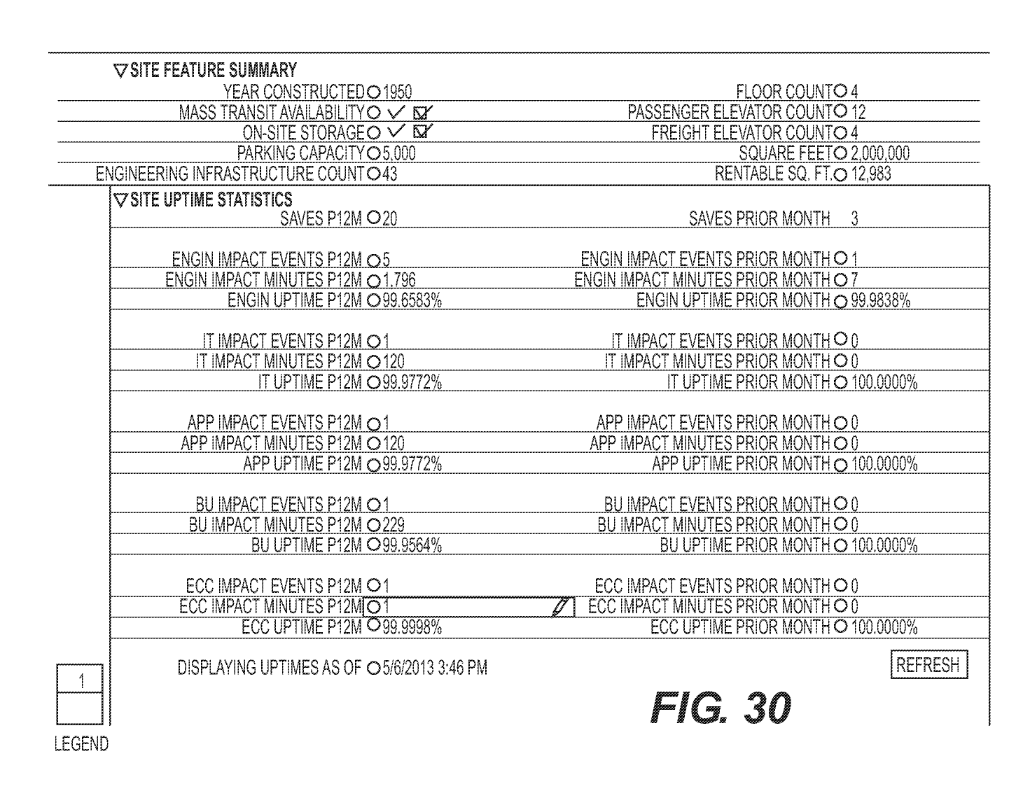

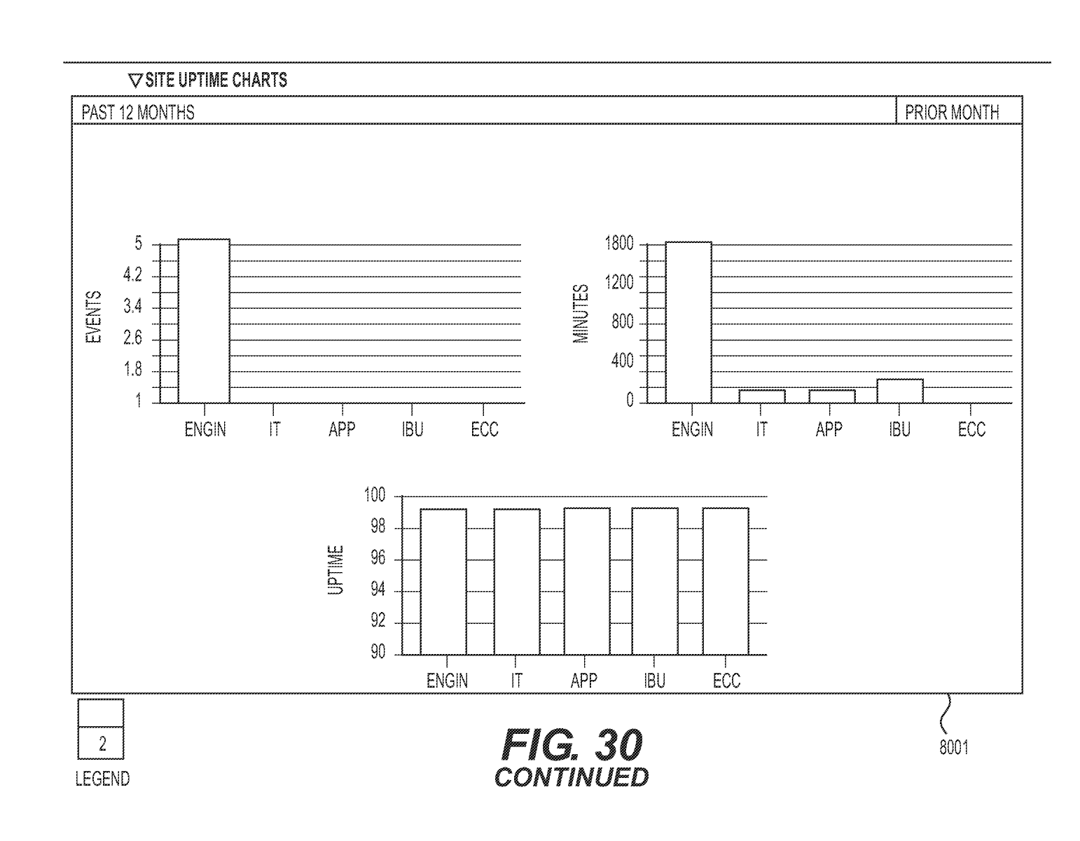

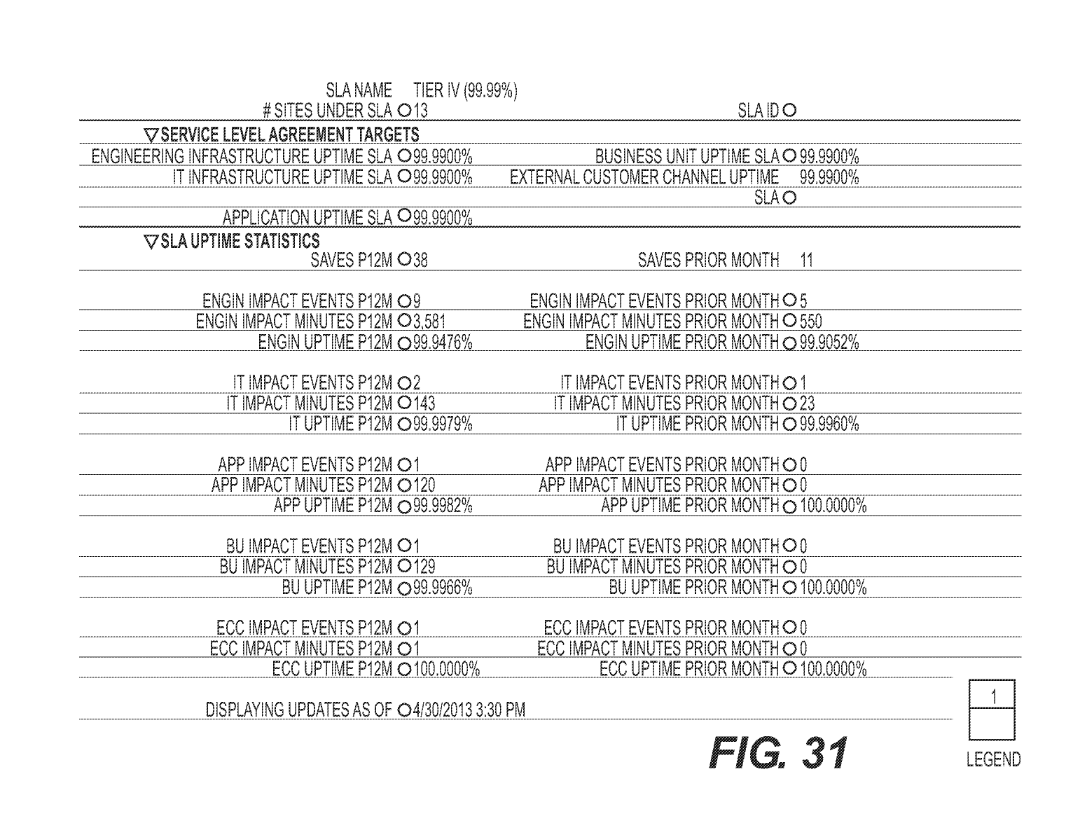

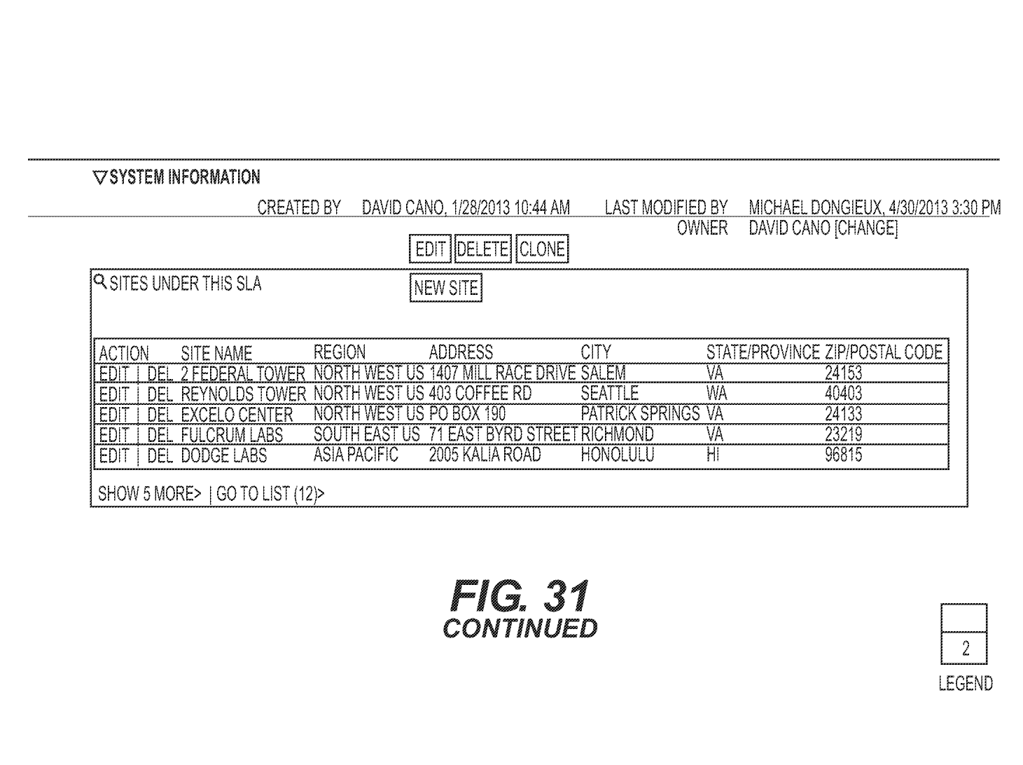

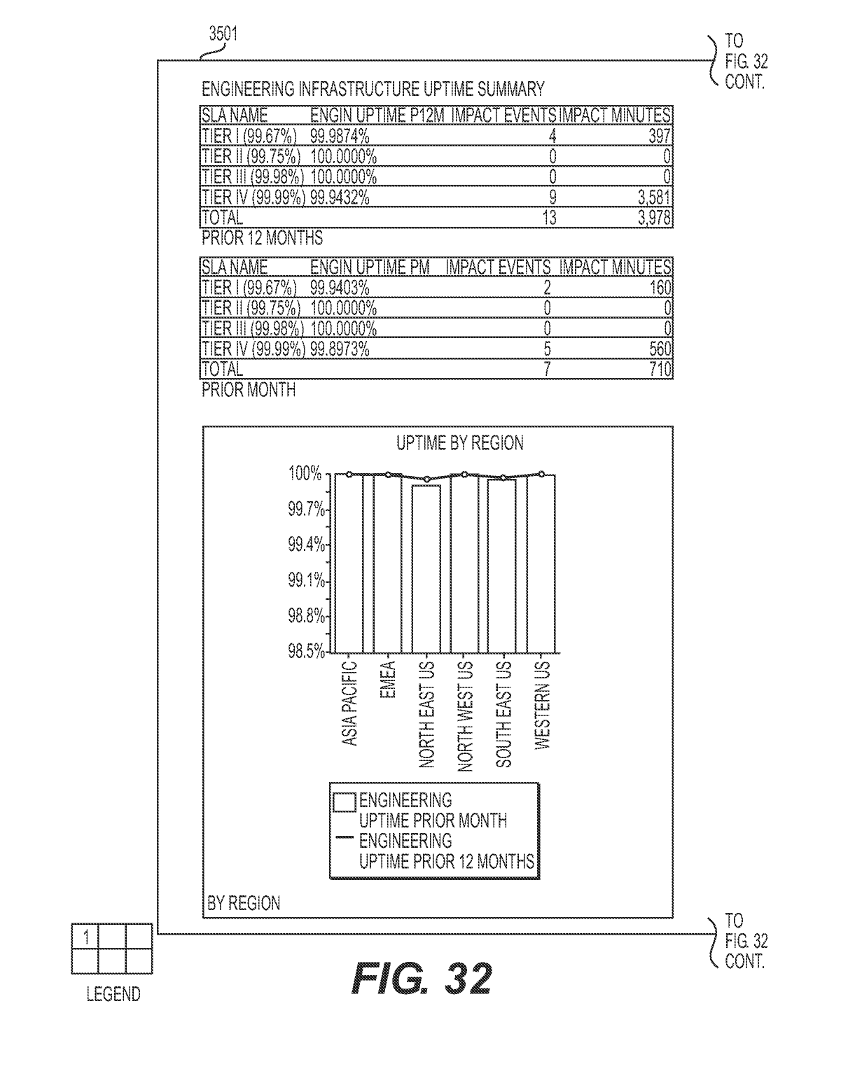

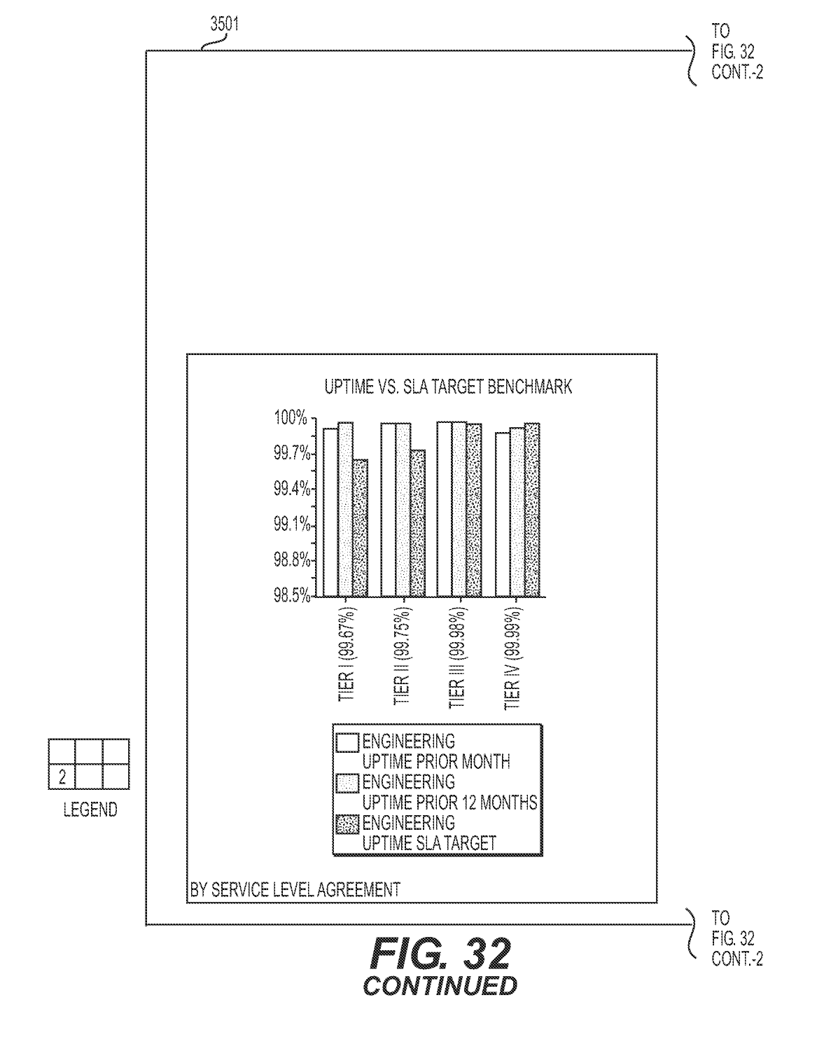

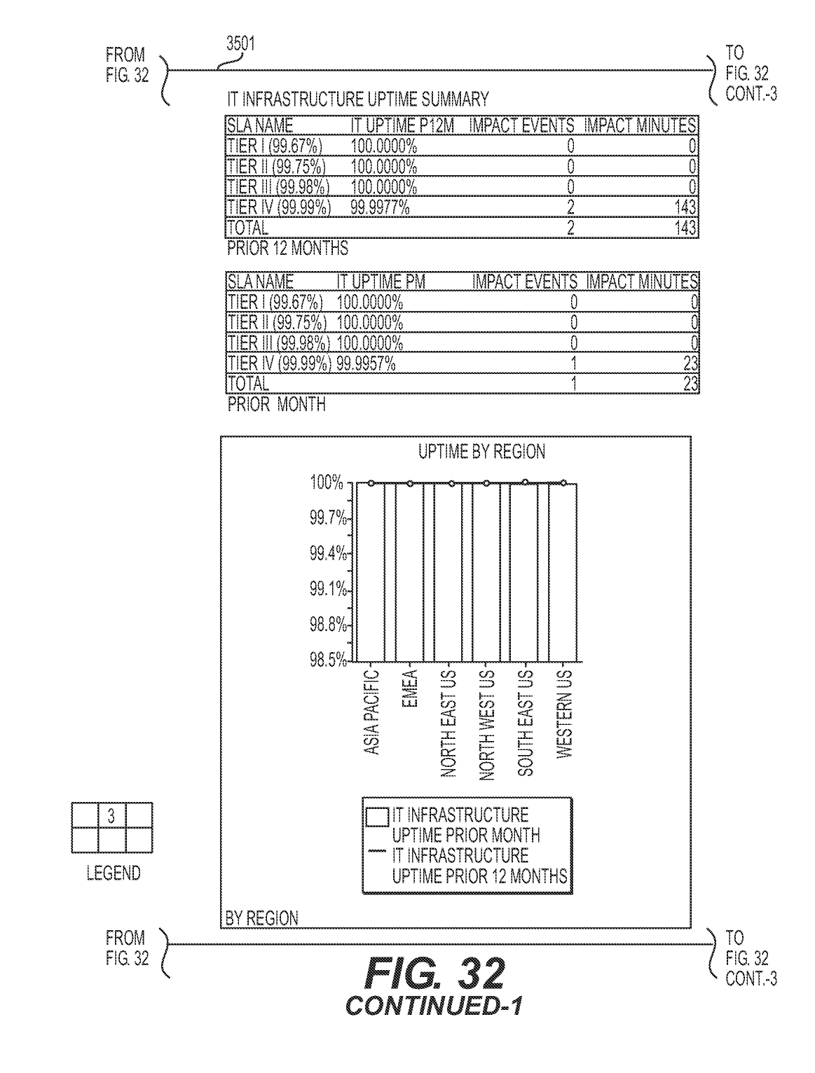

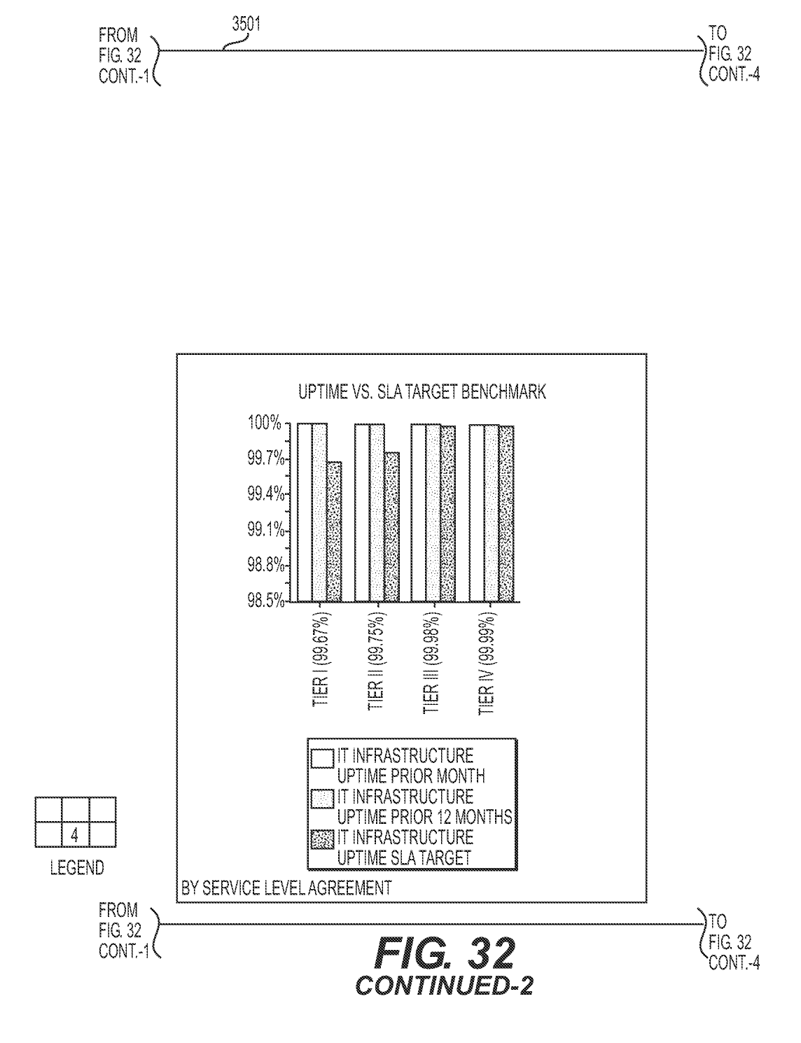

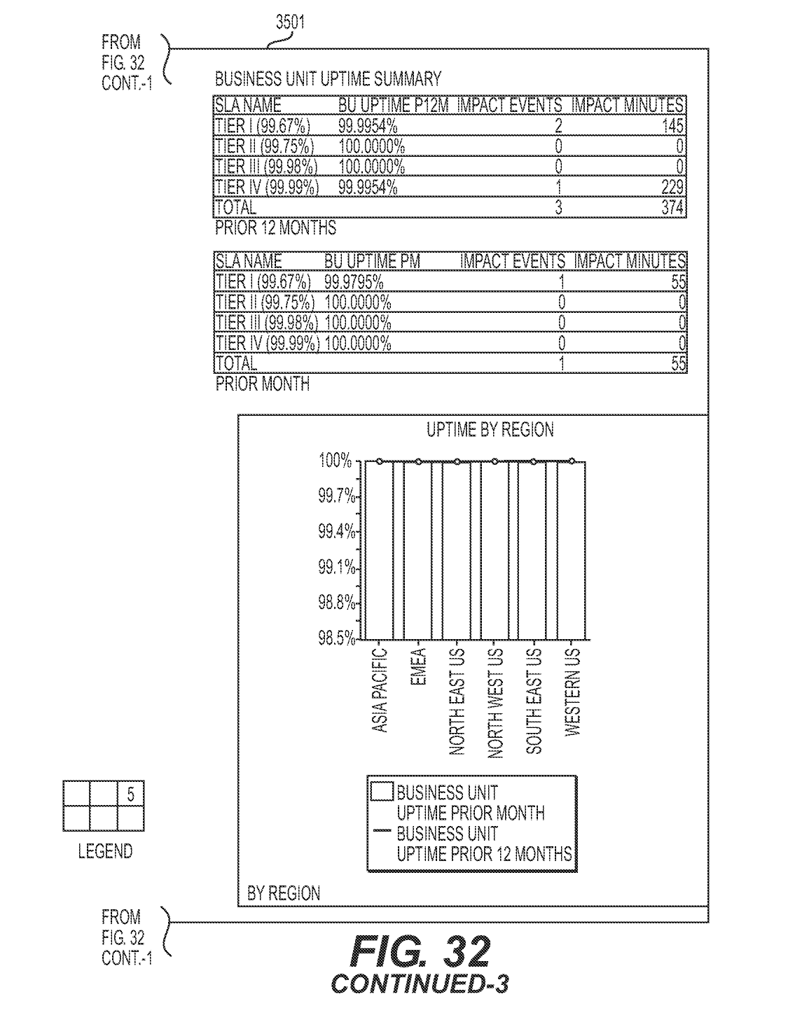

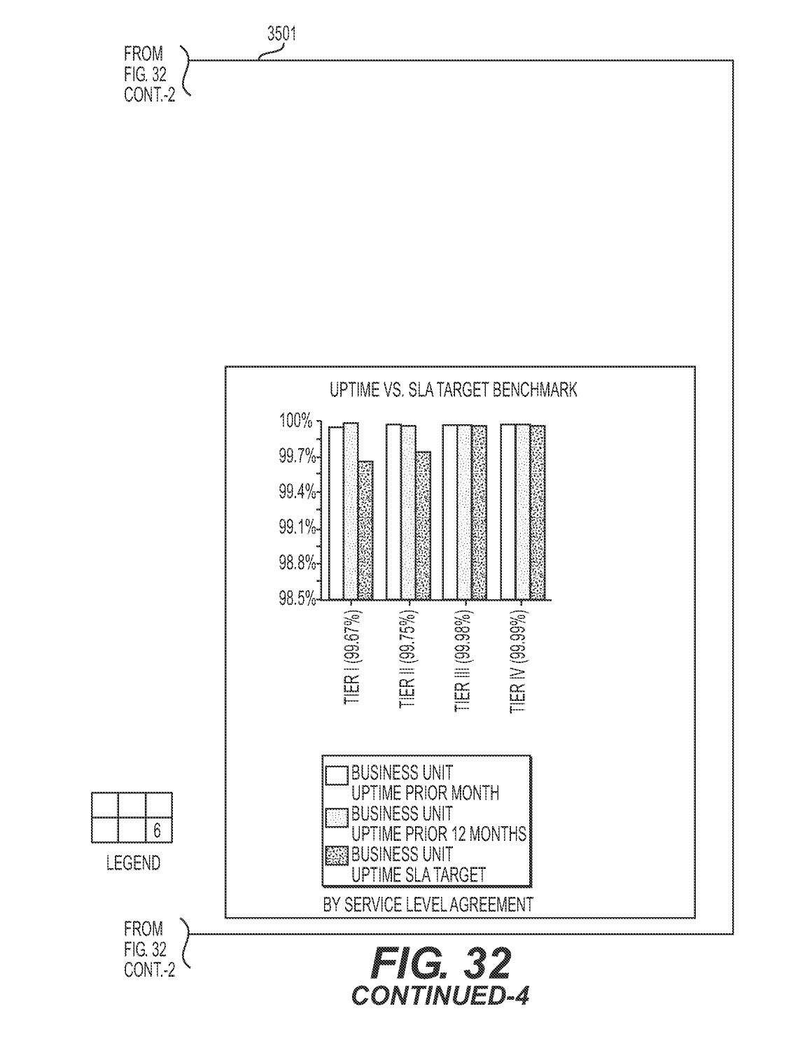

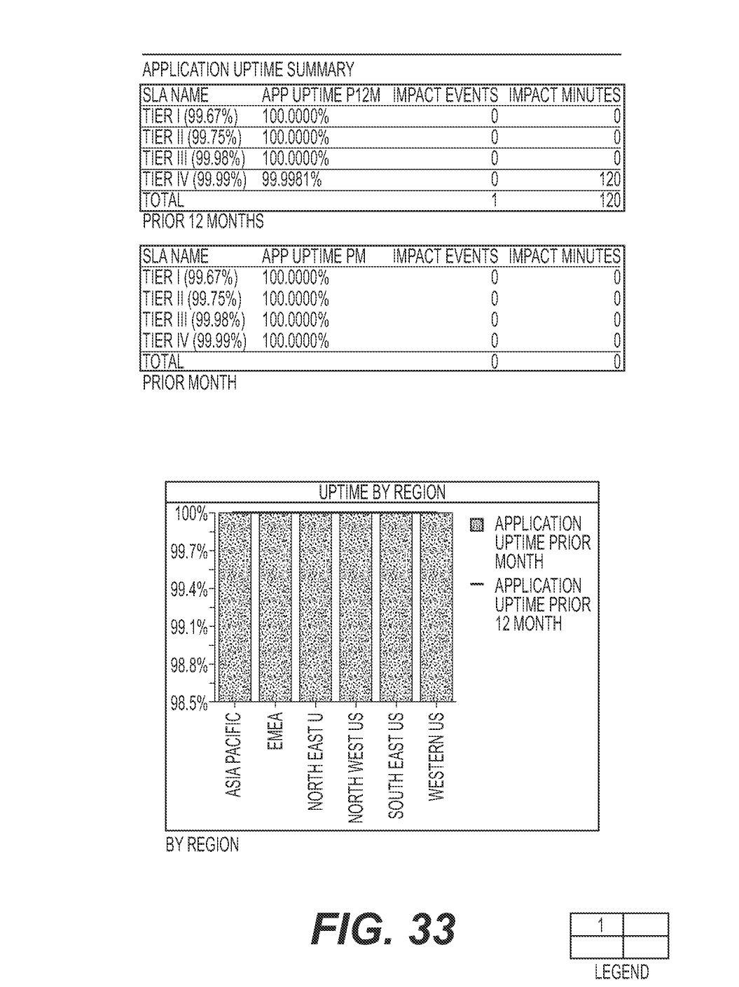

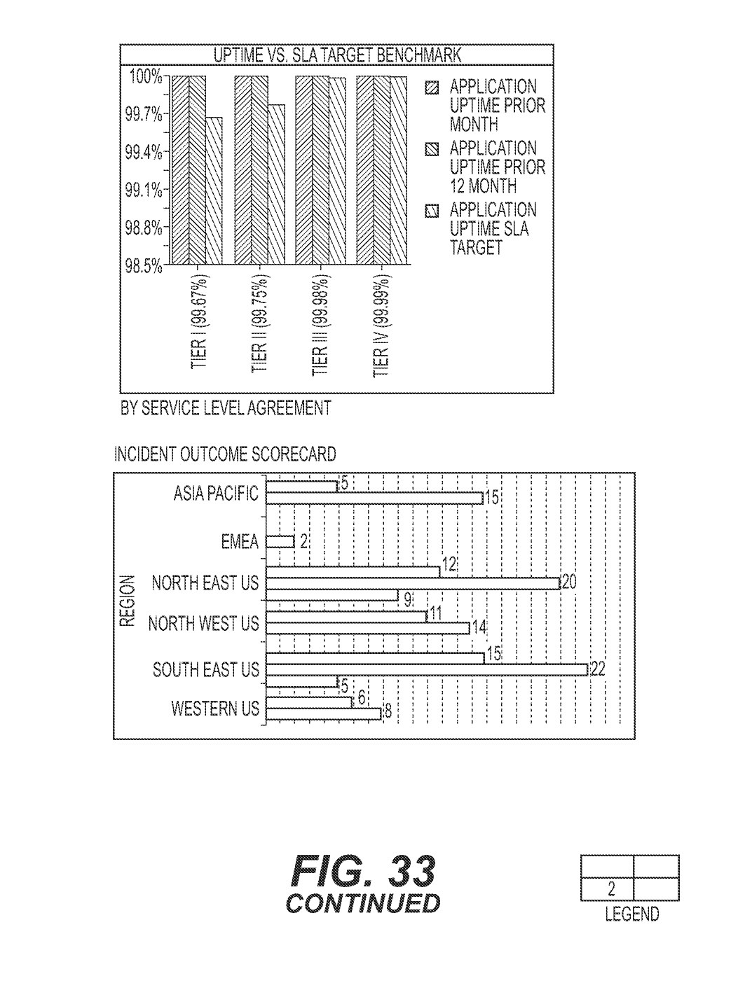

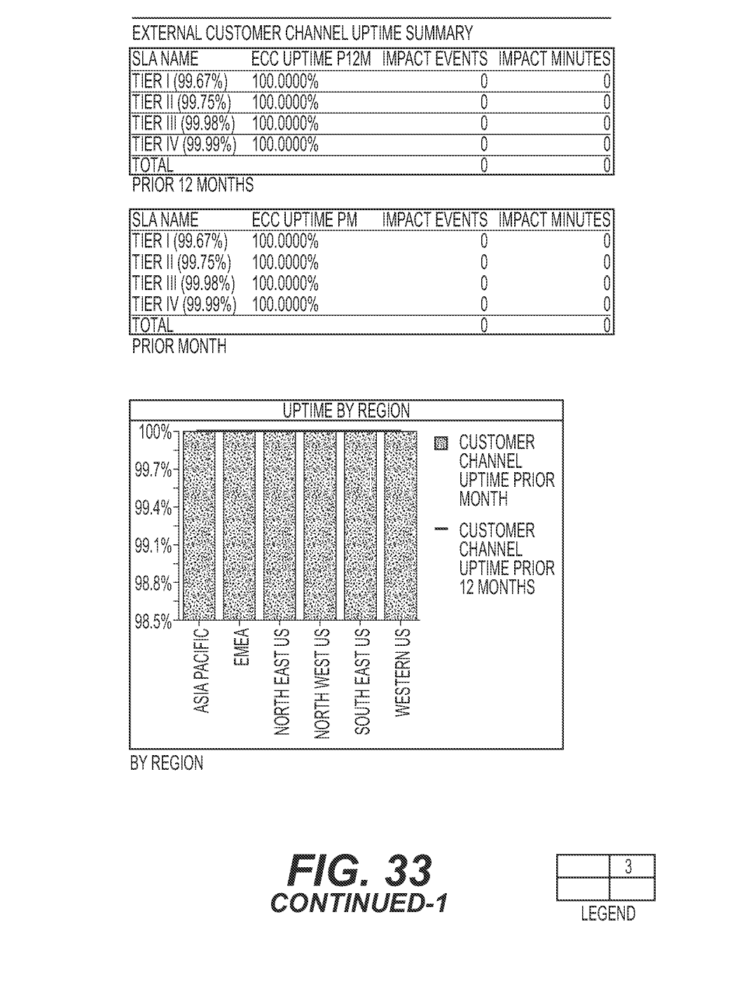

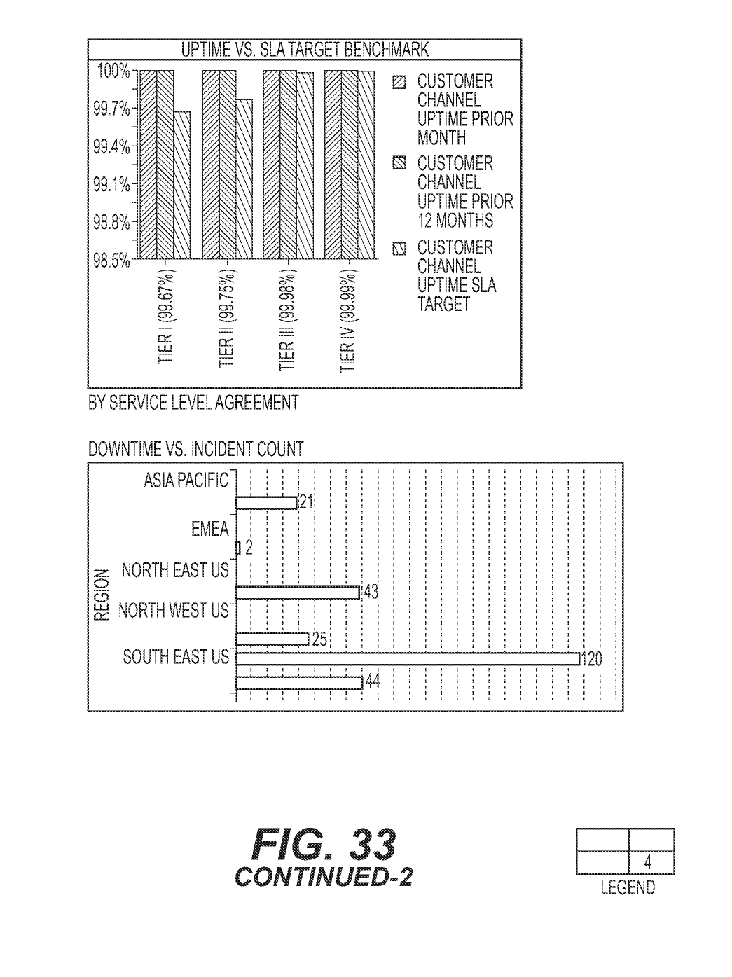

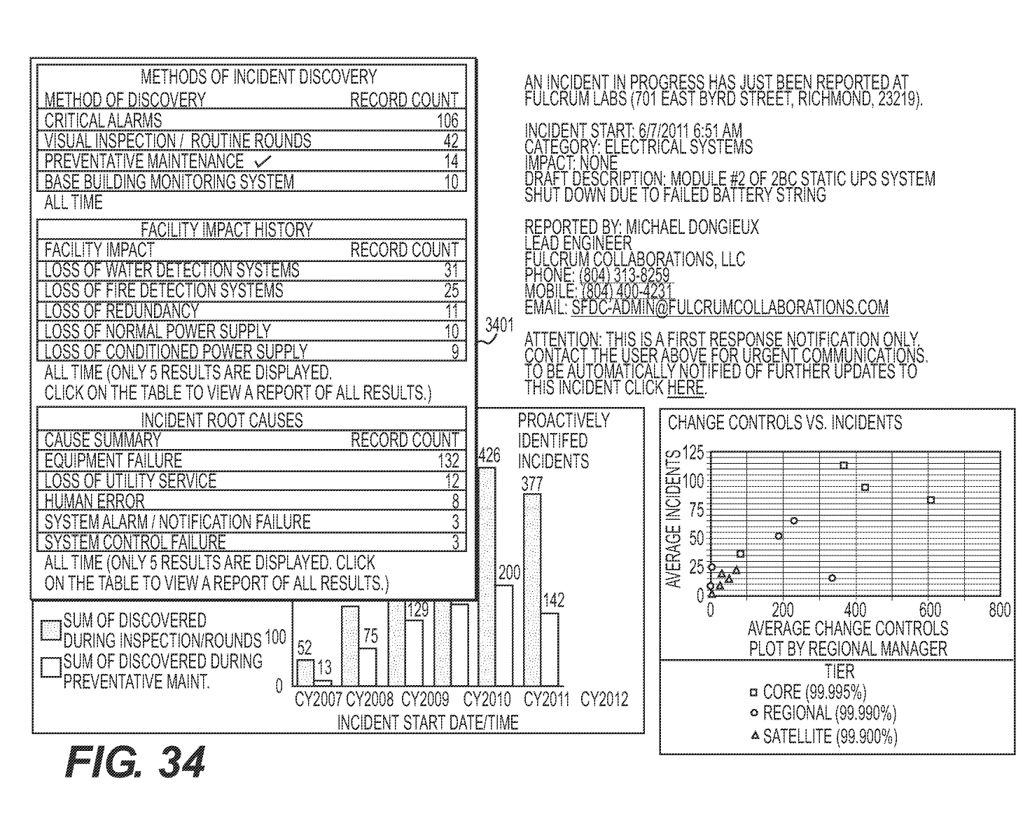

As depicted in FIG. 30, 8001, a user can view aggregate incident statistics for a particular site, which are automatically derived from data contained within the incident reports recorded at the site, during a specified period. As depicted in FIG. 31, a user can view aggregate incident statistics for a particular Service Level Agreement, which are automatically derived from data contained within the incident reports recorded at all sites under the Service Level Agreement, during a specified period. As depicted in the embodiments shown in FIG. 32, 3501, FIG. 33, 3701, and FIG. 34, 3401, a user can view aggregate incident statistics for any desired segmentation, which are automatically derived from data contained within the incident reports contained within that segmentation. Results in any of the above examples can be benchmarked against performance in prior periods, performance at other sites, or performance within any other desired segmentation.

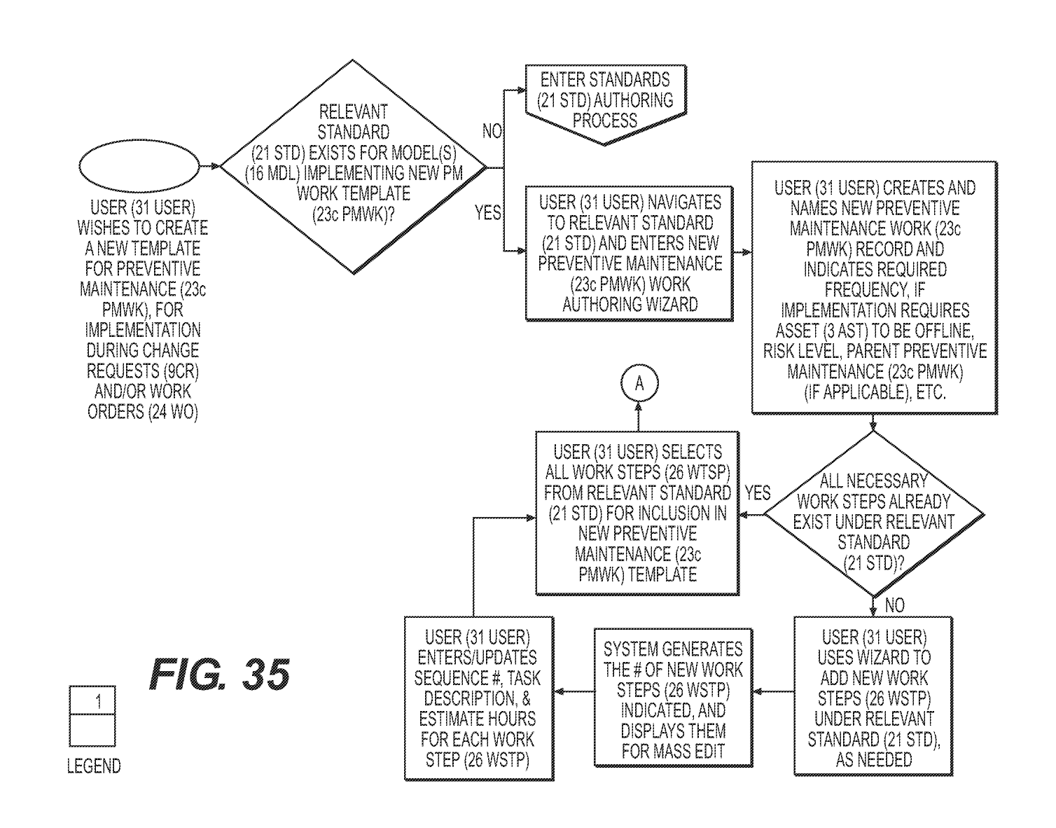

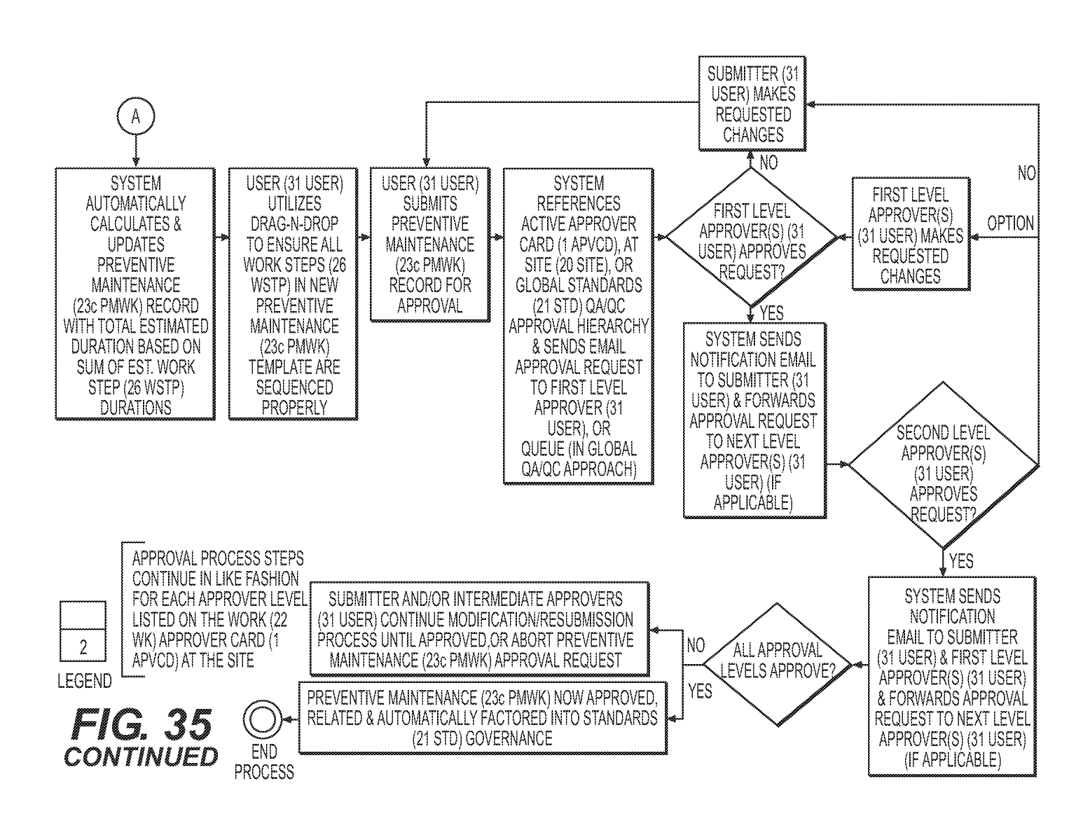

Finally, key findings identified through analysis of incident data, can be incorporated, either manually or automatically, into new and improved procedural and maintenance templates via the Preventive Maintenance Authoring Process, exemplary steps of which are illustrated in FIG. 35. In the exemplary method, User 31 seeks to create a new template for Preventive Maintenance 23c, for implementation during Change Requests 9 CR and/or Work Orders 24. If a relevant Standard 21 does not exist for model(s) 16, implementing the new work template 23c, then the system may enter Standards Authoring Process. If a relevant Standard does exist, User 31 may navigate to the relevant Standard 21 and enter a New Preventive Maintenance work authoring wizard to create a new Preventive Maintenance Work record, and indicate, e.g., required frequency, if implementation requires the asset 3 to be offline, risk level, parent preventive maintenance (if applicable), etc. If all necessary work steps do not already exist under relevant Standard 21 STD, then User 31 uses a wizard to add new Work Steps 26 under relevant Standard 21, as needed. The system may generate new work steps 26 as indicated, and display them for mess edit. User 31 may edit sequence, description, estimate hours, etc., for each Work Step 26. User 31 may select all Work Steps 26 from the relevant Standard 21 for inclusion in new Preventive Maintenance 23c PMWK template. If the work steps already exist, User 31 selects all Work Steps 26 from relevant Standard 21 for inclusion in new Preventive Maintenance 23c template.

The system may then automatically calculate and update Preventive Maintenance 23c records with the revised data. User 31 may use a drag-n-drop to ensure Work Steps 26 are sequenced properly, and then may submit the record for approval. The system may use Approver Cards 1 at Site 20, or global Standards 21 QA/QC approval hierarchy, and submit an approval request to first level Approver 31. A second level approver may require changes, or may approve the record. The process may end after all records have been approved. As with the other methods set forth in the drawings, the method shown in FIG. 35 is illustrative only, and one of ordinary skill would appreciate that not all steps are necessary, some steps may be combined or sub-divided, and steps may be performed in different sequences.

Asset monitoring typically provides large amounts of accurate, real-time data about critical and sub-critical assets in the infrastructure supporting value creation of an organization. One of ordinary skill in the art would appreciate that proactive identification of possible future failures in this infrastructure is one powerful method of risk mitigation. The creation of a system whereby monitoring data could be correlated among assets across one or more asset dependencies, areas, sites, or portfolio to discern patterns which may predict future failure, and may asses those correlations to automatically generate work orders and incidents to mitigate any future failure based on a pre-defined acceptable risk profile would provide considerable utility to users by maximizing up-time, creating better hierarchies for work orders and change requests, assisting in the creation of a fall picture of the weaknesses and possible failure points in an asset dependency or redundancy stream, among myriad other benefits.

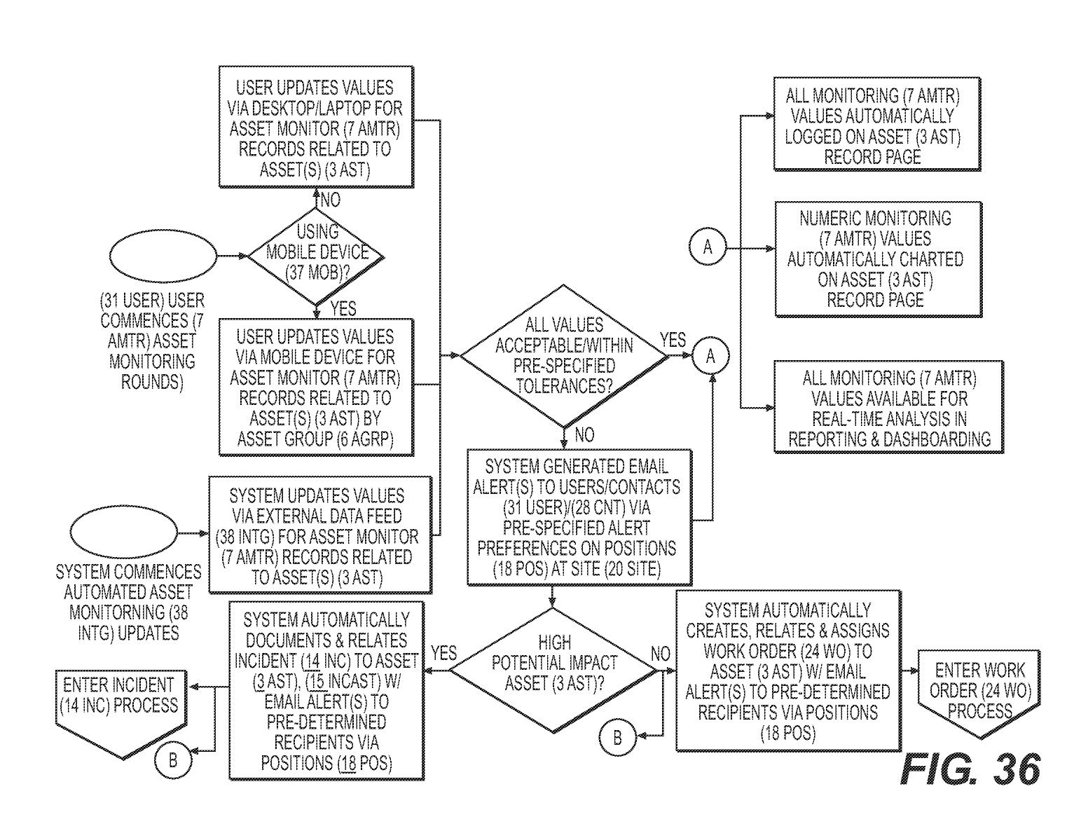

FIG. 36 illustrates exemplary steps for a process for automatic generation/assignment of work orders and incidents based on an integrated asset monitoring process as implemented in the exemplary embodiment. In the embodiment shown in FIG. 36, the system determines whether User 31 is using a mobile device. If so, then User updates values via Mobile Device for Asset Monitor 7 Records related to Asset(s) 3 by asset group 6. If not, User 31 updates values via another means, such as a desktop/laptop, for Asset Monitor 7 Records related to Asset(s) 3. The system may commence Automated Asset Monitoring 38 Updates. In such updates, the System updates values via an External Data Feed 28 for Asset Monitor 7 records related to Asset(s) 3. If monitored values are within pre-specified tolerances, then the system may proceed to a logging process. If not, then the system may generate an alert, such as an Email alert, to Users 31 and/or Contacts 28, which may be pursuant to predetermined alert preferences, and may be on Positions 18 at Site 20. If the asset being monitored is a High Potential impact Asset 3, then the system may automatically document the incident 4 and include it in the specific asset record. The system may also issue an alert to pre-determined recipients, such as via Positions 18 POS. If the asset is not a High Potential Impact Asset, then the system may take an alternative step, such as automatically creating and assigning a corrective Work Order to Asset 3, and may issue an alert to pre-determined recipients via Positions 18. In the logging process, monitoring values may be automatically logged on Asset 3 record pages. Numeric monitoring values may be automatically charted on Asset 3 record pages. All monitoring values may be available for real-time analysis, such as in reporting and dashboarding described elsewhere herein. As with the other exemplary methods disclosed herein, not all of the steps of FIG. 36 have to occur in the order shown, as will be apparent to persons skilled in the relevant art(s) based on the teachings herein. Other operational and structural embodiments will be apparent to persons skilled in the relevant art(s) based on the following discussion. Demonstrative steps from one embodiment are described in detail below.

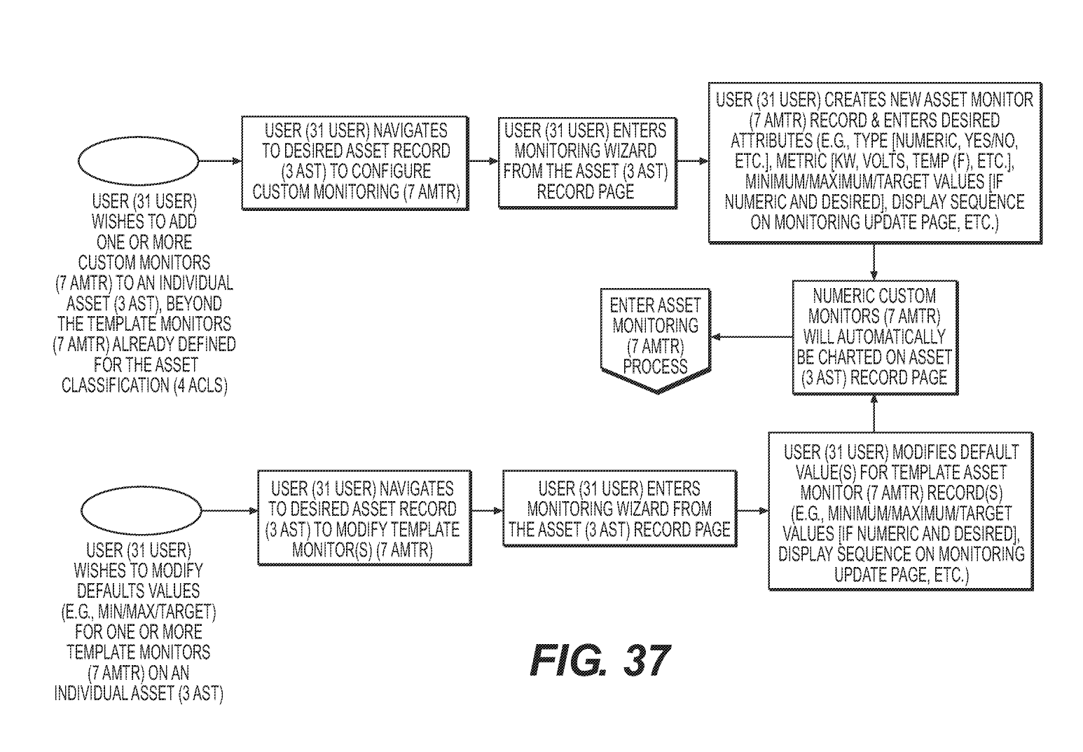

The system allows a user to pre-configure acceptable specifications for each monitored attribute, on each monitored asset in the system (such as minimum, maximum and target values, among others) 1901. FIG. 37 illustrates one method for defining custom monitors, according to an embodiment of the present approach. In the embodiment shown in FIG. 37, User 31 may add one or more custom monitors 7 to an individual asset 3, which may be beyond any template monitors 7 already defined for the asset classification 4. User 31 may navigate to desired asset record 3 to configure custom monitoring 7. User 31 enters a monitoring wizard from the asset 3 record page, and creates new Asset Monitor 7 record. The record may include fields for desired attributes (e.g. Type [numeric, yes/no, etc.], Metric [KW, Volts, Temp (F), etc.], minimum/maximum/target values [if numeric and desired], display sequence on monitoring update page, etc.). Numeric Custom Monitors 7 may be automatically be charted on Asset 3 record pages. If User 31 wishes to modify defaults values (e.g. min/max/target) for one or more template monitors 7 on an individual asset 3, User 31 may navigate to the desired asset record 3 and modify the default value(s) for the template Asset Monitor 7 record(s) (e.g. minimum/maximum/target values [if numeric and desired], display sequence on monitoring update page. etc.). Numeric Custom Monitors 7 may be automatically be charted on Asset 3 record page.

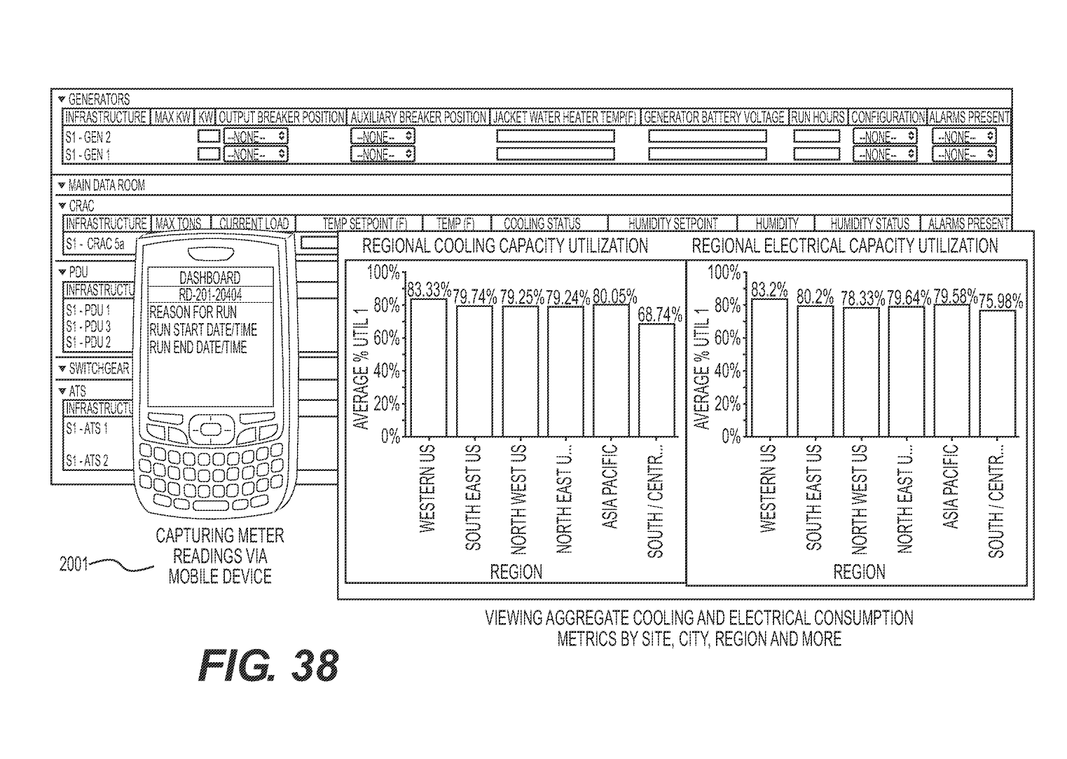

Monitoring values can then be updated by a user via a laptop or mobile device, as depicted in FIG. 38, 2001, and/or monitoring values can be automatically updated via an integration API which allows real-time data to be fed into the system from one or more external sources (such as a building management system). In FIG. 13, an out-of-specification reading on an engineering infrastructure asset 1504 causes the system to automatically create, assign and notify the assignee, of a problem ticket type work order 1503. Depending on the potential impact (priority/criticality 1402, current operating status 1403, upstream and downstream risk relationships and dependencies 1501, 1502) of the asset for which an out-of-specification monitoring value is detected, the system is able to determine whether or not an incident record should also be created. Whether a work order is created, an incident is created, or both, all of the created records will now be displayed on the asset's detail page as a part of the permanent history of the asset (as seen in 1503 and 1505), and can be accessed in the embedded reporting and dashboarding engines.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media.

Common forms of computer-readable media that may be used in the performance of the present approach include, but are not limited to, floppy disks, flexible disks, hard disks, magnetic tape, any other magnetic medium. CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, EDGE and EVDO.

Where databases are described in the present disclosure, it will be appreciated that alternative database structures to those described, as well as other memory structures besides databases may be readily employed. The drawing representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art.

It will be apparent to one skilled in the art that any computer system that includes suitable programming means for operating in accordance with the disclosed methods also falls well within the scope of the present approach. Suitable programming means include any means for directing a computer system to execute the steps of the system and method of the approach, including for example, systems comprised of processing units and arithmetic-logic circuits coupled to computer memory, which systems have the capability of storing in computer memory, which computer memory includes electronic circuits configured to store data and program instructions, with programmed steps of the method of the approach for execution by a processing unit. Aspects of the present approach may be embodied in a computer program product, such as a diskette or other recording medium, for use with any suitable data processing system. The present approach can further run on a variety of platforms, including Microsoft Windows™, Linux™, Sun Solaris™, HP/UX™, IBM AIX™ and Java compliant platforms, or cloud computing platforms such Salesforce.com, for example. Appropriate hardware, software and programming for carrying out computer instructions between the different elements and components of the present approach are provided.

Any suitable non-transient computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the non-transient computer-readable medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a device accessed via a network, such as the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any non-transient medium that can contain, store, communicate propagate, or transport the program for use by or in connection with the instruction execution system, apparatus, or device.

Computer program code for carrying out operations of the present approach may be written in an object oriented programming language such as Java, C++, etc. However, the computer program code for carrying out operations of the present approach may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present approach is described below with reference to flowchart illustrations and/or block diagrams of methods, apparatus (systems) and computer program products according to embodiments of the approach. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing, apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transient computer-readable memory, including a networked or cloud accessible memory, that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions mar also be loaded onto a computer or other programmable data processing apparatus to specially configure it to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any prompts associated with the present approach may be presented and responded to via a graphical user interface (GUI) presented on the display of the mobile communications device or the like. Prompts may also be audible, vibrating, etc.

Any flowcharts and block diagrams in the Figures illustrate the architecture, functionality, and operation of possible implementations of systems, methods and computer program products according to various embodiments of the present approach. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the approach. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The approach may be embodied in other specific forms without departing from the spirit or essential characteristics thereof. The present embodiments are therefore to be considered in all respects as illustrative and not restrictive, the scope of the approach being indicated by the claims of the application rather than by the foregoing description, and all changes which come within the meaning and range of equivalency of the claims are therefore intended to be embraced therein.

What is claimed is:

1. A computer-implemented method for assessing and managing dependencies between assets, the method comprising:
defining, in a database, a plurality of assets, each asset having an operation;
defining, in a database and for assets in the plurality of assets, upstream assets having at least one upstream asset dependency, an upstream asset dependency comprising an upstream asset having an operation that has a potential impact on the operation of an asset;
defining, in a database and for assets in the plurality of assets, downstream assets having at least one downstream asset dependency, a downstream asset dependency comprising a downstream asset that has an operation that may be impacted by the operation of an asset;
receiving an indication of an event, the event having a potential to change the operation of at least a first asset in the plurality of assets;
causing at least one processor to execute instructions stored in at least one memory device to identify a first category of assets for the event, a first category asset comprising a downstream asset having a downstream asset dependency on the first asset;
causing at least one processor to execute instructions stored in at least one memory device to determine redundant assets for the first category assets, a redundant asset comprising at least one of an asset upstream of a first category asset that provides the same operation to the first category asset as the first asset, an asset that provides the same operation as the first category asset, and an asset that provides the same operation as the first asset;
causing at least one processor to execute instructions stored in at least one memory device to identify a second category of assets, a second category asset comprising a first category asset having less redundant assets than a first predetermined threshold for the asset.

2. The method of claim 1, wherein assets in the plurality of assets comprise assets selected from at least one asset class from the group comprising engineering infrastructure assets, information technology hardware assets, information technology software assets, business unit assets, and customer channel assets.

3. The method of claim 2, wherein the plurality of assets comprise at least one engineering infrastructure asset and at least one asset selected from at least one asset class from the group comprising information technology hardware assets, information technology software assets, business unit assets, and customer channel assets.

4. The method of claim 2, wherein the plurality of assets comprise at least two types of assets in at least one asset class.

5. The method of claim 2, wherein the plurality of assets comprise at least two assets of the same type of asset in the same asset class.

6. The method of claim 1, wherein the event is at least one of a risk assessment event, a planned event, and an unplanned event.

7. The method of claim 6, wherein the planned event comprises at least one of inspection work, maintenance work, upgrade work, demolition work, install work, replacement work, testing, audit work, and personnel unavailability.

8. The method of claim 6, wherein the unplanned event comprises at least one of power loss, loss of climate control, mechanical failure, electrical failure, weather, a geological event, a cosmological event, natural disaster, a building evacuation, a business unit evacuation, loss of a fire detection system, loss of a fire suppression system, loss of data communication, loss of telecommunication, asset operation interruption, asset operation failure, reduction in asset operation, personnel unavailability, and an anomaly.

9. The method of claim 1, further comprising issuing a risk warning for at least one of (a) at least one first category asset, and (b) at least one second category asset. cm 10. The method of claim 1, further comprising defining a continuity plan for at least one asset in the plurality of assets.

11. The method of claim 10, further comprising automatically performing a business continuity plan for a second category asset.

12. The method of claim 1, wherein the first predetermined threshold is one.

13. The method of claim 1, further comprising causing at least one processor to execute instructions stored in at least one memory device to identify a third category of assets for the event, a third category asset comprising a first category asset having more redundant assets that a first predetermined threshold for the asset, and less redundant assets than a second predetermined threshold for the asset.

14. The method of claim 1, further comprising generating a graphical representation of at least one asset dependency between at least two assets.

15. The method of claim 1, further comprising monitoring the operation of at least one asset in the plurality of assets.

16. A computer-implemented system for assessing and managing dependencies between assets, the system comprising:
a database comprising data identifying a plurality of assets, each asset having an operation;
a database comprising data identifying, for assets in the plurality of assets, upstream assets having at least one upstream asset dependency, an upstream asset dependency comprising an upstream asset having an operation that has a potential impact on the operation an asset;
a database comprising data identifying, for assets in the plurality of assets, downstream assets having at least one downstream asset dependency, a downstream asset dependency comprising a downstream asset that has an operation that may be impacted by the operation of an asset;
an asset monitoring module;
an event indication receiving module, an event having the potential to change the operation of at least a first asset in the plurality of assets;
a first category asset identification module, a first category asset comprising a downstream asset having a downstream asset dependency on the first asset;
a redundant assets identification module, a redundant asset comprising at least one of an asset upstream of a first category asset that provides the same operation to the first category asset as the first asset, an asset that provides the same operation as the first category asset, and an asset that provides the same operation as the first asset;
a second category asset identification module, a second category asset comprising a first category asset having less redundant assets than a predetermined threshold for the asset.

17. The system of claim 16, further comprising an asset dependencies mapping and visualization module.

18. The system of claim 16, further comprising a database comprising data identifying at least one standard and at least one work template applicable to the standard.

19. The system of claim 16, further comprising a work order processing module and a change request and change control processing module.

20. The system of claim 16, further comprising an integrated reporting and analytics module.

21. The system of claim 16, wherein the asset dependencies mapping and visualization module re-evaluates, at at least one of a predefined interval, after an event, an ad hoc basis, and after an asset monitoring module signal, at least one asset dependency.

22. The system of claim 18, wherein the work template database provides automatic prescription and tracking of audit compliance for assets

23. The system of claim 19, wherein the work order processing module and the change request and change control processing module access a database comprising data identifying at least one standard and at least one work template applicable to the standard.

24. The system of claim 19, wherein the work order processing module generates and assigns work orders using information from the asset monitoring module.

25. The system of claim 20, further comprising an incident reporting and processing module that documents incidents using information from the asset monitoring module.
